(19) United States
(12) Patent Application Publication
(10) Pub. No.: US 2026/0228117 A1
(43) Pub. Date: Aug. 6, 2026

(54) Input Validation in AI Coding

(71) Applicant: Ron ZASS, Kiryat Tivon (IL)

(72) Inventor: Ron ZASS, Kiryat Tivon (IL)

(21) Appl. No.: 19/632,716

(22) Filed: Mar. 30, 2026

Related U.S. Application Data
(60) Provisional application No. 63/785,355, filed on Apr. 8, 2025.
(60) Provisional application No. 64/013,427, filed on Mar. 22, 2026.

(51) Int. Cl. G06F 11/3668; G06F 8/35

(52) U.S. Cl. CPC G06F 11/3684; G06F 8/35

(57) ABSTRACT

Systems, methods and non-transitory computer readable media for input validation in artificial intelligence coding are provided. An input in a natural language associated with a desire of an individual to generate source code for a software may be received. The input in the natural language may be analyzed to determine a need for the software to receive data from an external source. Guidance associated with input validation for the received data may be requested from the individual. The requested guidance may be received from the individual. An artificial intelligence model may be used to analyze the input in the natural language to generate the source code, the generated source code includes instructions for receiving the data from the external source and instructions for validating the received data based on the received guidance.

### CROSS-REFERENCE TO RELATED APPLICATIONS

This application claims the benefit of priority of U.S. Provisional Patent Application No. 63/785,355 (filed on Apr. 8, 2025), and U.S. Provisional Patent Application No. 64/013,427 (filed on Mar. 22, 2026).

The entire contents of all of the above-identified applications are herein incorporated by reference.

### BACKGROUND OF THE INVENTION

### Technological Field

The disclosed embodiments generally relate to systems and methods for artificial intelligence (AI) coding. More particularly, the disclosed embodiments relate to systems and methods for input validation in AI coding.

### Background Art

Generation and editing of user interfaces, such as user interfaces of websites, apps or extended reality applications, may require expertise in many different domains, including design principles, programming languages, usability testing, accessibility standards, and user experience psychology. Therefore, in many cases the development of complex user interfaces requires collaboration of cross-functional teams consisting of one or more of designers, front-end and back-end developers, UX/UI specialists, content creators, or domain experts to ensure a cohesive, functional, and user-centered final product. The communication among these team members is crucial to ensure that the design vision is accurately translated into code, the user experience is consistent, and any potential issues or challenges are identified and addressed early in the development process. An alignment problem can arise when different team members have varying interpretations of the design specifications, leading to discrepancies between the intended user interface and the implemented one. This misalignment can result in user dissatisfaction, functional errors, and project delays. Therefore, the process of developing or modifying user interfaces is not only a technical endeavor but also a highly collaborative and iterative journey that necessitates continuous alignment, refinement, and adaptation among multidisciplinary team members. Unfortunately, it's worth noting that due to communication problems between team members, these projects can often face significant challenges and even failure, resulting in subpar user experiences and missed project goals. Therefore, it is desirable to simplify the development and modification of user interfaces. Specifically, automating parts of the process to reduce the dependence on an excessive number of team members can contribute to more efficient and successful projects, minimizing the potential for misalignment and project failures.

Moreover, even when user interfaces are superbly developed, the development process often tends to be lengthy and resource-intensive due to the intricate nature of design, coding, testing, and optimization that are involved. Therefore, only a single final version of a user interface is usually produced, and all users are provided with this single final version. However, this approach can overlook the diverse needs and preferences of users, potentially leading to reduced user satisfaction and engagement. As a result, user interfaces are one of the least personalized aspects of the digital experience, missing opportunities to cater to individual user requirements and limiting the potential for creating truly immersive and tailored interactions. Moreover, to achieve hyper-personalization of user interfaces, where a unique version of the user interface is generated for each user, the ability to instantaneously create these interfaces becomes crucial. Implementing hyper-personalization through manual techniques is therefore impractical due to the sheer complexity and scale of generating and managing individualized user interfaces for a diverse user base. Therefore, the automation of user interface creation becomes imperative to achieve true hyper-personalization, allowing for the efficient and scalable generation of individualized interfaces that cater to diverse user needs and preferences.

Artificial intelligence systems may be configured to process inputs using multiple sequential processing stages, including task decomposition approaches in which an input is analyzed through a sequence of intermediate steps to generate a final response. In some implementations, each step may generate an intermediate result that is used by a subsequent step in the sequence. However, multi-step processing architectures may introduce challenges in identifying sources of errors, inconsistencies, or other misalignments between an input and a generated response. For example, when a generated response is determined to be inconsistent with an input, existing approaches may not provide mechanisms for determining which particular processing step contributed to the inconsistency. Accordingly, improvements in techniques for detecting misalignments between inputs and generated responses, and for associating such misalignments with particular processing steps within multi-step artificial intelligence processes, may be beneficial.

Software development workflows increasingly incorporate artificial intelligence tools to assist with code generation, modification, and optimization. While such tools can accelerate development, they also introduce challenges for conventional version control systems, which are typically designed around discrete, human-initiated code commits. AI-generated code may evolve iteratively in response to successive natural-language inputs, producing intermediate code states that are experimental, incomplete, or unsuitable for repository integration. Existing systems lack mechanisms to intelligently evaluate conversational context, prior prompts, and evolving code artifacts to determine whether a given AI-generated version should be committed, deferred, or superseded. As a result, premature or excessive commits can clutter repositories, degrade code quality, and complicate auditability and rollback processes. Accordingly, there is a need for improved version control techniques that coordinate AI-driven code generation with commit decision workflows, enabling context-aware evaluation of natural-language inputs and generated code versions prior to triggering repository commits.

Software development is increasingly supported by artificial intelligence-based coding systems that translate natural language inputs into executable source code. Conventional AI coding tools, however, typically rely on static model training or fixed prompt instructions and lack the ability to dynamically incorporate evolving coding guidelines during an active development workflow. As software projects grow in complexity, coding standards, architectural constraints, and organizational best practices frequently change, requiring continuous adaptation by developers. Existing systems provide limited mechanisms for integrating such modifications in real time, often resulting in inconsistent code generation, guideline non-compliance, or the need for manual refactoring. Accordingly, there is a need for improved software architecture frameworks that enable artificial intelligence coding systems to access structured coding guidelines, generate code in accordance with those guidelines, and responsively adjust subsequent code generation based on identified modifications to the guidelines while continuing to process natural language inputs.

Software development increasingly relies on artificial intelligence assisted tools to generate, modify, and optimize source code. While such tools can accelerate development, they often introduce inconsistencies in coding style, architectural patterns, and problem-solving approaches across different portions of a codebase. These inconsistencies may reduce maintainability, complicate collaboration, and increase the likelihood of defects when integrating newly generated code with existing implementations. Conventional AI coding systems typically focus on solving an isolated problem expressed in natural language without adequately considering established solutions already present in the source code or the particular approaches embodied therein. As a result, newly produced code may diverge from preferred design paradigms, reuse patterns, or domain-specific methodologies. Accordingly, there is a need for improved systems and techniques that leverage artificial intelligence to interpret natural-language inputs while maintaining consistency with existing problem-solution approaches reflected within prior versions of source code.

Artificial intelligence systems capable of generating source code from natural language inputs have gained significant adoption in modern software development workflows. These systems enable individuals, including those with limited programming expertise, to describe desired functionality in plain language and receive executable code in response. However, automatically generated code frequently omits robust input validation mechanisms, particularly when the software is intended to receive data from external sources such as user interfaces, remote services, or third-party data feeds. The absence of proper validation can expose applications to security vulnerabilities, data integrity issues, and system instability. Existing approaches either rely on the user to independently specify detailed validation requirements within the initial prompt or depend on the artificial intelligence model to infer such requirements without structured guidance, which can lead to inconsistent or incomplete safeguards. Accordingly, there is a need for systems and methods that proactively identify when externally sourced data is involved and incorporate user-guided input validation into automatically generated source code to improve reliability, security, and compliance with development best practices.

Artificial intelligence-based code generation systems have become increasingly capable of translating natural language inputs into executable source code, thereby accelerating software development and lowering the barrier to programming. However, code produced by such systems often lacks robust safeguards against run-time failures, including exceptions, invalid inputs, resource unavailability, and other execution-time faults that may not be apparent during initial generation. Conventional development workflows rely on manual review, static analysis tools, or post-execution debugging to identify and address these issues, which can be time-consuming and error-prone. Moreover, existing automated code generation techniques typically focus on functional correctness of the primary logic without systematically incorporating comprehensive error handling constructs tailored to multiple potential run-time scenarios. As a result, generated applications may exhibit instability, reduced reliability, or security vulnerabilities when deployed. Accordingly, there is a need for improved techniques that automatically identify potential run-time errors in AI-generated source code and integrate appropriate error handling instructions prior to execution.

Modern software development increasingly relies on third-party dependencies, such as external libraries, frameworks, and application programming interfaces, to accelerate development and extend functionality. At the same time, artificial intelligence models capable of generating source code from natural language inputs have become more prevalent, enabling developers to describe desired functionality in plain language and receive corresponding code implementations. However, conventional AI-based coding systems typically generate code without systematically evaluating multiple alternative third-party dependencies that could satisfy a given requirement. As a result, generated code may rely on suboptimal, outdated, incompatible, or less secure dependencies. Existing approaches often lack mechanisms for analyzing contextual information, metadata, performance characteristics, compatibility constraints, licensing considerations, or other data associated with alternative third-party dependencies prior to code generation. Accordingly, there is a need for improved systems and methods that enable an artificial intelligence model to intelligently evaluate and select among multiple alternative third-party dependencies based on relevant data, and to incorporate a selected dependency into generated source code in response to natural language input.

Modern software development increasingly relies on distributed architectures, including microservices-based systems, to improve scalability, modularity, and maintainability. At the same time, artificial intelligence models capable of generating and modifying source code have emerged as tools to assist developers in accelerating development cycles and reducing manual effort. However, existing AI-assisted coding solutions generally focus on generating isolated code snippets or performing limited refactoring within a monolithic context, without intelligently identifying opportunities to implement functionality as discrete microservices or seamlessly integrating such microservices into an existing codebase. Developers are therefore often required to manually determine when a microservice architecture is appropriate, design the service interfaces, generate the corresponding source code, and modify the existing codebase to interact with the newly created services. This manual process can be error-prone, inconsistent, and time-consuming, particularly when working with evolving requirements expressed in natural language. Accordingly, there is a need for improved systems and methods that leverage artificial intelligence to analyze natural language inputs, identify opportunities for microservice implementation, generate corresponding service-specific source code, and automatically update existing codebases to incorporate interactions with the generated microservices.

Artificial intelligence-based code generation systems, such as those built on large language models, have significantly accelerated software development by enabling developers to describe desired functionality in natural language and receive corresponding source code. However, while such tools can produce syntactically correct and functionally plausible code, they do not consistently generate comprehensive, context-aware testing procedures aligned with the user's original intent. As a result, developers must often manually design and execute unit tests, integration tests, or other validation procedures to verify correctness, security, and performance. This manual testing process introduces inefficiencies, increases the likelihood of defects, and may lead to discrepancies between the intended functionality described in natural language and the actual behavior of the generated code. Accordingly, there is a need for improved systems and methods that automatically derive and execute appropriate testing procedures in conjunction with artificial intelligence-based source code generation to ensure reliable and validated outputs.

Conventional artificial intelligence conversational models are generally designed to preserve and reproduce learned associations in order to generate consistent and contextually relevant responses to user inputs. However, such behavior creates challenges in environments subject to privacy, regulatory, or policy compliance requirements, particularly where information associated with identifiable individuals must be limited, modified, or omitted upon request. In some instances, a model may generate and provide a response that includes a particular aspect of such information, after which continued availability or reproduction of that aspect in subsequent outputs may give rise to compliance risks or conflicts with user directives. Accordingly, there is a need for improved techniques that enable artificial intelligence conversational systems to selectively suppress specified aspects of information in generated responses following a request, while continuing to provide coherent and contextually appropriate outputs.

In modern software development, artificial intelligence assisted coding tools are increasingly used to generate and modify source code based on natural language inputs. While such tools can significantly improve developer productivity, challenges arise when underlying software tools, libraries, or frameworks are updated to newer versions. Conventional systems often lack mechanisms to ensure that previously generated code remains consistent with prior guidance or user intent after such updates, leading to incompatibilities, regressions, or deviations from the original specifications. Moreover, existing approaches typically require manual intervention to reconcile differences between versions, which is time-consuming and error-prone. Accordingly, there is a need for improved techniques that leverage artificial intelligence to automatically update source code in response to changes in dependent software tools, while maintaining conformance with the original natural language input and preserving the intended functionality across versions.

In modern software development, particularly in systems leveraging artificial intelligence, managing and extending complex codebases organized into hierarchical folder structures presents ongoing challenges. Conventional development workflows often require manual interpretation of user requirements and deliberate placement of newly generated source code within appropriate directories, which can be time-consuming and prone to inconsistency. Recent advances in artificial intelligence models have enabled automated code generation from natural language inputs; however, existing approaches typically focus on generating code in isolation without adequately addressing integration into structured code repositories. As a result, there is a need for improved techniques that not only generate source code responsive to natural language modification requests, but also intelligently determine appropriate locations within a multi-folder codebase and seamlessly incorporate the generated artifacts to produce an updated and coherent version of the codebase.

### SUMMARY OF THE INVENTION

In some examples, systems, methods and non-transitory computer readable media for control and alignment in AI coding are provided. An artificial intelligence model may generate and modify source code based on natural language inputs, for example within a managed development environment. Outputs of the artificial intelligence model may be monitored and evaluated to detect inconsistencies or misalignment with intended inputs, and operations to improve reliability may be selectively adjusted. Evolution of the codebase may be governed by applying constraints, maintaining consistency with prior outputs, and controlling integration of generated code. By introducing structured oversight of artificial intelligence behavior, predictability, reliability, and quality of software produced using artificial intelligence may be improved.

In some examples, systems, methods and non-transitory computer readable media for handling misalignments in artificial intelligence processes that include task decomposition are provided. In some examples, an artificial intelligence model may be accessed. Further, an input may be received. The artificial intelligence model may be used to perform a sequence of at least three steps. The at least three steps may include at least a first step and a last step. The first step may include analyzing the input to generate an intermediate result. Each intermediate step of the at least three steps may include analyzing a respective preceding intermediate result of a respective step immediately preceding the intermediate step to generate a respective new intermediate result. The last step may include analyzing the intermediate result of the step immediately preceding the last step and generating a response to the input. An indication of a misalignment between the input and the generated response may be received. The intermediate results may be used to identify at least one particular step of the at least three steps associated with the misalignment. The at least three steps may include at least one step not included in the at least one particular step.

In some examples, systems, methods and non-transitory computer readable media for version control in artificial intelligence coding are provided. In some examples, an artificial intelligence model may be accessed. A first version of a source code may be accessed. The first version of the source code may be committed to a version control system. A first input in a natural language may be received. The artificial intelligence model may be used to analyze the first input in the natural language and at least portion of the first version of the source code to generate a second version of the source code. After generating the second version of the source code, a second input in the natural language may be received. At least one of the first input, the second input or at least part of the second version of the source code may be analyzed to determine not to commit the second version of the source code to the version control system. Triggering a committing of the second version of the source code to the version control system may be avoided. The artificial intelligence model may be used to analyze the second input in the natural language and at least portion of the second version of the source code to generate a third version of the source code. After generating the third version of the source code, a third input in the natural language may be received. At least one of the second input, the third input or at least part of the third version of the source code may be analyzed to determine to commit the third version of the source code to the version control system. A committing of the third version of the source code to the version control system may be triggered.

In some examples, systems, methods and non-transitory computer readable media for software architecture in artificial intelligence coding are provided. In some examples, an artificial intelligence model may be accessed. A data-structure identifying at least one coding guideline may be accessed. A first input in a natural language may be received. The artificial intelligence model and the at least one coding guideline may be used to analyze the first input to generate at least first part of a source code adhering to the at least one coding guideline. After generating the at least first part of the source code, a modification to the at least one coding guideline may be identified. A second input in the natural language may be received. The artificial intelligence model and the modified at least one coding guideline may be used to analyze the second input to generate at least second part of the source code adhering to the modified at least one coding guideline.

In some examples, systems, methods and non-transitory computer readable media for consistency in artificial intelligence coding are provided. In some examples, an artificial intelligence model may be accessed. A first version of a source code may be accessed. An input in a natural language may be received. The input in the natural language may be analyzed to determine a need to solve a first problem. At least first part of the first version of the source code may be analyzed to identify in the first version of the source code a solution to a second problem. The solution to the second problem may be associated with a particular approach for solving problems. The artificial intelligence model may be used to analyze the input in the natural language to modify at least second part of the first version of the source code based on the particular approach, to thereby obtain a second version of the source code including a solution to the first problem based on the particular approach.

In some examples, systems, methods and non-transitory computer readable media for input validation in artificial intelligence coding are provided. In some examples, an artificial intelligence model may be accessed. An input in a natural language associated with a desire of an individual to generate source code for a software may be received. The input in the natural language may be analyzed to determine a need for the software to receive data from an external source. Guidance associated with input validation for the received data may be requested from the individual. The requested guidance may be received from the individual. The artificial intelligence model may be used to analyze the input in the natural language to generate the source code, the generated source code includes instructions for receiving the data from the external source and instructions for validating the received data based on the received guidance.

In some examples, systems, methods and non-transitory computer readable media for error handling in artificial intelligence coding are provided. In some examples, an artificial intelligence model may be accessed. An input in a natural language may be received. The artificial intelligence model may be used to analyze the input in the natural language to generate a source code. A plurality of different potential run-time errors associated with the generated source code may be determined. For each potential run-time error of the plurality of different potential run-time errors, respective error handling instructions may be added to the generated source code.

In some examples, systems, methods and non-transitory computer readable media for using third-party dependencies in artificial intelligence coding are provided. In some examples, an artificial intelligence model may be accessed. An input in a natural language may be received. The input in the natural language may be analyzed to determine an opportunity for using at least one of a plurality of alternative third-party dependencies. For each third-party dependency of the plurality of alternative third-party dependencies, respective data associated with the third-party dependency may be obtained. The obtained data may be analyzed to select a particular third-party dependency of the plurality of alternative third-party dependencies. The artificial intelligence model may be used to analyze the input in the natural language to generate a source code. The source code may include usage of the particular third-party dependency.

In some examples, systems, methods and non-transitory computer readable media for using microservices in artificial intelligence coding are provided. In some examples, an artificial intelligence model may be accessed. A preliminary version of a codebase may be accessed. The preliminary version of the codebase may include at least one preliminary source code. An input in a natural language associated with a desire to modify the preliminary version of the codebase may be received. The input in the natural language may be analyzed to determine an opportunity for using a microservice. The artificial intelligence model may be used to analyze the input to generate at least one specific source code for implementing the microservice. An updated version of the codebase may be obtained by: using the artificial intelligence model to analyze the input and the at least one preliminary source code to modify the at least one preliminary source code to include at least one interaction with the microservice; and including the at least one specific source code in the codebase.

In some examples, systems, methods and non-transitory computer readable media for testing in artificial intelligence coding are provided. In some examples, an artificial intelligence model may be accessed. An input in a natural language associated with a desire to generate a source code may be received. The artificial intelligence model may be used to analyze the input in the natural language to generate one or more testing procedures for the source code. The artificial intelligence model may be used to analyze the input in the natural language to generate at least part of the source code. The generated one or more testing procedures may be executed on the source code.

In some examples, systems, methods and non-transitory computer readable media for forgetting in artificial intelligence conversational models are provided. In some examples, an artificial intelligence model may be accessed. A first input in a natural language may be received. The artificial intelligence conversational model may be used to analyze the first input and generate a first response. The first response may comprise information corresponding to at least one particular aspect of information associated with a particular individual. The generated first response may be provided. After providing the first response, a request to suppress the at least one particular aspect of information associated with the particular individual may be received. After receiving the request, a second input in the natural language may be received. The second input may convey a substantially same meaning as the first input. The artificial intelligence conversational model may be used to analyze the second input and generate a second response. In response to the received request, the second response may not comprise any information corresponding to the at least one particular aspect of information associated with the particular individual. The generated second response may be provided.

In some examples, systems, methods and non-transitory computer readable media for maintaining conformance to prior guidance when updating source code using artificial intelligence coding are provided. In some examples, an artificial intelligence model may be accessed. An input in a natural language may be received. The artificial intelligence model may be used to analyze the input in the natural language to generate at least part of a first version of a source code. The first version of the source code may include usage of a first version of a software tool. A trigger, associated with an update of the software tool to a second version of the software tool, for updating the source code may be identified. In response to the identified trigger, the artificial intelligence model may be used to update the source code based on the second version of the software tool and the input in the natural language, to thereby obtain a second version of the source code. The second version of the source code may include usage of the second version of the software tool, the second version of the source code conforms to the input in the natural language.

In some examples, systems, methods and non-transitory computer readable media for folders in artificial intelligence coding are provided. In some examples, an artificial intelligence model may be accessed. A preliminary version of a codebase may be accessed. The preliminary version of the codebase may include a plurality of preliminary source code files arranged in a plurality of folders. An input in a natural language associated with a desire to modify the preliminary version of the codebase may be received. The artificial intelligence model may be used to analyze the input in the natural language to generate at least one additional source code file. A specific folder may be selected of the plurality of folders for the at least one additional source code file. The at least one additional source code file may be added to the codebase at the selected specific folder to obtain an updated version of the codebase.

### BRIEF DESCRIPTION OF DRAWINGS

FIG. 1A is a block diagram illustrating some possible flows of information, consistent with some embodiments of the present disclosure.

FIG. 1B is a block diagram illustrating some possible flows of information, consistent with some embodiments of the present disclosure.

FIG. 1C is a block diagram illustrating a possible implementation of a communicating system, consistent with some embodiments of the present disclosure.

FIGS. 2A and 2B are block diagrams illustrating some possible implementations of an apparatus, consistent with some embodiments of the present disclosure.

FIG. 3 is a block diagram illustrating an example embodiment of a memory containing software modules, consistent with some embodiments of the present disclosure.

FIG. 4A is a flowchart of an example process for handling misalignments in artificial intelligence processes that includes task decomposition, consistent with some embodiments of the present disclosure.

FIG. 4B is a flowchart of an example process resulting from task decomposition, consistent with some embodiments of the present disclosure.

FIG. 5 is a flowchart of an example process for version control in artificial intelligence coding, consistent with some embodiments of the present disclosure.

FIG. 6 is a flowchart of an example process for software architecture in artificial intelligence coding, consistent with some embodiments of the present disclosure.

FIG. 7 is a flowchart of an example process for consistency in artificial intelligence coding, consistent with some embodiments of the present disclosure.

FIG. 8 is a flowchart of an example process for input validation in artificial intelligence coding, consistent with some embodiments of the present disclosure.

FIG. 9 is a flowchart of an example process for error handling in artificial intelligence coding, consistent with some embodiments of the present disclosure.

FIG. 10 is a flowchart of an example process for using third-party dependencies in artificial intelligence coding, consistent with some embodiments of the present disclosure.

FIG. 11 is a flowchart of an example process for using microservices in artificial intelligence coding, consistent with some embodiments of the present disclosure.

FIG. 12 is a flowchart of an example process for testing in artificial intelligence coding, consistent with some embodiments of the present disclosure.

FIG. 13 is a flowchart of an example process for forgetting in artificial intelligence conversational models, consistent with some embodiments of the present disclosure.

FIG. 14 is a flowchart of an example process for maintaining conformance to prior guidance when updating source code using artificial intelligence coding, consistent with some embodiments of the present disclosure.

FIGS. 15A and 15B are flowcharts of example processes for folders in artificial intelligence coding, consistent with some embodiments of the present disclosure.

### DETAILED DESCRIPTION OF THE INVENTION

Unless specifically stated otherwise, as apparent from the following discussions, it is appreciated that throughout the specification discussions utilizing terms such as “processing”, “calculating”, “computing”, “determining”, “generating”, “setting”, “configuring”, “selecting”, “defining”, “applying”, “obtaining”, “monitoring”, “providing”, “identifying”, “segmenting”, “classifying”, “analyzing”, “associating”, “extracting”, “storing”, “receiving”, “transmitting”, “presenting”, “causing”, “using”, “basing”, “halting” or the like, include action and/or processes of a computer that manipulate and/or transform data into other data, said data represented as physical quantities, for example such as electronic quantities, and/or said data representing the physical objects. The terms “computer”, “processor”, “controller”, “processing unit”, “computing unit”, and “processing module” should be expansively construed to cover any kind of electronic device, component or unit with data processing capabilities, including, by way of non-limiting example, a personal computer, a wearable computer, a tablet, a smartphone, a server, a computing system, a cloud computing platform, a communication device, a processor (for example, digital signal processor (DSP), an image signal processor (ISR), a microcontroller, a field programmable gate array (FPGA), an application specific integrated circuit (ASIC), a central processing unit (CPA), a graphics processing unit (GPU), a visual processing unit (VPU), and so on), possibly with embedded memory, a single core processor, a multi core processor, a core within a processor, any other electronic computing device, or any combination of the above.

The operations in accordance with the teachings herein may be performed by a computer specially constructed or programmed to perform the described functions.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) may be included in at least one embodiment of the presently disclosed subject matter. Thus, the appearance of the phrase “one case”, “some cases”, “other cases” or variants thereof does not necessarily refer to the same embodiment(s). As used herein, the term “and/or” includes any and all combinations of one or more of the associated listed items.

As used herein, the phrase “may not” means “might not”. As used herein, the phrase “at least one of” followed by a list of items means one or more of the listed items, including any number and any combination thereof, including any positive integer number of such elements, including one, two, three, ..., up to and including all of the elements. Similarly, the term “at least x” for a positive integer x means x or more, including any positive integer number or a range of positive integer numbers of such elements as long as all the positive integer(s) are at least x (such as x, x+1, x+2, x+4, x+5, ..., at least x+1, at least x+2, at least x+3, ..., at least y but no more than z for y greater than or equal to x and z greater than y, and so forth). As used herein, the phrase “one or more” with respect to a listed item or group of items means any positive integer quantity of such item(s), including one, two, three, ..., up to and including all of the listed item(s). Similarly, the phrase “x or more” for a positive integer x includes any positive integer number or a range of positive integer numbers of such elements as long as all the positive integer(s) are at least x (such as x, x+1, x+2, x+4, x+5, ..., at x+1 or more, x+2 or more, x+3 or more, ..., at least y but no more than z for y greater than or equal to x and z greater than y, and so forth).

Some non-limiting examples of a mathematical object in a mathematical space may include a mathematical point in the mathematical space, a group of mathematical points in the mathematical space (such as a region, a manifold, a mathematical subspace, etc.), a mathematical shape in the mathematical space, a numerical value, a vector, a matrix, a tensor, a function, and so forth. Another non-limiting example of a mathematical object is a vector, wherein the dimension of the vector may be at least two (for example, exactly two, exactly three, more than three, and so forth). Some non-limiting examples of a phrase may include a phrase of at least two words, a phrase of at least three words, a phrase of at least five words, a phrase of more than ten words, and so forth. Some non-limiting examples of a mathematical function may include a linear function, a non-linear function, a polynomial function, an exponential function, a logarithmic function, a continuous function, a discontinuous function, a single-variate function, a multivariate function, a similarity function, a scoring function, a ranking function, and so forth. In some examples, a result value (for example, of calculating a mathematical function, of calculating a convolution, of an algorithm, etc.) may be used to select elements and/or to determine information and/or to generate content. Some non-limiting examples of such result value may include a numerical result value, a mathematical object in a mathematical space, a word, a utterance, a string, and so forth. For example, when the result value equals a first value or in a first group of values, a first element may be selected and/or first information may be determined and/or a first content may be generated, and when the result value equals a second value (different from the first value) or in a second group of values (mutually exclusive to the first group), a second element (that may be different from the first element) may be selected and/or second information (that may be different from the first information) may be determined and/or a first content (that may be different from the first content) may be generated. In another example, the result value may be used a seed or an input of a generative model for generating the content. In yet another example, the result value may be used a parameter (such as a threshold, an input variable, etc.) to a rule or algorithm used to select elements and/or to determine information and/or to generate content.

In some examples, a determination may be made based on a mathematical object. For example, when the mathematical object is in a first region of a particular mathematical space, a first determination may be made, and when the mathematical object is in a second region of the particular mathematical space, a second determination (different from the first determination) may be made. In some examples, a selection may be made based on a mathematical object. For example, an item may be selected of a plurality of alternative items based on the mathematical objects. For example, when the mathematical object is in a first region of a particular mathematical space, a first item of the plurality of alternative items may be selected, and when the mathematical object is in a second region of the particular mathematical space, a second item of the plurality of alternative items (different from the first item) may be selected. For example, an option may be selected of a plurality of alternative options based on the mathematical objects. For example, when the mathematical object is in a first region of a particular mathematical space, a first option of the plurality of alternative options may be selected, and when the mathematical object is in a second region of the particular mathematical space, a second option of the plurality of alternative options (different from the first option) may be selected. In some examples, content may be generated based on a mathematical object. For example, the mathematical object may be used as an input or a seed value of a generative model used to generate the content. In another example, when the mathematical object is in a first region of a particular mathematical space, a first content may be generated, and when the mathematical object is in a second region of the particular mathematical space, a second content (different from the first content) may be generated.

In some examples, a user interface consistent with some embodiments of the present disclosure may enable a computerized system to present information to one or more individuals (for example, visually, audibly, textually, graphically, and so forth), may enable one or more individuals to provide information to a computerized system, may enable a computerized system to react to inputs received from one or more individuals (for example, by modifying presented information, by presenting new information, by stopping to present information, and so forth). In a non-limiting example consistent with some embodiments of the present disclosure, a user interface may include a webpage, such as a website that present information to a user, receive inputs from the user, and reacts to the inputs received from the user. In a non-limiting example consistent with some embodiments of the present disclosure, a user interface may be or include a user interface of an app, for example a software app configured to operate with an operating system of a mobile or a stationary device. In a non-limiting example consistent with some embodiments of the present disclosure, a user interface may be or include a user interface configured to operate with at least one of a keyboard, a computer mouse, a touchscreen or a touchpad. For example, the user interface may be configured to receive inputs from a user via at least one of a keyboard, a computer mouse, a touchscreen or a touchpad. In a non-limiting example consistent with some embodiments of the present disclosure, a user interface may be or include a user interface configured for usage in an extended reality environment. For example, the user interface may be configured to present information in the extended reality environment via an extended reality appliance. In one example, the user interface may be configured to receive information from the user via voice commands and/or speech recognition. In one example, the user interface may be configured to receive information from the user via gestures of the user, for example using a gesture recognition algorithm.

In some examples, a design element may be or include a visual element, such as an image, a video, an animation, an illustration, a logo, and so forth. In some examples, a design element may be or include an audio element, such as sequence of sounds, sound effect, music, speech, background music, and so forth. In some examples, a design element may be or include a textual element. In some examples, a design element may be or include at least one font characteristic, such as a typeface, a font size, a text style (such as regular, bold, italic, underline, strikethrough, and so forth), a text position (such as subscript, superscript, default, and so forth), letter spacing, line spacing, a foreground color, a background color, a foreground texture, a background texture, a foreground pattern, a background pattern, and so forth. In some examples, a design element may be or include a user interface element. In some examples, a design element may be or include a color scheme. In some examples, a design element may be or include a background.

In some examples, a user interface element may be an element presenting information and/or enabling a user to enter new information and/or enabling a user to modify information and/or enabling a user to enter selections and/or enabling a user to provide a command and/or enabling a user to initiate a process. Some non-limiting examples of user interface element may include input controls, navigational components, informational components, checkboxes, radio buttons, dropdown lists, list boxes, buttons, dropdown buttons, toggles, text fields, date pickers, time pickers, search fields, breadcrumbs, pagination, tags, sliders, icons, image carousels, notifications, progress bars, tooltips, message boxes, popups, and so forth. In some examples, one user interface element, such as an accordion, may contain a plurality of other user interface elements. In one example, a user interface element may be or include a design element.

In some examples, a design of a user interface may be or include one or more design elements. In some examples, a design of a user interface may be or include a layout for at least part of the elements included in the user interface. In some examples, a design of a user interface may be or include a color scheme of at least part of the user interface. In some examples, a design of a user interface may be or include a density of details in the user interface. In some examples, a design of a user interface may be or include a selection of sizes of at least part of the elements included in the user interface. In some examples, a design of a user interface may be or include a selection of shapes of at least part of the elements included in the user interface. In some examples, a design of a user interface may be or include a selection of font characteristics of at least part of the elements included in the user interface. In some examples, a design of a user interface may be or include a selection of positions for at least part of the elements included in the user interface. In some examples, a design of a user interface may be or include a selection of distances between at least part of the elements included in the user interface.

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

In embodiments of the presently disclosed subject matter, one or more stages illustrated in the figures may be executed in a different order and/or one or more groups of stages may be executed simultaneously. The figures illustrate a general schematic of the system architecture in accordance embodiments of the presently disclosed subject matter. Each module in the figures can be made up of any combination of software, hardware and/or firmware that performs the functions as defined and explained herein. The modules in the figures may be centralized in one location or dispersed over more than one location.

It should be noted that some examples of the presently disclosed subject matter are not limited in application to the details of construction and the arrangement of the components set forth in the following description or illustrated in the drawings. The invention can be capable of other embodiments or of being practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing may have the same use and description as in the previous drawings.

The drawings in this document may not be to any scale. Different figures may use different scales and different scales can be used even within the same drawing, for example different scales for different views of the same object or different scales for the two adjacent objects.

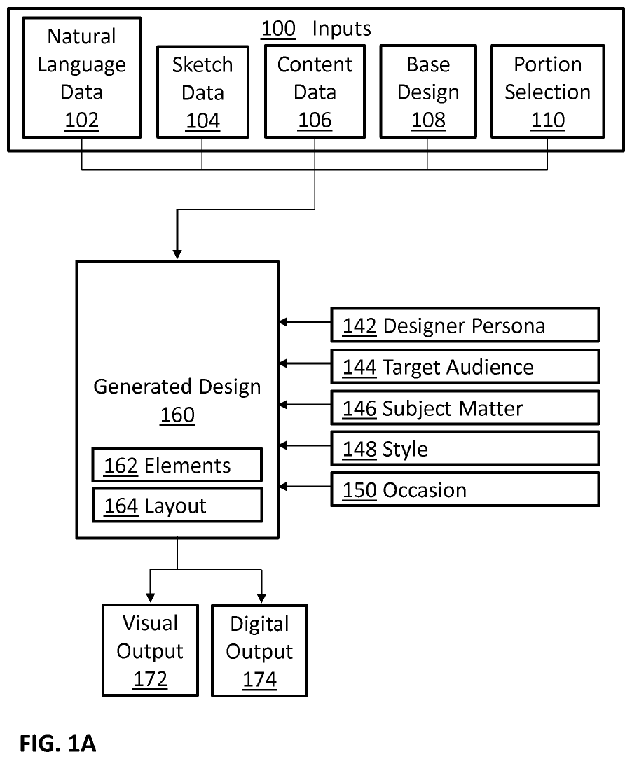

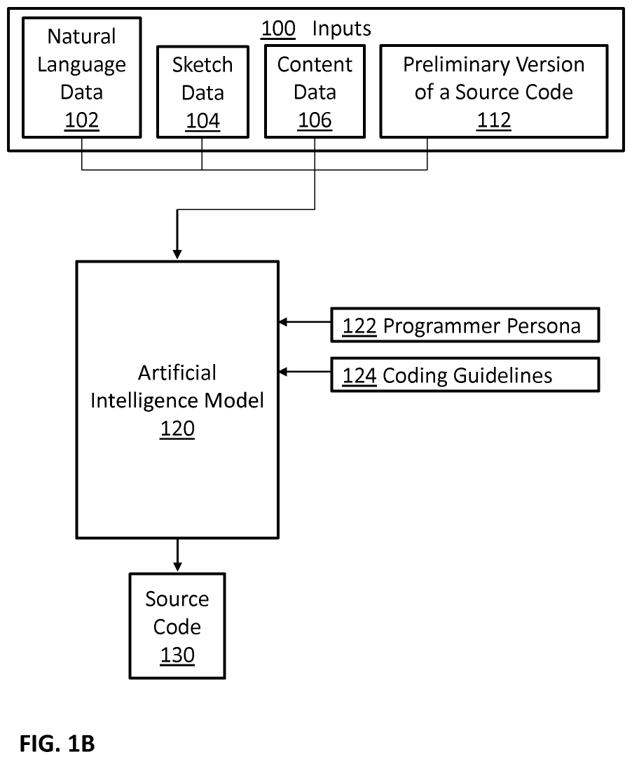

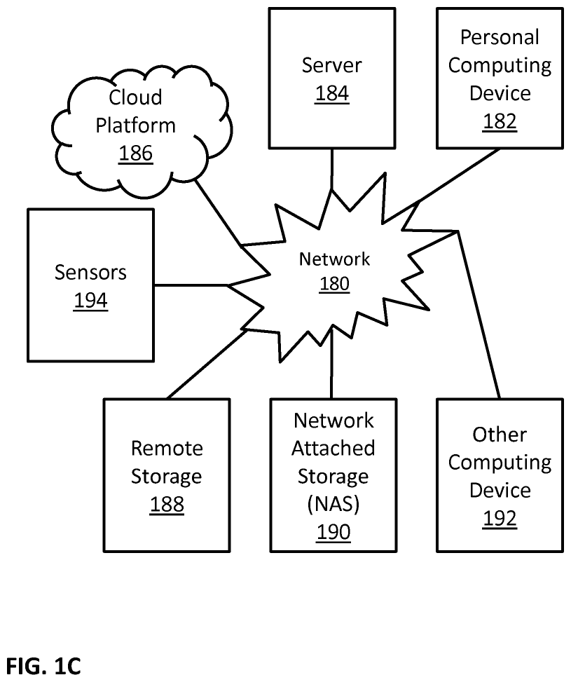

FIG. 1A is a block diagram illustrating some possible flows of information consistent with some embodiments of the present disclosure. In this example, inputs 100 may comprise at least one of natural language data 102, sketch data 104, content data 106, base design 108 or portion selection 110. In other examples, the inputs 100 may include any other type of information. In one example, inputs 100 may comprise information encoded in a digital format and/or in a digital signal. In some examples, natural language data 102 may include any textual information, such as textual content in natural language, source code, formatted text records, textual input, textual files, and so forth. For example, natural language data 102 may include an encoding of textual content in digital format, an encoding of textual content in analog format, a hardcopy, and so forth. In some examples, natural language data 102 may include audible speech data in the natural language. In some examples, sketch data 104 may include any data corresponding to a visual representation of at least part of a user interface. For example, sketch data 104 may include an encoding of the visual representation in a digital format, an encoding of the visual representation in an analog format, a hardcopy, and so forth. Some non-limiting examples of such visual representation may include a hand-drawn sketch, a digital-drawing, a schematic drawing, a picture, and so forth. In some examples, content data 106 may indicate content for inclusion in the user interface, such as audio content, visual content, sounds, images, videos, animations, texts, slogans, logos, and so forth. For example, content data 106 may include the contents, may include an identifier of the contents (such as file name, identifier in a database, etc.), hardcopies, and so forth. In some examples, base design 108 may include a design of a user interface to be modified, replaced or used as an inspiration. For example, base design 108 may include digital data (such as source code of the base design, for example in as HyperText Markup Language and/or Cascading Style Sheets formats), a visual representation of the base design (such as screenshots of the base design, a sketch of the base design, etc.), a textual description of the visual representation, and so forth. In some examples, portion selection 110 may include an indication of a portion of the base design. For example, the selection of the portion may be received from an individual, for example via a user interface for selecting the portion, via a pointing device (such as a computer mouse, a joystick, a trackpad, a touchpad, etc.), via gestures, via textual description of the portion, and so forth. In another example, the selection of the portion may be received from another automated process, such as an attention mechanism. In some examples, selected portion 110 may correspond to a convex region of the base design, to a concave region of the base design, to a continuous region of the base design, to a fragmented region of the base design, and so forth. In the examples of FIG. 1A and FIG. 1B, any one of inputs 100, alone or in combination, may be analyzed or otherwise used.

In some examples, an indication of a designer persona, such as designer persona 142, may be obtained. For example, the indication of the designer persona may include or enable access to information related to the designer persona. For example, information related to the designer persona may be read from memory (such as memory 210), may be received from an external computing device (for example, using a digital communication device), may be determined based on an analysis of historic designs (such as historic designs generated by the designer persona, historic designs liked by the designer persona, etc.) associated with the designer persona, may be received from an individual (for example, via a user interface), and so forth. For example, the information related to the designer persona may include at least a portion of historic designs associated with the designer persona, may include an indication of design elements (such as visuals and/or texts and/or layouts and/or colors and/or fonts) associated with the designer persona (for example, design elements commonly used by the designer persona), may include an indication of a style (such as style 148, a drawing style, etc.) associated with the designer persona, may include an indication of layout preferences associated with the designer persona, and so forth. In one example, the designer persona may be selected based on target audience 144 and/or subject matter 146 and/or style 148 and/or occasion 150. For example, a particular designer persona may have previous success making designs related to an occasion or aimed at a target audience, and may be therefore selected.

In some examples, an indication of a target audience, such as target audience 144, may be obtained. For example, the indication of the target audience may include or enable access to information related to the target audience. For example, information related to the target audience may be read from memory (such as memory 210), may be received from an external computing device (for example, using a digital communication device), may be determined based on an analysis of historic designs associated with the target audience, may be received from an individual (for example, via a user interface), and so forth. For example, the information related to the target audience may include at least a portion of historic designs associated with the target audience (for example, historic designs consumed or liked by the target audience, historic designs that drove the target audience to action, etc.), may include an indication of design elements (such as visuals and/or texts and/or layouts and/or colors and/or fonts) associated with the target audience (for example, design elements commonly consumed by the target audience, design elements that drove the target audience to action, etc.), may include an indication of a style (such as style 148,) associated with the target audience, may include an indication of layout preferences associated with the target audience, may include an indication of a location (such as a physical location, a virtual location, a geographical region, a category of locations, etc.) associated with the target audience, may include an indication of a demographic characteristic (such as age, gender, ethnicity, religion, income level, education level, etc.) associated with the target audience, may include an indication of a past actions and/or past events associated with the target audience, may include an indication of behavior patterns associated with the target audience, may include an indication of one or more languages associated with the target audience, and so forth. In one example, a target audience (such as target audience 144) may be a target audience of a single particular individual, may be a target audience of at least two individuals, may be a target audience of at least three individuals, may be a target audience of at least one thousand individuals, may be a target audience of at least one million individuals, and so forth. In some examples, a textual data in a natural language may be analyzed to determine a characteristic of the target audience, for example using a Large Language Model (LLM). In some examples, the information related to the target audience and/or historic activities of individuals associated with the target audience may be analyzed to determine a characteristic of the target audience, for example using a rule based analysis. Some non-limiting examples of such characteristics of the target audience may include susceptibility to styles and/or designs and/or layouts and/or design elements and/or textual messages and/or color schemes and/or fonts, demographic characteristics (such as age group, gender, ethnicity, religion, income level, education level, etc.) associated with the target audience, inclination to taking specific actions, behavior patterns, languages, and so forth.

In some examples, an indication of a subject matter, such as subject matter 146, may be obtained. For example, the indication of the subject matter may include or enable access to information related to the subject matter. For example, information related to the subject matter may be read from memory (such as memory 210), may be received from an external computing device (for example, using a digital communication device), may be determined based on an analysis of historic contents (such as historic textual contents, historic patents, historic visual contents, historic auditory content, historic user interfaces, etc.) associated with the subject matter, may be received from an individual (for example, via a user interface), and so forth. For example, the information related to the subject matter may include at least a portion of historic contents associated with the subject matter, may include an indication of words and/or phrases associated with the subject matter (for example, words and/or phrases commonly used in contents associated with the subject matter), may include an indication of a style (such as style 148, a design style, a drawing style, etc.) corresponding with the subject matter, may include an indication of design elements associated with the subject matter, may include an indication of layouts associated with the subject matter, and so forth. In some examples, image data may be analyzed to determine an indication of the subject matter associated with the generated design. For example, a classification model may be used to classify the image data to a class of a plurality of alternative class, each alternative class may be associated with a subject matter, and thereby the subject matter may be determined from the classification. In some examples, audio data may be analyzed to determine an indication of the subject matter associated with the generated design. For example, a classification model may be used to classify the audio data to a class of a plurality of alternative class, each alternative class may be associated with a subject matter, and thereby the subject matter may be determined from the classification. In one example, the subject matter may be determined based on occasion 150.

In some examples, an indication of a style, such as style 148, may be obtained. For example, the indication of the style may include or enable access to information related to the style. For example, information related to the style may be read from memory (such as memory 210), may be received from an external computing device (for example, using a digital communication device), may be determined based on an analysis of selected historic designs, may be received from an individual (for example, via a user interface), and so forth. For example, style 148 may be a design style, may be a drawing style, and so forth. In one example, style 148 may be a design style of a designer persona (such as designer persona 142), may be a design style selected by an individual, may be a design style that is associated with a subject matter (such as subject matter 146), may be a design style that a target audience (such as target audience 144) is susceptibility to, and so forth. In one example, the information related to the style may include an indication of a level of details, may include an indication of an affinity to specific design elements, may include an indication of an affinity to specific layouts, may include an indication of an affinity to specific element sizes, may include an indication of an affinity to specific color schemes, may include an indication of an affinity to specific fonts, may include an indication of an affinity to specific textual messages, may include an indication of an affinity to specific distance between elements, and so forth. In some examples, textual data in a natural language may be analyzed to determine the style (or the information related to the style), for example using a LLM. In some examples, an indication of the style may be received from an individual, for example via a user interface. In some examples, at least one other user interface may be analyzed to determine the style. In one example, the at least one other user interface may be at least one user interface associated with a specific brand (such as one or more websites associated with the specific brand). In one example, the at least one other user interface may be at least one user interface associated with a specific subject matter (such as subject matter 146).

In some examples, an indication of an occasion, such as occasion 150, may be obtained. For example, the indication of the occasion may include or enable access to information related to the occasion. For example, information related to the occasion may be read from memory (such as memory 210), may be received from an external computing device (for example, using a digital communication device), may be determined based on an analysis of textual data, may be determined based on an analysis of visual data, may be determined based on an analysis of audible data, may be received from an individual (for example, via a user interface), and so forth. Some non-limiting examples of such occasion may include a personal celebration (such as birthday, wedding, anniversary, personal milestone, retirement party, funeral, graduation, etc.), an institutional ceremony, a holiday, a special event, a conference, a seasonal event, a gathering, a sport event, a cultural event, and so forth. In some examples, textual data in a natural language may be analyzed to determine the occasion (or information related to the occasion), for example using a LLM. In one example, the occasion may be determined based on a date, for example using a calendar.

In the example of FIG. 1A, any input of inputs 100, alone or in combination with other inputs and/or information, may be used to generate designs (for example as described herein), and thereby obtaining generated a design (such as design 160). In some examples, the generation of a design (such as design 160) may be further based on at least one of designer persona 142, target audience 144, subject matter 146, or style 148. In one example, a design (such as design 160) may be generated in a style associated with designer persona 142, may include design elements associated with designer persona 142, may include a layout based on the layout preferences associated with the designer persona 142, and so forth. In one example, a design (such as design 160) may be generated in a style associated with target audience 144, may include design elements associated with target audience 144, may include a layout based on the layout preferences associated with the target audience 144, and so forth. In one example, a design (such as design 160) may be generated in a style associated with subject matter 146, may include design elements associated with subject matter 146, may include a layout based on the layouts associated with the subject matter 146, and so forth. In some examples, a design (such as design 160) may be generated in a particular style, for example in style 148. For example, in a particular style selected by an individual, in a particular style associated with a designer persona (such as designer persona 142), in a particular style associated with a target audience (such as target audience 144), in a particular style associated with a specific subject matter (such as subject matter 146), in a particular style selected based on input data, and so forth. For example, a style may include at least one of an affinity to usage of specific design elements, an affinity to specific layout preferences, an affinity to usage of specific visuals, an affinity to usage of specific colors, an affinity to usage of specific shapes, an affinity to usage of specific fonts, an affinity to setting specific size to specific design elements, and so forth. In one example, a particular generative model associated with the particular style may be selected of a plurality of alternative generative models, and a design (such as design 160) may be generated using the particular generative model, thereby generating the design in the particular style. In another example, information associated with the particular style may be used as input to a generative model to cause the generative model to generate a design (such as design 160) in the particular style.

In the example of FIG. 1A, one or more outputs may be provided based on generated design 160. For example, the one or more outputs may include at least one of visual output 172 based on at least part of the generated design 160, or digital output 174 encoding at least part of generated design 160. In one example, digital output 174 may include digital files encoding at least part of generated design 160, for example in HyperText Markup Language (HTML) and/or Cascading Style Sheets (CSS) formats. For example, the digital files may be stored in memory (such as memory unit 210), may be stored in remote storage 188, may be stored in Network Attached Storage 190, and so forth. In one example, digital output 174 may include transmission of digital signals encoding at least part of generated design 160, for example in HTML and/or CSS formats. For example, the digital signals may be transmitted to another computing device using communication module 230. In some examples, generated design 160 may be a design of a user interface. In some examples, generated design 160 may be a design for a visual presentation of information. In some examples, generated design 160 may include elements 162, such as visual elements (such as images, videos, animations, illustrations, logos, etc.), audio elements (such as sequence of sounds, sound effect, music, speech, background music, etc.), design elements, user interface elements, and so forth. In some examples, generated design 160 may include layout 164. In one example, layout 164 may specify locations for elements 162 in the generated design (for example, locations for user interface elements in a user interface, locations for visual elements in a visual presentation, etc.). In one example, layout 164 may specify sizes for elements 162 in the generated design. In one example, layout 164 may specify, when two or more elements of elements 162 overlaps, which one of the two or more elements to favor. In other example, elements 162 may be separated from design 160, and/or design 160 may include layout 164 without any specific element).

FIG. 1B is a block diagram illustrating some possible flows of information, consistent with some embodiments of the present disclosure. In this example, inputs 100 may comprise at least one of natural language data 102, sketch data 104, content data 106, or preliminary version of a source code 112. In other examples, the inputs 100 may include any other type of information. In one example, inputs 100 may comprise information encoded in a digital format and/or in a digital signal. In some examples, preliminary version of a source code 112 may be read from memory (such as memory 210, a digital memory, etc.), may be received from an external computing device (for example, using a digital communication device), may be received from an individual (for example, via a user interface, via an integrated development environment (IDE), via a what-you-see-is-what-you-get application that creates source code from graphical design, via an input device, via a keyboard, via voice recognition, etc.), may be generated (for example, using a generative artificial intelligence model, in response to a prompt, based on a sketch, by altering a different version of the source code, by generating the at least part of the source code from scratch, using the steps and/or processes described herein, using other processes, etc.), as described in relation to step 504, and so forth. In the example of FIG. 1B, any input of inputs 100, alone or in combination with other inputs and/or information, may be used to as inputs to artificial intelligence model 120. Some non-limiting examples of artificial intelligence model 120 may include a generative model, a foundation model, a multi-modal artificial intelligence model, an artificial intelligence conversational model, a deep learning model, an artificial neural network, a trained machine learning model, a physical artificial intelligence model, a world foundation model, and so forth. In one example, artificial intelligence model 120 may include at least one of parameters, weights, structure or architecture, execution instructions, sub-models, mathematical functions, thresholds, rules, or artificial neurons. In one example, artificial intelligence model 120 may be accessed by step 402. Artificial intelligence model 120 may analyze at least part of inputs 100 and/or programmer persona 122 and/or coding guidelines 124 to generate source code 130, for example using any one of the processes and techniques described herein.

In some examples, an indication of a programmer persona, such as programmer persona 122, may be obtained. For example, the indication of the programmer persona may include or enable access to information related to the programmer persona. For example, information related to the programmer persona may be read from memory (such as memory 210), may be received from an external computing device (for example, using a digital communication device), may be determined based on an analysis of historic source code (such as historic source code generated by the programmer persona, historic source code liked by the programmer persona, etc.) associated with the programmer persona, may be received from an individual (for example, via a user interface), and so forth. For example, the information related to the programmer persona may include at least a portion of historic source code associated with the programmer persona, may include an indication of coding characteristics (such as coding style, design pattern, third-party libraries, naming preferences, etc.) associated with the programmer persona (for example, coding characteristics common in source code produced by the programmer persona), may include an indication of a coding style associated with the programmer persona, and so forth. In one example, programmer persona 122 may be associated with a specific human programmer. In another example, programmer persona 122 may be synthetically generated. In some examples, coding guidelines, such as coding guidelines 124, may be obtained, for example using step 604.

FIG. 1C is a block diagram illustrating a possible implementation of a communicating system consistent with some embodiments of the present disclosure. In this example, apparatuses may communicate using communication network 180 or directly with each other. Some non-limiting examples of such apparatuses may include at least one of personal computing device 182 (such as a mobile phone, smartphone, tablet, personal computer, smartwatch, etc.), server 184, cloud platform 186, remote storage 188 and network attached storage (NAS) 190, other computing devices 192, or sensors 194. Some non-limiting examples of communication network 180 may include digital communication network, analog communication network, the Internet, phone networks, cellular networks, satellite communication networks, private communication networks, virtual private networks (VPN), and so forth. FIG. 1C illustrates a possible implementations of a communication system. In some embodiments, other communication systems that enable communication between apparatuses may be used. Some non-limiting examples of sensors 194 may include at least one of a remote sensor, a sensor integrated in a computing device, image sensors (such as image sensor 260), audio sensors (such as audio sensors 250), motion sensors (such as motion sensor 270), positioning sensors (such as positioning sensors 275), touch sensors, proximity sensors, chemical sensors, temperature sensors, barometers, and so forth.

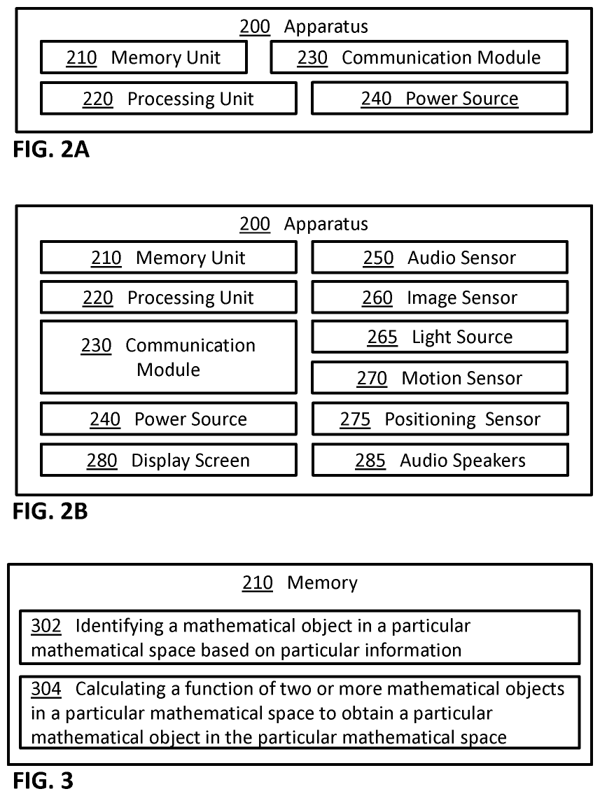

FIG. 2A is a block diagram illustrating a possible implementation of apparatus 200. In this example, apparatus 200 may comprise: one or more memory units 210, one or more processing units 220, and one or more image sensors 260. In some implementations, apparatus 200 may comprise additional components, while some components listed above may be excluded. FIG. 2B is a block diagram illustrating a possible implementation of apparatus 200. In this example, apparatus 200 may comprise: one or more memory units 210, one or more processing units 220, one or more communication modules 230, one or more power sources 240, one or more audio sensors 250, one or more image sensors 260, one or more light sources 265, one or more motion sensors 270, and one or more positioning sensors 275. In some implementations, apparatus 200 may comprise additional components, while some components listed above may be excluded. For example, in some implementations apparatus 200 may also comprise at least one of the following: one or more barometers; one or more user input devices; one or more output devices; and so forth. In another example, in some implementations at least one of the following may be excluded from apparatus 200: memory units 210, communication modules 230, power sources 240, audio sensors 250, image sensors 260, light sources 265, motion sensors 270, and positioning sensors 275. In some embodiments, apparatus 200 may be included and/or may be used as a personal computing device (such as personal computing device 182), a personal computer, a tablet, a mobile phone, a smartphone, a smartwatch, a computing device, a wearable computing device, a head-mounted computing device, a server (such as server 184), a computational node of a cloud platform (for example, of cloud platform 186), a router, a remote storage unit (such as remote storage 188), NAS (such as NAS 190), a sensor (such as sensors 194), and so forth.

In some embodiments, one or more power sources 240 may be configured to power apparatus 200. Possible implementation examples of power sources 240 may include: one or more electric batteries; one or more capacitors; one or more connections to external power sources; one or more power convertors; any combination of the above; and so forth.

In some embodiments, the one or more processing units 220 may be configured to execute software programs. For example, processing units 220 may be configured to execute software programs stored on the memory units 210. In some cases, the executed software programs may store information in memory units 210. In some cases, the executed software programs may retrieve information from the memory units 210. Possible implementation examples of the processing units 220 may include: one or more single core processors, one or more multicore processors; one or more controllers; one or more application processors; one or more system on a chip processors; one or more central processing units; one or more graphical processing units; one or more neural processing units; any combination of the above; and so forth.

In some embodiments, the one or more communication modules 230 may be configured to receive and transmit information. For example, control signals may be transmitted and/or received through communication modules 230. In another example, information received though communication modules 230 may be stored in memory units 210. In an additional example, information retrieved from memory units 210 may be transmitted using communication modules 230. In another example, input data may be transmitted and/or received using communication modules 230. Examples of such input data may include: input data inputted by a user using user input devices; information captured using one or more sensors; and so forth. Examples of such sensors may include: audio sensors 250; image sensors 260; motion sensors 270; positioning sensors 275; chemical sensors; temperature sensors; barometers; and so forth.

In some embodiments, the one or more audio sensors 250 may be configured to capture audio by converting sounds to digital information. Some examples of audio sensors 250 may include: microphones, unidirectional microphones, bidirectional microphones, cardioid microphones, omnidirectional microphones, onboard microphones, wired microphones, wireless microphones, any combination of the above, and so forth. In some examples, the captured audio may be stored in memory units 210. In some additional examples, the captured audio may be transmitted using communication modules 230, for example to other computerized devices. In some examples, processing units 220 may control the above processes. For example, processing units 220 may control at least one of: capturing of the audio; storing the captured audio; transmitting of the captured audio; and so forth. In some cases, the captured audio may be processed by processing units 220. For example, the captured audio may be compressed by processing units 220; possibly followed: by storing the compressed captured audio in memory units 210; by transmitted the compressed captured audio using communication modules 230; and so forth. In another example, the captured audio may be processed using speech recognition algorithms. In another example, the captured audio may be processed using speaker recognition algorithms.

In some embodiments, the one or more image sensors 260 may be configured to capture visual information by converting light to: images; sequence of images; videos; 3D images; sequence of 3D images; 3D videos; and so forth. In some examples, the captured visual information may be stored in memory units 210. In some additional examples, the captured visual information may be transmitted using communication modules 230, for example to other computerized devices. In some examples, processing units 220 may control the above processes. For example, processing units 220 may control at least one of: capturing of the visual information; storing the captured visual information; transmitting of the captured visual information; and so forth. In some cases, the captured visual information may be processed by processing units 220. For example, the captured visual information may be compressed by processing units 220; possibly followed: by storing the compressed captured visual information in memory units 210; by transmitted the compressed captured visual information using communication modules 230; and so forth. In another example, the captured visual information may be processed in order to: detect objects, detect events, detect action, detect face, detect people, recognize person, and so forth.

In some embodiments, the one or more light sources 265 may be configured to emit light, for example in order to enable better image capturing by image sensors 260. In some examples, the emission of light may be coordinated with the capturing operation of image sensors 260. In some examples, the emission of light may be continuous. In some examples, the emission of light may be performed at selected times. The emitted light may be visible light, infrared light, x-rays, gamma rays, and/or in any other light spectrum. In some examples, image sensors 260 may capture light emitted by light sources 265, for example in order to capture 3D images and/or 3D videos using active stereo method.

In some embodiments, the one or more motion sensors 270 may be configured to perform at least one of the following: detect motion of objects in the environment of apparatus 200; measure the velocity of objects in the environment of apparatus 200; measure the acceleration of objects in the environment of apparatus 200; detect motion of apparatus 200; measure the velocity of apparatus 200; measure the acceleration of apparatus 200; and so forth. In some implementations, the one or more motion sensors 270 may comprise one or more accelerometers configured to detect changes in proper acceleration and/or to measure proper acceleration of apparatus 200. In some implementations, the one or more motion sensors 270 may comprise one or more gyroscopes configured to detect changes in the orientation of apparatus 200 and/or to measure information related to the orientation of apparatus 200. In some implementations, motion sensors 270 may be implemented using image sensors 260, for example by analyzing images captured by image sensors 260 to perform at least one of the following tasks: track objects in the environment of apparatus 200; detect moving objects in the environment of apparatus 200; measure the velocity of objects in the environment of apparatus 200; measure the acceleration of objects in the environment of apparatus 200; measure the velocity of apparatus 200, for example by calculating the egomotion of image sensors 260; measure the acceleration of apparatus 200, for example by calculating the egomotion of image sensors 260; and so forth. In some implementations, motion sensors 270 may be implemented using image sensors 260 and light sources 265, for example by implementing a LIDAR using image sensors 260 and light sources 265. In some implementations, motion sensors 270 may be implemented using one or more RADARs. In some examples, information captured using motion sensors 270: may be stored in memory units 210, may be processed by processing units 220, may be transmitted and/or received using communication modules 230, and so forth.

In some embodiments, the one or more positioning sensors 275 may be configured to obtain positioning information of apparatus 200, to detect changes in the position of apparatus 200, and/or to measure the position of apparatus 200. In some examples, positioning sensors 275 may be implemented using one of the following technologies: Global Positioning System (GPS), GLObal NAvigation Satellite System (GLONASS), Galileo global navigation system, BeiDou navigation system, other Global Navigation Satellite Systems (GNSS), Indian Regional Navigation Satellite System (IRNSS), Local Positioning Systems (LPS), Real-Time Location Systems (RTLS), Indoor Positioning System (IPS), Wi-Fi based positioning systems, cellular triangulation, and so forth. In some examples, information captured using positioning sensors 275 may be stored in memory units 210, may be processed by processing units 220, may be transmitted and/or received using communication modules 230, and so forth.

In some embodiments, the one or more chemical sensors may be configured to perform at least one of the following: measure chemical properties in the environment of apparatus 200; measure changes in the chemical properties in the environment of apparatus 200; detect the present of chemicals in the environment of apparatus 200; measure the concentration of chemicals in the environment of apparatus 200. Examples of such chemical properties may include: pH level, toxicity, temperature, and so forth. Examples of such chemicals may include: electrolytes, particular enzymes, particular hormones, particular proteins, smoke, carbon dioxide, carbon monoxide, oxygen, ozone, hydrogen, hydrogen sulfide, and so forth. In some examples, information captured using chemical sensors may be stored in memory units 210, may be processed by processing units 220, may be transmitted and/or received using communication modules 230, and so forth.

In some embodiments, the one or more temperature sensors may be configured to detect changes in the temperature of the environment of apparatus 200 and/or to measure the temperature of the environment of apparatus 200. In some examples, information captured using temperature sensors may be stored in memory units 210, may be processed by processing units 220, may be transmitted and/or received using communication modules 230, and so forth.

In some embodiments, the one or more barometers may be configured to detect changes in the atmospheric pressure in the environment of apparatus 200 and/or to measure the atmospheric pressure in the environment of apparatus 200. In some examples, information captured using the barometers may be stored in memory units 210, may be processed by processing units 220, may be transmitted and/or received using communication modules 230, and so forth.

In some embodiments, the one or more user input devices may be configured to allow one or more users to input information. In some examples, user input devices may comprise at least one of the following: a keyboard, a mouse, a touch pad, a touch screen, a joystick, a microphone, an image sensor, and so forth. In some examples, the user input may be in the form of at least one of: text, sounds, speech, hand gestures, body gestures, tactile information, and so forth. In some examples, the user input may be stored in memory units 210, may be processed by processing units 220, may be transmitted and/or received using communication modules 230, and so forth.

In some embodiments, the one or more user output devices may be configured to provide output information to one or more users. In some examples, such output information may comprise of at least one of: notifications, feedbacks, reports, and so forth. In some examples, user output devices may comprise at least one of: one or more audio output devices (such as audio output devices 285, a headset, a set of speakers, earbuds, etc.); one or more textual output devices; one or more visual output devices (such as visual output devices 280, display screens, see-through displays, extended reality appliances, personal extended reality apparatus, wearable extended reality apparatus, etc.); one or more tactile output devices; and so forth. In some examples, the one or more audio output devices may be configured to output audio to a user, for example through: a headset, a set of speakers, and so forth. In some examples, the one or more visual output devices may be configured to output visual information to a user, for example through: a display screen, an augmented reality display system, a printer, a LED indicator, and so forth. In some examples, the one or more tactile output devices may be configured to output tactile feedbacks to a user, for example through vibrations, through motions, by applying forces, and so forth. In some examples, the output may be provided: in real time, offline, automatically, upon request, and so forth. In some examples, the output information may be read from memory units 210, may be provided by a software executed by processing units 220, may be transmitted and/or received using communication modules 230, and so forth.

FIG. 3 is a block diagram illustrating an example embodiment of a memory containing software modules, consistent with some embodiments of the present disclosure. In this example, memory 210 contains software modules 302 and 304. It is understood that any of the processes and/or individual steps of the processes and/or operations described herein may equally be software modules contained in memory 210. In other examples, memory 210 may contain additional modules or fewer modules. The modules are described in more details below. In one example, at least one of these modules may include data and/or computer implementable instructions that when executed by at least one processor (such as processing units 220) may cause the at least one processor to perform operations for carrying out actions corresponding to at least one of these modules. Any one of these modules may be executed alone or in combination with other modules. It is understood that herein any reference to a step may equally refer to a module and vice versa. In one example, a system may comprise at least one processing unit (such as processing units 220) configured to perform operations for carrying out actions corresponding to at least one of these modules.

In some examples, module 302 may comprise identifying a mathematical object based on particular information. In some examples, the particular information may be or include at least one word, and module 302 may use module 302 to identify the mathematical object based on the at least one word. In one example, the mathematical object may correspond to a specific at least one word. In one example, the mathematical object may be determined based on a specific at least one word. For example, a function or an injective function mapping words to mathematical object in the particular mathematical space may be used based on the specific at least one word to obtain the mathematical object corresponding to the specific at least one word. In some examples, the particular information may be or include at least one instruction, and module 302 may use module 302 to identify the mathematical object based on the at least one instruction. In one example, the mathematical object may correspond to a specific at least one instruction. In one example, the mathematical object may be determined based on a specific at least one instruction. For example, a function or an injective function mapping instructions to mathematical object in the particular mathematical space may be used based on the specific at least one instruction to obtain the mathematical object corresponding to the specific at least one instruction. For example, a word2vec or a Global Vectors for Word Representation (GloVe) algorithm may be used to obtain the function. In another example, a word embedding algorithm may be used to obtain the function. In some examples, the particular information may be or include the mathematical object, and module 302 may simply access the particular information to obtain the mathematical object. In yet another example, the particular information may be or include one or more numerical values, and module 302 may calculate a function of the numerical values to obtain the mathematical object. Some non-limiting examples of such function may include a linear function, a non-linear function, a polynomial function, an exponential function, a logarithmic function, a continuous function, a discontinuous function, and so forth. In some examples, the particular information may be or include at least one sentence in a natural language, and module 302 may use a text embedding algorithm to obtain the mathematical object. In some examples, module 302 may use a machine learning model to analyze the particular information to determine the mathematical object. The machine learning model may be a machine learning model trained using training examples to determine mathematical objects based on information. An example of such training example may include sample information, together with a label indicative of a mathematical object.

In some examples, module 304 may comprise calculating a function of two or more mathematical objects in a particular mathematical space to obtain a particular mathematical object in the particular mathematical space. In one example, module 304 may comprise calculating a function of a plurality of mathematical objects (such as two mathematical objects, three mathematical objects, four mathematical objects, more than four mathematical objects, etc.) in a particular mathematical space to obtain a particular mathematical object in the particular mathematical space. In one example, module 304 may comprise calculating a function of at least one mathematical object (such as a single mathematical object, two mathematical objects, three mathematical objects, four mathematical objects, more than four mathematical objects, etc.) in a particular mathematical space and/or at least one numerical value (such as a single numerical value, two numerical values, three numerical values, four numerical values, more than four numerical values, etc.) to obtain a particular mathematical object in the particular mathematical space. In one example, the particular mathematical object may correspond to a particular at least one word. Some non-limiting examples of such function may include a linear function, a non-linear function, a polynomial function, an exponential function, a logarithmic function, a continuous function, a discontinuous function, and so forth. In one example, the particular at least one word may be determined based on the particular mathematical object. For example, the injective function described in relation to module 302 may be used to determine the particular at least one word corresponding to the particular mathematical object. In one example, the particular mathematical object may correspond to a particular at least one instruction. Some non-limiting examples of such function may include a linear function, a non-linear function, a polynomial function, an exponential function, a logarithmic function, a continuous function, a discontinuous function, and so forth. In one example, the particular at least one instruction may be determined based on the particular mathematical object. For example, the injective function described in relation to module 302 may be used to determine the particular at least one instruction corresponding to the particular mathematical object.

In some embodiments, machine learning algorithms (also referred to as machine learning models in the present disclosure) may be trained using training examples, for example in the cases described below. Some non-limiting examples of such machine learning algorithms may include classification algorithms, data regressions algorithms, image segmentation algorithms, visual detection algorithms (such as object detectors, face detectors, person detectors, motion detectors, edge detectors, etc.), visual recognition algorithms (such as face recognition, person recognition, object recognition, etc.), speech recognition algorithms, mathematical embedding algorithms, natural language processing (NLP) algorithms, support vector machines, random forests, nearest neighbors algorithms, deep learning algorithms, artificial neural network algorithms, convolutional neural network algorithms, recurrent neural network algorithms, linear machine learning models, non-linear machine learning models, ensemble algorithms, and so forth. For example, a trained machine learning algorithm may comprise an inference model, such as a predictive model, a classification model, a data regression model, a clustering model, a segmentation model, an artificial neural network (such as a deep neural network, a convolutional neural network, a recurrent neural network, etc.), a random forest, a support vector machine, and so forth. In some examples, the training examples may include example inputs together with the desired outputs corresponding to the example inputs. Further, in some examples, training machine learning algorithms using the training examples may generate a trained machine learning algorithm, and the trained machine learning algorithm may be used to estimate outputs for inputs not included in the training examples. In some examples, engineers, scientists, processes and machines that train machine learning algorithms may further use validation examples and/or test examples. For example, validation examples and/or test examples may include example inputs together with the desired outputs corresponding to the example inputs, a trained machine learning algorithm and/or an intermediately trained machine learning algorithm may be used to estimate outputs for the example inputs of the validation examples and/or test examples, the estimated outputs may be compared to the corresponding desired outputs, and the trained machine learning algorithm and/or the intermediately trained machine learning algorithm may be evaluated based on a result of the comparison. In some examples, a machine learning algorithm may have parameters and hyper parameters, where the hyper parameters may be set manually by a person or automatically by an process external to the machine learning algorithm (such as a hyper parameter search algorithm), and the parameters of the machine learning algorithm may be set by the machine learning algorithm based on the training examples. In some implementations, the hyper-parameters may be set based on the training examples and the validation examples, and the parameters may be set based on the training examples and the selected hyper-parameters. For example, given the hyper-parameters, the parameters may be conditionally independent of the validation examples.

In some embodiments, trained machine learning algorithms (also referred to as machine learning models and trained machine learning models in the present disclosure) may be used to analyze inputs and generate outputs, for example in the cases described below. In some examples, a trained machine learning algorithm may be used as an inference model that when provided with an input generates an inferred output. For example, a trained machine learning algorithm may include a classification algorithm, the input may include a sample, and the inferred output may include a classification of the sample (such as an inferred label, an inferred tag, and so forth). In another example, a trained machine learning algorithm may include a regression model, the input may include a sample, and the inferred output may include an inferred value corresponding to the sample. In yet another example, a trained machine learning algorithm may include a clustering model, the input may include a sample, and the inferred output may include an assignment of the sample to at least one cluster. In an additional example, a trained machine learning algorithm may include a classification algorithm, the input may include an image, and the inferred output may include a classification of an item depicted in the image. In yet another example, a trained machine learning algorithm may include a regression model, the input may include an image, and the inferred output may include an inferred value corresponding to an item depicted in the image (such as an estimated property of the item, such as size, volume, age of a person depicted in the image, cost of a product depicted in the image, and so forth). In an additional example, a trained machine learning algorithm may include an image segmentation model, the input may include an image, and the inferred output may include a segmentation of the image. In yet another example, a trained machine learning algorithm may include an object detector, the input may include an image, and the inferred output may include one or more detected objects in the image and/or one or more locations of objects within the image. In some examples, the trained machine learning algorithm may include one or more formulas and/or one or more functions and/or one or more rules and/or one or more procedures, the input may be used as input to the formulas and/or functions and/or rules and/or procedures, and the inferred output may be based on the outputs of the formulas and/or functions and/or rules and/or procedures (for example, selecting one of the outputs of the formulas and/or functions and/or rules and/or procedures, using a statistical measure of the outputs of the formulas and/or functions and/or rules and/or procedures, and so forth).

In some embodiments, artificial neural networks may be configured to analyze inputs and generate corresponding outputs, for example in the cases described below. Some non-limiting examples of such artificial neural networks may comprise shallow artificial neural networks, deep artificial neural networks, feedback artificial neural networks, feed forward artificial neural networks, autoencoder artificial neural networks, probabilistic artificial neural networks, time delay artificial neural networks, convolutional artificial neural networks, recurrent artificial neural networks, long short term memory artificial neural networks, and so forth. In some examples, an artificial neural network may be configured manually. For example, a structure of the artificial neural network may be selected manually, a type of an artificial neuron of the artificial neural network may be selected manually, a parameter of the artificial neural network (such as a parameter of an artificial neuron of the artificial neural network) may be selected manually, and so forth. In some examples, an artificial neural network may be configured using a machine learning algorithm. For example, a user may select hyper-parameters for the an artificial neural network and/or the machine learning algorithm, and the machine learning algorithm may use the hyper-parameters and training examples to determine the parameters of the artificial neural network, for example using back propagation, using gradient descent, using stochastic gradient descent, using mini-batch gradient descent, and so forth. In some examples, an artificial neural network may be created from two or more other artificial neural networks by combining the two or more other artificial neural networks into a single artificial neural network.

In some embodiments, generative models may be configured to generate new content, such as textual content, visual content, auditory content, graphical content, layouts, source code, and so forth. In some examples, generative models may generate new content without input. In other examples, generative models may generate new content based on an input. In one example, the new content may be fully determined from the input, where every usage of the generative model with the same input will produce the same new content. In another example, the new content may be associated with the input but not fully determined from the input, where every usage of the generative model with the same input may product a different new content that is associated with the input. In some examples, a generative model may be a result of training a machine learning generative algorithm with training examples. An example of such training example may include a sample input, together with a sample content associated with the sample input. Some non-limiting examples of such generative models may include Deep Generative Model (DGM), Generative Adversarial Network model (GAN), auto-regressive model, Variational AutoEncoder (VAE), transformers based generative model, artificial neural networks based generative model, hard-coded generative model, and so forth.

A Large Language Model (LLM) is a generative language model with a large number of parameters (usually billions or more) trained on large corpus of unlabeled data (usually trillions of words or more) in a self-supervised learning scheme and/or a semi-supervised learning scheme. While models trained using a supervised learning scheme with label data are fitted to the specific tasks they were trained for, LLM can handle a wide range of tasks that the model was never specifically trained for, including ill-defined tasks. It is common to provide LLM with instructions in natural language, sometimes referred to as prompts. For example, to cause a LLM to count the number of people that objected to a proposed plan in a meeting, one might use the following prompt, ‘Please read the meeting minutes. Of all the speakers in the meeting, please identify those who objected to the plan proposed by Mr. Smith at the beginning of the meeting. Please list their names, and count them.’ Further, after receiving a response from the LLM, it is common to refine the task or to provide subsequent tasks in natural language. For example, ‘Also count for each of these speakers the number of words said’, ‘Of these speakers, could you please identify who is the leader?’ or ‘Please summarize the main objections’. LLM may generate textual outputs in natural language, or in a desired structured format, such as a table or a formal language (such as a programming language, a digital file format, and so forth). In many cases, a LLM may be part of a multimodal large model, allowing the model to analyze both textual inputs as well as other kind of inputs (such as images, videos, audio, sensor data, telemetries, and so forth) and/or to generate both textual outputs as well as other kinds of outputs (such as images, videos, audio, telemetries, and so forth).

Some AI models (such as LLM, generative models, foundation models, transformer based models, etc.) may generate source code from natural language, for example by leveraging training on vast datasets of programming examples and human-written text. These models, may learn statistical patterns that link descriptive language (for example, ‘create a function that sorts a list in ascending order’) with corresponding code structures. During training, the model may process millions of pairs of instructions, comments, and source code files, enabling it to internalize syntax, semantics, and common programming conventions across multiple languages. When a user provides a natural language prompt, the model may convert the prompt into numerical representations, may analyze contextual relationships between words, and/or may predict a sequence of code tokens that satisfy the described intent. In one non-limiting example, the output may be generated iteratively, token by token, with each prediction conditioned on the prior context, allowing the model to generate syntactically consistent and logically coherent code based on learned statistical representations. Advanced implementations may further refine results using techniques such as fine-tuning on domain-specific repositories, reinforcement learning from human feedback, and/or integration with static analysis tools or execution environments to improve correctness, security, and performance. A code token may be a meaningful unit of a programming language (or smaller than that, for example as done in a Byte-Pair Encoding) that an AI model may process or generate when producing source code. In the context of AI-based code generation, tokens may be discrete elements such as keywords (for example, ‘if’, ‘return’, ‘class’), identifiers (variable and function names), operators (‘+’, ‘==’, ‘=’), literals (42, ‘text’), punctuation (‘{’, ‘}’, ‘(‘, ’)’), or in other examples, sub-word fragments depending on the tokenizer design, entire lines, full statements, and so forth. Before generation, the natural language prompt and any existing code context may be converted into a sequence of numerical representations corresponding to these tokens. During inference, the model may predict the next most probable token based on the preceding sequence and/or the prompt, repeating this process iteratively until a complete and coherent block of code is formed. By operating at the token level, the model may statistically learn to produce syntactically valid structures, respect programming grammar rules, and construct logically consistent expressions and control flows. In some examples, a natural language prompt may be provided together with a preliminary version of a source code to generate a modified version of that source code. In this example, the prompt may describe the intended changes, improvements, or additional functionality, such as refactoring for efficiency, adding error handling, adapting the code to a different interface, or extending features—while the preliminary source code serves as contextual input. Both the prompt and the preliminary source code may be processed by the model, enabling the model to interpret the prompt's intent in light of the original structure, logic, and syntax. The model may then generate a modified version of the source code by predicting a sequence of code tokens that reflect the requested modifications while preserving relevant portions of the original implementation. This approach supports iterative development workflows, automated refactoring, code optimization, feature expansion, bug solving, and adaptation to evolving technical requirements. In some examples, the generated source code may comprise a test procedure configured to evaluate the functionality, correctness, or performance of another source code. In this example, a natural language prompt may specify testing objectives, such as validating specific functions, covering defined input ranges, simulating edge cases, or verifying compliance with expected outputs, while the other source code is provided as contextual input. The model may process both the prompt including the testing instructions and the other source code to identify relevant interfaces, parameters, and execution paths. Based on this analysis, the model may generate a test procedure that invokes the other code under defined conditions, supplies structured test inputs, and evaluates actual results against expected outcomes. The generated test code may include setup and teardown routines, assertions, mock objects, and reporting mechanisms, thereby facilitating automated verification, regression testing, and quality assurance within a software development workflow.

In some examples, AI coding may broadly refer to the use of one or more artificial intelligence models to generate, modify, analyze, or manage source code or other software artifacts based on one or more inputs, including natural language inputs. AI coding may be implemented in a variety of forms, including but not limited to interactive assistance tools, automated or semi-automated agents, conversational interfaces, integrated development environments, command-line or terminal-based systems, and systems for generating complete or partial software applications. Such systems may operate with varying degrees of autonomy, may incorporate iterative or multi-step workflows, and may be configured for general-purpose or domain specific use. Further, AI coding systems may be deployed in local or distributed environments and may incorporate constraints relating to security, privacy, or organizational policies.

In some examples, modification of a preliminary source code may be performed using a structure-aware transformation process rather than unconstrained regeneration of the entire source file. The preliminary source code may first be parsed into a structured intermediate representation, such as an abstract syntax tree (AST), control flow graph (CFG), dependency graph, symbol table, or other programmatic representation that captures syntactic and semantic relationships between code elements. The natural language prompt describing the intended modification may be analyzed to identify one or more target regions within the structured representation. In some examples, a change-boundary detection module may identify spans of the preliminary source code that are relevant to the requested modification while designating unaffected regions as locked segments. Locked segments may be preserved during generation to prevent unintended alteration of stable functionality. The system may then construct a constrained generation context comprising: (i) the identified modifiable region, (ii) structural metadata from the intermediate representation, and (iii) preservation constraints corresponding to the locked segments. During inference, the model may generate modified code tokens only for the designated modifiable region while conditioning on the preserved context. In some examples, decoding may be constrained by syntactic or semantic rules derived from the structured representation. For example, token candidates may be filtered to ensure compatibility with type constraints, scope rules, function signatures, interface contracts, or language grammar. In certain implementations, the generation process may operate at the granularity of AST subtrees, such that entire subtrees are replaced, inserted, or removed in accordance with the requested modification, thereby preserving structural validity of the overall program. After generation of a modified region, the system may re-integrate the generated code into the original structured representation and perform one or more validation procedures. Validation may include compilation, static analysis, type checking, linting, security scanning, dependency resolution, and/or execution within a sandboxed runtime environment. If an error, warning, or policy violation is detected, diagnostic information (such as compiler error messages, stack traces, or static analysis reports) may be programmatically transformed into an augmented prompt and supplied back to the model to regenerate only the affected region. This iterative correction loop may continue until one or more predefined correctness criteria are satisfied. In some examples, a structural diff engine may compute a semantic difference between the preliminary source code and the modified source code at the level of syntax trees or program graphs rather than textual comparison alone. This semantic diff may be used to verify that only intended functional regions were modified and to prevent regression in unrelated components. By isolating modifiable regions, enforcing structural constraints during decoding, and validating modifications through automated analysis, the system may generate targeted source code transformations that preserve functional integrity of unaffected components while implementing the requested changes. This approach may improve reliability, reduce unintended side effects, and enhance automated refactoring and feature extension workflows in comparison to unconstrained end-to-end code regeneration.

Some non-limiting examples of image data may include one or more images, grayscale images, color images, series of images, 2D images, 3D images, videos, 2D videos, 3D videos, frames, footages, or data derived from other image data. In some embodiments, analyzing image data (for example by the methods, steps and modules described herein) may comprise analyzing the image data to obtain a preprocessed image data, and subsequently analyzing the image data and/or the preprocessed image data to obtain the desired outcome. One of ordinary skill in the art will recognize that the followings are examples, and that the image data may be preprocessed using other kinds of preprocessing methods. In some examples, the image data may be preprocessed by transforming the image data using a transformation function to obtain a transformed image data, and the preprocessed image data may comprise the transformed image data. For example, the transformed image data may comprise one or more convolutions of the image data. For example, the transformation function may comprise one or more image filters, such as low-pass filters, high-pass filters, band-pass filters, all-pass filters, and so forth. In some examples, the transformation function may comprise a nonlinear function. In some examples, the image data may be preprocessed by smoothing at least parts of the image data, for example using Gaussian convolution, using a median filter, and so forth. In some examples, the image data may be preprocessed to obtain a different representation of the image data. For example, the preprocessed image data may comprise: a representation of at least part of the image data in a frequency domain; a Discrete Fourier Transform of at least part of the image data; a Discrete Wavelet Transform of at least part of the image data; a time/frequency representation of at least part of the image data; a representation of at least part of the image data in a lower dimension; a lossy representation of at least part of the image data; a lossless representation of at least part of the image data; a time ordered series of any of the above; any combination of the above; and so forth. In some examples, the image data may be preprocessed to extract edges, and the preprocessed image data may comprise information based on and/or related to the extracted edges. In some examples, the image data may be preprocessed to extract image features from the image data. Some non-limiting examples of such image features may comprise information based on and/or related to: edges; corners; blobs; ridges; Scale Invariant Feature Transform (SIFT) features; temporal features; and so forth. In some examples, analyzing the image data may include calculating at least one convolution of at least a portion of the image data, and using the calculated at least one convolution to calculate at least one resulting value and/or to make determinations, identifications, recognitions, classifications, and so forth.

In some embodiments, analyzing image data (for example by the methods, steps and modules described herein) may comprise analyzing the image data and/or the preprocessed image data using one or more rules, functions, procedures, artificial neural networks, object detection algorithms, face detection algorithms, visual event detection algorithms, action detection algorithms, motion detection algorithms, background subtraction algorithms, inference models, and so forth. Some non-limiting examples of such inference models may include: an inference model preprogrammed manually; a classification model; a regression model; a result of training algorithms, such as machine learning algorithms and/or deep learning algorithms, on training examples, where the training examples may include examples of data instances, and in some cases, a data instance may be labeled with a corresponding desired label and/or result; and so forth. In some embodiments, analyzing image data (for example by the methods, steps and modules described herein) may comprise analyzing pixels, voxels, point cloud, range data, etc. included in the image data.

A convolution may include a convolution of any dimension. A one-dimensional convolution is a function that transforms an original sequence of numbers to a transformed sequence of numbers. The one-dimensional convolution may be defined by a sequence of scalars. Each particular value in the transformed sequence of numbers may be determined by calculating a linear combination of values in a subsequence of the original sequence of numbers corresponding to the particular value. A result value of a calculated convolution may include any value in the transformed sequence of numbers. Likewise, an n-dimensional convolution is a function that transforms an original n-dimensional array to a transformed array. The n-dimensional convolution may be defined by an n-dimensional array of scalars (known as the kernel of the n-dimensional convolution). Each particular value in the transformed array may be determined by calculating a linear combination of values in an n-dimensional region of the original array corresponding to the particular value. A result value of a calculated convolution may include any value in the transformed array. In some examples, an image may comprise one or more components (such as color components, depth component, etc.), and each component may include a two dimensional array of pixel values. In one example, calculating a convolution of an image may include calculating a two dimensional convolution on one or more components of the image. In another example, calculating a convolution of an image may include stacking arrays from different components to create a three dimensional array, and calculating a three dimensional convolution on the resulting three dimensional array. In some examples, a video may comprise one or more components (such as color components, depth component, etc.), and each component may include a three dimensional array of pixel values (with two spatial axes and one temporal axis). In one example, calculating a convolution of a video may include calculating a three dimensional convolution on one or more components of the video. In another example, calculating a convolution of a video may include stacking arrays from different components to create a four dimensional array, and calculating a four dimensional convolution on the resulting four dimensional array. In some examples, audio data may comprise one or more channels, and each channel may include a stream or a one-dimensional array of values. In one example, calculating a convolution of audio data may include calculating a one dimensional convolution on one or more channels of the audio data. In another example, calculating a convolution of audio data may include stacking arrays from different channels to create a two dimensional array, and calculating a two dimensional convolution on the resulting two dimensional array.

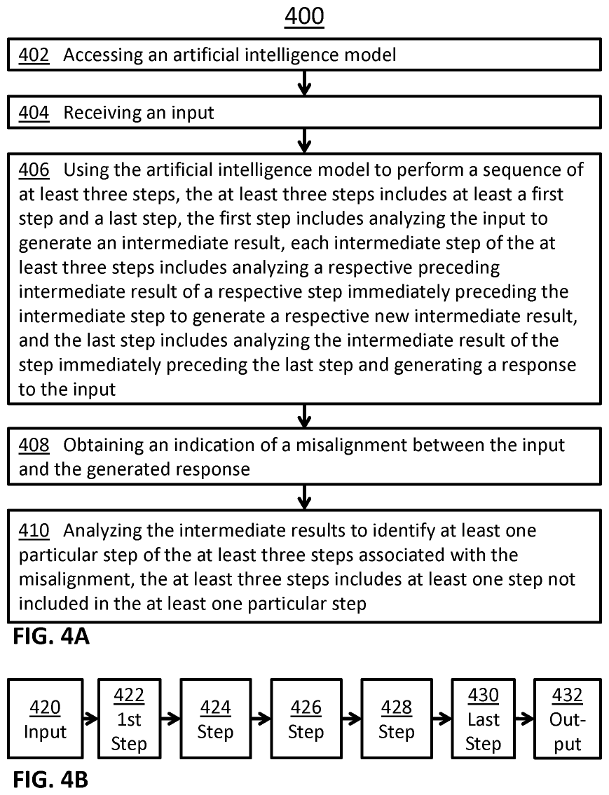

FIG. 4A is a flowchart of an example process 400 for handling misalignments in artificial intelligence processes that includes task decomposition, consistent with some embodiments of the present disclosure. In this example, process 400 may comprise: accessing an artificial intelligence model (step 402); receiving an input (step 404); using the artificial intelligence model to perform a sequence of at least three steps (step 406), the at least three steps includes at least a first step and a last step, the first step includes analyzing the input to generate an intermediate result, each intermediate step of the at least three steps includes analyzing a respective preceding intermediate result of a respective step immediately preceding the intermediate step to generate a respective new intermediate result, and the last step includes analyzing the intermediate result of the step immediately preceding the last step and generating a response to the input; obtaining an indication of a misalignment between the input and the generated response (step 408); and analyzing the intermediate results to identify at least one particular step of the at least three steps associated with the misalignment, the at least three steps includes at least one step not included in the at least one particular step (step 410). In other examples, process 400 may include additional steps or fewer steps. In other examples, one or more steps of process 400 may be executed in a different order and/or one or more groups of steps may be executed simultaneously.

In some examples, a system for handling misalignments in artificial intelligence processes that include task decomposition may include at least one processing unit configured to perform operations, and the operations may include the steps of process 400. In some examples, a method for handling misalignments in artificial intelligence processes that include task decomposition may include performing process 400. In some examples, a non-transitory computer readable medium may store computer implementable instructions that when executed by at least one processor may cause the at least one processor to perform operations for handling misalignments in artificial intelligence processes that include task decomposition, and the operations may include the steps of process 400.

In some examples, a misalignment between an input and a generated response (such as the misalignment of process 400, step 408 and/or step 410, a different misalignment, etc.) may correspond to a measurable difference between an intended characteristic for the response indicated by the input (for example, an intent classification, requested factual content, requested action, policy-constrained behavior, or other inferred or explicit response requirement) and an observed characteristic of the generated response. The misalignment may be quantified using one or more metrics, such as a semantic similarity score, contradiction score, factual consistency score, policy compliance score, intent matching score, or other evaluation metric. For example, step 408 may determine that a misalignment exists when a similarity score between a representation of the input and a representation of the generated response is below a threshold, when a contradiction classifier outputs a value exceeding a threshold, when a policy compliance evaluation indicates a violation, or when an intent classification of the generated response differs from an intent classification of the input. In some examples, the misalignment may be represented as a binary value, a categorical value indicating a type of misalignment, a continuous score indicating a degree of misalignment, or a multi-dimensional vector representing multiple misalignment characteristics. The thresholds, metrics, and representations described herein may be predetermined, dynamically determined, learned from training data, or otherwise configured. In some examples, a misalignment may be associated with one or more specific aspects of the generated response, such as factual statements, safety attributes, formatting characteristics, tone characteristics, specific sections of the generated response, tokens, spans, actions, or other response components.

In some examples, step 402 may comprise accessing an artificial intelligence model. For example, step 402 may read at least part of the artificial intelligence model from memory (for example, from a digital memory, from memory unit 210, etc.), may access at least part of the artificial intelligence model via an external computing device (for example, using a digital communication device), may access at least part of the artificial intelligence model in a database, may generate at least part of the artificial intelligence model (for example, by training a machine learning model using training examples, by fine-tuning or otherwise modifying another artificial intelligence model, etc.), and so forth. Some non-limiting examples of such an artificial intelligence model may include a generative model, a foundation model, a multi-modal artificial intelligence model, an artificial intelligence conversational model, a deep learning model, an artificial neural network, a trained machine learning model, a physical artificial intelligence model, a world foundation model, and so forth. In one example, the artificial intelligence model may include at least one of parameters, weights, structure or architecture, execution instructions, sub-models, mathematical functions, thresholds, rules, or artificial neurons.

In some examples, step 404 may comprise receiving an input. In one example, the input received by step 404 may be an input in a natural language. For example, the input received by step 404 may be a textual input in the natural language, may be an audible speech input in the natural language, and so forth. In another example, the input received by step 404 may be an input in a formal language. In one example, the input received by step 404 may be a textual input. In one example, the input received by step 404 may be an audible input. For example, the input received by step 404 may be an audible verbal input in a natural language. In another example, the input received by step 404 may be an audible non-verbal input. In yet another example, the input received by step 404 may be a mix of audible verbal input in a natural language and audible non-verbal sounds. In one example, the input received by step 404 may be a visual input, such as image data input, image data captured from an environment (such as a physical environment, extended reality environment, and so forth), synthetic image data, image data generated based on data, visual content created by an individual (for example, via a user interface), and so forth. For example, the input received by step 404 may include visual input (such as image data) indicative of at least one gestures. In another example, the input received by step 404 may include visual input (such as image data) indicative of one or more objects in an environment. In yet another example, the input received by step 404 may include a sketch. In one example, the input received by step 404 may be indicative of a physical environment, such as image data captured from the physical environment, layout of the physical environment, indication of physical objects in the physical environment or characteristics thereof, and so forth. In one example, the input received by step 404 may include or be indicative of a gesture. For example, the input may include at least one of image data depicting the gesture, depth data indicative of the gesture, or pose data (for example, from a glove or body suit that includes positioning sensors) indicative of the gesture. In one example, the input received by step 404 may include at least part of inputs 100. For example, the input received by step 404 may include at least one of natural language data 102, sketch data 104, content data 106, base design 108 or portion selection 110. In one example, the input received by step 404 may include at least one of (or an indication of at least one of) designer persona 142, target audience 144, subject matter 146, or style 148. In other examples, the inputs received by step 404 may include any other types of information. In one example, step 404 may read the input from memory (for example, from a digital memory, from memory unit 210, etc.), may receive the input from an external computing device (for example, using a digital communication device, such as communication module 230), may capture the input (for example, using speech recognition, using a microphone, using an audio sensor, using an image sensor, etc.), may receive the input from an individual (for example, using a user interface, using a keyboard, using speech recognition, using a microphone, using an audio sensor, using an image sensor, etc.), may decode the input (for example, from a digital signal, digital data or another machine readable form), and so forth. In some examples, step 404 may receive the input at a single time or over a plurality of times. For example, the input may be received as a single input instance, as a sequence of input instances, or as a continuous input stream. In some examples, step 404 may receive multiple inputs substantially simultaneously or sequentially. In some examples, step 404 may be performed once or may be repeated one or more times during execution of the process, such as in response to updated, additional, or modified input.

In some examples, step 406 may comprise using an artificial intelligence model (such as the artificial intelligence model received by step 402, a different artificial intelligence model, etc.) to perform a sequence of at least three steps. For example, the artificial intelligence model may perform the entire sequence of at least three steps. In another example, different components of the artificial intelligence model may perform different steps of the sequence of at least three steps. In one example, the at least three steps may include at least a first step and a last step. In one example, the at least three steps may be exactly three steps, may be at least four steps, may be at least ten steps, and so forth. Further, the first step may include analyzing an input (such as the input received by step 404, inputs 100 or any part thereof, a different input, etc.) to determine and/or generate an intermediate result. Further, each intermediate step of the at least three steps may include analyzing a respective preceding intermediate result of a respective step immediately preceding the intermediate step (and/or respective preceding intermediate results of other respective steps preceding the intermediate step) to determine and/or generate a respective new intermediate result. The last step may include analyzing the intermediate result of the step immediately preceding the last step (and/or respective preceding intermediate results of other respective steps preceding the last step) and generating (and/or determining) a response to the input. Such a sequence of steps may be defined, generated, or executed using any combination of cascaded processing stages, hierarchical or graph-based planning structures, rule-based or symbolic reasoning, learned policies or options, large language model-based reasoning or agent processes, multi-model pipelines, multi-agent architectures, or other arrangements in which intermediate results are progressively produced, refined, selected, or validated. FIG. 4B is a flowchart of a non-limiting example process resulting from task decomposition, consistent with some embodiments of the present disclosure. In the example of FIG. 4B, the task of determining and/or generating output 432 from input 420 is decomposed to a first step 422, intermediate steps 424, 426 and 428, and last step 430, where first step 422 analyzes input 420 to determine and/or generate a first intermediate result, intermediate step 424 analyzes the first intermediate result to determine and/or generate a second intermediate result, intermediate step 426 analyzes the second intermediate result to determine and/or generate a third intermediate result, intermediate step 428 analyzes the third intermediate result to determine and/or generate a fourth intermediate result, and last step 430 analyzes the fourth intermediate result to determine and/or generate output 432. In one example, step 406 may execute the artificial intelligence model to analyze a document-based input and generate a response. In this example, the artificial intelligence model may analyze the input to identify one or more candidate portions of the document relevant to a task and may generate a first intermediate result identifying the candidate portions. The artificial intelligence model may then analyze the first intermediate result to extract structured information from the candidate portions and may generate a second intermediate result comprising extracted entities, relationships, or attributes. The artificial intelligence model may further analyze the second intermediate result to apply one or more reasoning, ranking, or consistency evaluation operations and generates a third intermediate result. The artificial intelligence model may analyze the third intermediate result to generate the response to the input. In another example, step 406 may execute the artificial intelligence model to perform a planning or problem-solving task in response to the input. In this example, the artificial intelligence model may analyze the input to generate a first intermediate result representing an initial state, goal representation, or candidate solution. The artificial intelligence model may iteratively analyze each intermediate result to generate a subsequent intermediate result, for example by applying one or more learned policies, search operations, or heuristic evaluation functions to refine the candidate solution. The artificial intelligence model may analyze a final intermediate result to generate the response to the input, where the response may correspond to a selected plan, decision, or solution.

In some examples, a generated response to an input (such as a response to the input received by step 404, a response to a different input, the response generated by step 406, the response generated by the last step of step 406, a response generated by a generative model, a different response, etc.) may be a response in a natural language (such as an audible speech response in the natural language, a textual response in the natural language, etc.), may include a textual response (such as a textual response in a natural language, a textual response in a formal language, a textual response including a mix of text in a natural language and text in a formal language, etc.), may include an audible response (such as an audible speech response in a natural language, an audible non-verbal response, mix of audible speech response in a natural language and audible non-verbal sounds, etc.), may include a visual content, may include a selected movement of at least part of a virtual object (such as an avatar, a virtual object in an extended reality environment, etc.), may include a gesture performed by a depiction of a virtual body (such as an avatar), may include a selected movement of at least part of a physical body, may include a gesture performed by a physical body, and so forth. Some non-limiting examples of a physical body may include a physical body of a robot, of a humanoid robot, of a non-humanoid robot, of an autonomous car, of a physical device, of a toy, and so forth.

In some examples, the sequence of at least three steps of step 406 may be a preset sequence of at least three steps. In some other examples, step 406 may further comprise analyzing the input to determine the sequence of at least three steps. For example, step 406 may determine the sequence using task decomposition techniques in which inputs, requests or tasks are broken down into a plurality of smaller, logically related subtasks, each subtask corresponding to an intermediate operation required to generate a final response. In another example, step 406 may determine the sequence using chain-of-thought techniques, determining a plurality of intermediate reasoning operations that define an ordered sequence of steps. In one example, step 406 may identify dependencies, ordering constraints, or execution priorities among the subtasks or steps, and may iteratively or concurrently process the subtasks or steps using one or more models, rules, or processing components. For example, step 406 may use an artificial intelligence model (such as the artificial intelligence model accessed by step 402, a different artificial intelligence model, etc.) to analyze the input and determine the sequence of at least three steps. In another example, step 406 may use a machine learning model to analyze the input and determine the sequence of at least three steps. The machine learning model may be a machine learning model trained using training examples to determine a sequence of subtasks from inputs. An example of such training example may include a sample input, together with a sample sequence of subtasks corresponding to the sample input. In yet another example, step 406 may use an artificial neural network to analyze the input and determine the sequence of at least three steps. In some examples, step 406 may use a preset sequence when the input matches a predefined task category; and otherwise, step 406 may determine the sequence dynamically based on analysis of the input. In some examples, the artificial intelligence model accessed by step 402 may be an artificial intelligence conversational model, and the sequence of at least three steps of step 406 may be associated with chain-of-thought reasoning. In some examples, the artificial intelligence model accessed by step 402 may be a physical artificial intelligence model, and the sequence of at least three steps of step 406 may be associated with task decomposition.

In some examples, step 408 may comprise obtaining an indication of a misalignment between an input (such as the input received by step 404, inputs 100 or any part thereof, a different input, and so forth) and a generated response (such as a response to the input, the response generated by step 406, the response generated by the last step of step 406, a response generated by a generative model, a different response, and so forth). In some examples, step 408 may receive the indication of the misalignment from an individual (for example, via a user interface, via an input device, via voice command, via a gesture, and so forth). In some examples, step 408 may analyze the input and the generated response to obtain (and/or determine) the indication of the misalignment. For example, step 408 may use an artificial intelligence model (such as the artificial intelligence model accessed by step 402, a different artificial intelligence model, etc.) to analyze the input and the generated response to obtain (and/or determine) the indication of the misalignment. In another example, step 408 may use a machine learning model to analyze the input and the generated response to obtain (and/or determine) the indication of the misalignment. The machine learning model may be a machine learning model trained using training examples to determine misalignments from inputs and responses. An example of such training example may include a sample input and a sample response, together with a label indicative of whether the sample input and the sample response are misaligned. In yet another example, step 408 may use an artificial neural network to analyze the input and the generated response to obtain (and/or determine) the indication of the misalignment. In an additional example, step 408 may include: identifying a first mathematical object in a particular mathematical space, wherein the first mathematical object corresponds to at least one phrase included in the input (for example using module 302); identifying a second mathematical object in the particular mathematical space based on at least part of the generated response (for example using module 302); calculating a function of the first and second mathematical objects to obtain a particular mathematical object in the particular mathematical space (for example using module 304); and identifying the misalignment based on the particular mathematical object. For example, when the particular mathematical object is in a first region of the particular mathematical space, step 408 may determine that a misalignment between the input and the generated response exists, and/or when the particular mathematical object is in a second region of the particular mathematical space, step 408 may determine that no misalignment between the input and the generated response exists. In another example, step 408 may calculate a function of the particular mathematical object (for example, the function may have a binary codomain, may have a different codomain, etc.), wherein when the result is a first element of the codomain of the function, step 408 may determine that a misalignment between the input and the generated response exists, and/or when the result is a second element of the codomain of the function, step 408 may determine that no misalignment between the input and the generated response exists.

In some examples, step 410 may comprise analyzing the intermediate results of step 406 to identify at least one particular step of the at least three steps of step 406 associated with the misalignment of step 408. In one example, the at least three steps may include at least one step not included in the at least one particular step identified by step 410. In another example, the at least one particular step identified by step 410 may include all steps of the at least three steps. In yet another example, the at least one particular step identified by step 410 may be exactly one particular step of the at least three steps. In an additional example, the at least one particular step identified by step 410 may be exactly two particular steps of the at least three steps (for example, the at least one particular step identified by step 410 may be exactly two particular steps adjacent to one another in the sequence of step 406, or in another example, at least one specific step may come between the exactly two particular steps in the sequence of step 406). In another example, the at least one particular step identified by step 410 may be at least two particular steps of the at least three steps. In an additional example, the at least three steps of step 406 may include at least four steps, and the at least one particular step identified by step 410 may be at least three particular steps of the at least four steps. In some examples, the analyzing the intermediate results to identify the at least one particular step (by step 410) may include using an artificial intelligence model (such as the artificial intelligence model accessed by step 402, a different artificial intelligence model, etc.) to analyze the intermediate results to identify the at least one particular step of the at least three steps associated with the misalignment. In some examples, the analyzing the intermediate results to identify the at least one particular step (by step 410) may include using a machine learning model to analyze the intermediate results and/or additional information to identify the at least one particular step of the at least three steps associated with the misalignment. The machine learning model may be a machine learning model trained using training examples to identify steps associated with misalignments based on intermediate results produced by different steps and/or additional information. An example of such training example may include sample intermediate results produced by sample steps and/or sample additional information, together with a label indicative of a subset of the sample steps associated with misalignment. In some examples, the analyzing the intermediate results to identify the at least one particular step (by step 410) may include using an artificial neural network to analyze the intermediate results and/or additional information to identify the at least one particular step of the at least three steps associated with the misalignment. In some examples, the analyzing the intermediate results to identify the at least one particular step (by step 410) may include: for each intermediate result of the generated intermediate results, identifying a respective mathematical object in a particular mathematical space based on the intermediate result, for example using module 302; calculating a function of the identified mathematical objects to obtain a particular mathematical object in the particular mathematical space, for example using module 304; and determining whether to include a specific step of the at least three steps in the at least one particular step based on the particular mathematical object and the mathematical object associated with the intermediate result generated by the specific step. For example, step 410 may calculate a function of the particular mathematical object and the mathematical object associated with the intermediate result generated by the specific step to obtain a specific mathematical object in the particular mathematical space, for example using module 304, and may determine whether to include the specific step in the at least one particular step based on the specific mathematical object. In some examples, the analyzing the intermediate results to identify the at least one particular step (by step 410) may include analyzing the intermediate results, the input received by step 404 and/or the response generated by step 406 to identify the at least one particular step of the at least three steps associated with the misalignment. For example, step 410 may use the input and/or the generated response as the additional information when using the trained machine learning model or the artificial neural network to identify the at least one particular step as described above.

In some examples, process 400 may further comprise providing an indication of an identified at least one particular step associated with a misalignment (such as the at least one particular step identified by step 410, at least one particular step associated with the misalignment of step 408, at least one particular step associated with a different misalignment, and so forth). The provided indication may include audible indication, visual indication, textual indication, graphical indication, digital indication, an indication in a data-structure, an indication in a database, an indication stored in memory (for example, in a digital memory, in memory unit 210, etc.), a transmitted indication (for example, using a digital communication device, such as communication module 230), an encoded indication (for example, in a digital encoding, a digital signal, digital data or in another machine readable form), and so forth. In one example, the indication may be provided to an individual, for example via a user interface. In another example, the indication may be provided to an external computing device, for example, using a digital communication device, such as communication module 230. In yet another example, the indication may be provided to a different process, for example via memory, data-structure, database, communication protocol or function call.

In some examples, the input received by step 404 may be associated with a desire of a specific individual for the artificial intelligence model accessed by step 402 to respond to the input, and process 400 may further comprise presenting the response generated by step 406 to the specific individual, for example as described above. In one example, step 408 may receive the indication of the misalignment from the specific individual. For example, step 408 may receive the indication from the specific individual via a user interface. In another example, step 408 may receive a feedback in a natural language (for example, a textual feedback, an audible speech feedback, etc.) from the specific individual, and may analyze the feedback (for example, using NLP algorithms, using the artificial intelligence model accessed by step 402, using a different artificial intelligence model, using an artificial neural network, etc.) to determine that the feedback indicates a misalignment between the input and the generated response.

In some examples, process 400 may further comprise using the identification of at least one particular step associated with a misalignment (such as the at least one particular step identified by step 410, at least one particular step associated with the misalignment of step 408, at least one particular step associated with a different misalignment, and so forth) to correct the misalignment. For example, process 400 may alter, augment or expand the input received by step 404 to include instructions or to remove instructions to prevent the at least one particular step from causing the misalignment. In another example, process 400 may add or modify additional inputs to the at least one particular step (such as a system prompt, system-level instructions, different parameters, a different seed value, etc.) to prevent the at least one particular step from causing the misalignment. In yet another example, process 400 may replace the identified at least one particular step associated with the misalignment in the sequence of at least three steps of step 406 to obtain a new sequence of at least three steps, and may use the artificial intelligence model to perform the new sequence of at least three steps to generate a new response to the input received by step 404. For example, the replacement may be determined based on the misalignment. In some examples, replacing the identified at least one particular step may comprise selecting a replacement step from a plurality of candidate steps based on the misalignment, generating the replacement step using the artificial intelligence model, or modifying the identified at least one particular step according to one or more rules or heuristics associated with the misalignment, prior to performing the new sequence of at least three steps. In some examples, preventing the at least one particular step from causing the misalignment may comprise re-executing at least a portion of sequence after the alteration, augmentation, expansion, addition, modification, or replacement, and evaluating whether the misalignment is reduced or no longer detected based on one or more alignment criteria, validation rules, or misalignment detection techniques described herein. In some examples, process 400 may further comprise providing an indication of the correction of the misalignment. The indication may comprise generating and outputting a signal, message, log entry, metadata, new response or other data indicating that the misalignment associated with the at least one particular step has been corrected or reduced, and may be provided to a user, a monitoring component, or another process.

In some examples, the input received by step 404 may be an input in a natural language that includes a first at least one word, the response generated by step 406 may include a response in a natural language that includes a second at least one word, and the misalignment between the input and the generated response (of step 408) may be based on the first at least one word and the second at least one word. For example, the first at least one word may indicate a specific object, the input may include a question about the specific object, and the second at least one word may indicate that the generated response failed to correctly answer the question. In this example, the misalignment may be associated with a step for identifying the specific object, may be associated with a step for determining information based on the identified object, may be associated with a step for phrasing the response based on the determined information, and so forth. In another example, the input without the first at least one word may have multiple different meanings, the first at least one word indicates a specific meaning of the different meanings, and the second at least one word may indicate that the generated response reacted to the input as having a meaning different than the specific meaning. In this example, the misalignment may be associated with a step for enriching and/or augmenting the input, may be associated with a step for gathering information based on the enriched and/or augmented input and the understanding of the input, may be associated with a step for phrasing the response based on the gathered information and the enriched and/or augmented input, and so forth. In one example, step 408 may comprise: identifying a first mathematical object in a mathematical space (for example using module 302), the first mathematical object corresponds to the first at least one word; identifying a second mathematical object in the mathematical space (for example using module 302), the second mathematical object corresponds to the second at least one word; calculating a function of the first mathematical object and the second mathematical object to obtain a third mathematical object in the mathematical space, for example using module 304; and determining the misalignment between the input and the generated response based on the third mathematical object. In one example, the first at least one word may be a first adjective, the first adjective may be adjacent to a specific noun in the input, the second at least one word may be a second adjective, and the second adjective may be adjacent to the specific noun in the generated response. For example, the input may include ‘show me a red car available for rent’, and the generated response may include ‘here is a blue car available for rent’. In another example, the input may include ‘I am looking for a quiet restaurant nearby’, and the generated response may include ‘I recommend a lively restaurant nearby’. In one example, the first at least one word may be a first adverb, the first adverb may be adjacent to a specific verb in the input, the second at least one word may be a second adverb, and the second adverb may be adjacent to the specific verb in the generated response. For example, the input may include ‘the system should automatically update the data’, and the generated response may include ‘the system will manually update the data’. In another example, the input may include ‘the person in the video should walk slowly’, and the generated response may include ‘the person in the video now walks quickly’.

In some examples, the input received by step 404 may be an input in a natural language that includes at least one word, the response generated by step 406 may include a visual content, and the misalignment between the input and the generated response may be based on the at least one word and a depiction included in the visual content. For example, the input may be associated with a desire to generate and/or retrieve a visual content with specific characteristics indicated by the at least one word, and the generated response may include a generated visual content that doesn't have at least one of the specific characteristics. In this example, the misalignment may be associated with a step for determining the specific characteristics from the input, may be associated with a step for generating a visual with the specific characteristics, and so forth. In another example, the input may be associated with a question, and the visual content may be associated with answering (or failing to answer) the question. In this example, the misalignment may be associated with a step for understanding the question, may be associated with a step for breaking the question to a series of sub-questions, may be associated with a step for answering a specific sub-question, may be associated with a step for generating the visual based on the answer to the specific sub-question, and so forth. In one example, step 408 may comprise: identifying a first mathematical object in a mathematical space (for example using module 302), the first mathematical object corresponds to the first at least one word; calculating a convolution of at least part of the visual content to obtain a plurality of numerical result values; calculating a function of the first mathematical object and the plurality of numerical result values to obtain a second mathematical object in the mathematical space, for example using module 304; and determining the misalignment between the input and the generated response based on the second mathematical object. In one example, the at least one word may be an adjective, the adjective may be adjacent to a noun in the input, the depiction included in the visual content may be a depiction of an object associated with a specific characteristic, the noun may be associated with the object, and the misalignment between the input and the generated response may be based on a misalignment between the adjective and the specific characteristic. For example, the input may include ‘I want a picture of a red car’, and the generated response may include a picture of a blue car. For example, the input may include ‘show me a picture of my wife smiling’, and the generated response may include a picture of the wife frustrated. In another example, the input may include ‘show me a video of an empty restaurant’, and the generated response may include a video of a vibrant restaurant. In one example, the at least one word may be an adverb, the adverb may be adjacent to a verb in the input, the depiction included in the visual content may be a depiction of an event associated with a specific characteristic, the verb may be associated with the event, and the misalignment between the input and the generated response may be based on a misalignment between the adverb and the specific characteristic. For example, the input may include ‘the person in the video should walk slowly’, and the generated response may include a video of a person walking quickly. In another example, the input may include ‘show me a picture of a cat jumping up’, and the generated response may include a picture of a cat jumping down from a tree.

In some examples, the input received by step 404 may be an input in a natural language that includes at least one word, the response generated by step 406 may include a selected movement of at least part of a physical body, and the misalignment between the input and the generated response may be based on the at least one word and the movement. For example, the input may include a physical task indicated by the at least one word, and the selected movement may be associated with performing (or failing to perform) the physical task. In this example, the misalignment may be associated with a step for determining the physical task, may be associated with a step for determining a series of movements for performing the determined physical task, may be associated with a step for performing a specific movement of the series, and so forth. In another example, the input may include a requirement (indicated by the at least one word) for avoiding a physical action, and the selected movement may be associated with the physical action. In yet another example, the input may include a safety requirement indicated by the at least one word, and the selected movement may be associated with a failure to comply with the safety requirement. In this example, the misalignment may be associated with a step for determining the safety requirement from the input, may be associated with a step for determining a series of movements for performing a physical task while complying with the determined safety requirement, may be associated with a step for performing a specific movement of the series, and so forth. In one example, step 408 may comprise: identifying a first mathematical object in a mathematical space (for example using module 302), the first mathematical object corresponds to the first at least one word; analyzing the selected movement to obtain a plurality of numerical result values (for example, based on determined parameters of movement, such as speed, direction, involved part of the physical body, etc.); calculating a function of the first mathematical object and the plurality of numerical result values to obtain a second mathematical object in the mathematical space, for example using module 304; and determining the misalignment between the input and the generated response based on the second mathematical object. In one example, the at least one word may be an adjective, the adjective may be adjacent to a noun in the input, the movement may be associated with a manipulation of an object, the noun may be associated with the object, and the misalignment between the input and the generated response may be based on a misalignment between the adjective and the manipulation. For example, the input may include ‘bring me the red cup’, and the movement may be associated with bringing a blue cup. In another example, the input may include ‘throw the empty cartridge’ and the movement may be associated with throwing a non-empty cartridge. In one example, the at least one word may be an adverb, the adverb may be adjacent to a verb in the input, the movement may be associated with an action associated with a specific characteristic, the verb may be associated with the action, and the misalignment between the input and the generated response may be based on a misalignment between the adverb and the specific characteristic. For example, the input may include ‘quickly extract the component’, and the movement may be associated with slow extraction of the component. In another example, ‘gently grasp the part’, and the movement may be associated with excessive force applied for grasping the part.

In some examples, the input received by step 404 may include a visual content that includes a depiction associated with a specific characteristic, the response generated by step 406 may include a response in a natural language that includes at least one word, and the misalignment between the input and the generated response may be based on the specific characteristic and the at least one word. In one example, the generated response may include a description (or a wrong description, as indicated by the at least one word) in the natural language of the depiction and the specific characteristic. In this example, the misalignment may be associated with a step for identifying elements in the visual content, may be associated with a step for determining characteristics of the identified elements, may be associated with a step for phrasing the response based on the determined characteristics, and so forth. In another example, the generated response may include a determination, deduction and/or a conclusion (whether right or wrong, as indicated by the at least one word) in the natural language based on the depiction and/or the specific characteristic. For example, the visual content may depict a red car, and the generated response may include ‘this is a picture of Joe's car’, when the Joe's car is blue. In this example, the misalignment may be associated with a step for identifying colors of cars in the visual content, may be associated with a step for obtaining or determining characteristics of cars from non-visual data, may be associated with a step for identifying cars based on their identified characteristics, and so forth. In one example, step 408 may comprise: calculating a convolution of at least part of the visual content to obtain a plurality of numerical result values; identifying a first mathematical object in a mathematical space (for example, using module 302), the first mathematical object corresponds to the at least one word; calculating a function of the first mathematical object and the plurality of numerical result values to obtain a second mathematical object in the mathematical space, for example using module 304; and determining the misalignment between the input and the generated response based on the second mathematical object. In one example, the depiction included in the visual content may be a depiction of an object associated with the specific characteristic, the at least one word may be an adjective, the adjective may be adjacent to a noun in the generated response, and the noun may be associated with the object. For example, the visual content may depict a red car, and the generated response may include ‘this is a picture of a blue car’. In another example, the visual content may depict a person smiling, and the generated response may include ‘a person mourning’. In one example, the depiction included in the visual content may be a depiction of an event associated with the specific characteristic, the at least one word may be an adverb, the adverb may be adjacent to a verb in the generated response, and the verb may be associated with the event. For example, the visual content may depict a cat jumping down from a tree, and the generated response may include ‘a cat jumping up’. In another example, the visual content may depict a person walking slowly, and the generated response may include ‘power walking’.

In some examples, the input received by step 404 may include a first visual content that includes a first depiction associated with a first specific characteristic, the response generated by step 406 may include a second visual content that includes a second depiction associated with a second specific characteristic, and the misalignment between the input and the generated response may be based on the first specific characteristic and the second specific characteristic. For example, the second visual content may be an alteration of the first visual content (for example, based on a preset rule, based on a prompt included in the input, and so forth). In this example, the misalignment may be associated with a step for enriching and/or augmenting the prompt, may be associated with a step for analysis of the first visual content, may be associated with a step for generating the second visual content, and so forth. In another example, the second visual content may include objects and/or characters from the first visual content in different settings (for example, different pose, acting according to a different script, performing a different action, and so forth). In this example, the misalignment may be associated with a step for extracting the objects and/or characters from the first visual content, may be associated with a step for determining the different settings, may be associated with a step for generating the second visual content based on the different settings and the extracted objects and/or characters, and so forth. In one example, step 408 may comprise: calculating a convolution of at least part of the first visual content to obtain a plurality of numerical result values; calculating a convolution of at least part of the second visual content to obtain a second plurality of numerical result values; calculating a function of the first plurality of numerical result values and the second plurality of numerical result values to obtain a third numerical result value, for example using module 304; and determining the misalignment between the input and the generated response based on the third numerical result value. In one example, the first depiction may be a depiction of a first object associated with the first specific characteristic, and the second depiction may be a depiction of a second object associated with the second specific characteristic. For example, the first object may be a first person smiling, the second object may be a second person crying, the sequence of step 406 may be aimed at replacing the first person with the second person without changing the situation, and the misalignment may be due to the smiling replaced by crying. In another example, the first object may be a snowman, the second object may be a grassland, and the sequence of step 406 may be aimed at creating a background appropriate for the first object. In one example, the first depiction may be a depiction of an object associated with the first specific characteristic, the second depiction may be a depiction of an event associated with the second specific characteristic, and the event may be associated with the object. For example, the object may be a phone, the event may be a monkey picking the phone and slamming it against the floor, and the sequence of step 406 may be aimed at presenting a normal use of the object. In another example, the object may be a glass snow globe, the event may be the glass snow globe falling to the ground but not breaking, and the sequence of step 406 may be aimed at generating a simulation of the object falling from a height of five feet. In one example, the first depiction may be a depiction of a first event associated with the first specific characteristic, and the second depiction may be a depiction of a second event associated with the second specific characteristic. For example, the first event may be a glass snow globe falling towards the ground, the second event may be the glass snow globe bouncing back from the ground unharmed, and the sequence of step 406 may be aimed at generating a reasonable continuation of the first visual content.

In some examples, the input received by step 404 may include a visual content that includes a depiction associated with a specific characteristic, the response generated by step 406 may include a selected movement of at least part of a physical body, and the misalignment between the input and the generated response may be based on the specific characteristic and the movement. For example, the movement may be aimed to mimic an action depicted in the visual content. In this example, the misalignment may be associated with a step for identifying the action depicted in the visual content, may be associated with a step for determining characteristics of the depicted action, may be associated with a step for determining a series of movements for mimicking the action, may be associated with a step for performing a specific movement of the series, and so forth. In another example, the may be aimed to pick an object depicted in the visual content of a plurality of physical objects. In this example, the misalignment may be associated with a step for identifying the depicted object, may be associated with a step for detecting the identified object in a physical environment, may be associated with a step for picking the detected object, and so forth. In one example, step 408 may comprise: calculating a convolution of at least part of the visual content to obtain a plurality of numerical result values; analyzing the selected movement to obtain a second plurality of numerical result values (for example, based on determined parameters of movement, such as speed, direction, involved part of the physical body, etc.); calculating a function of the first plurality of numerical result values and the second plurality of numerical result values to obtain a third numerical result value, for example using module 304; and determining the misalignment between the input and the generated response based on the third numerical result value. In one example, the depiction may be a depiction of an object associated with the specific characteristic, the selected movement may be associated with an action associated with a physical object associated with a second characteristic, and the misalignment between the input and the generated response may be based on the specific characteristic and the second characteristic. For example, the depiction may be of a screw with a hexagon head, the physical object may be a torx screwdriver, and the sequence of step 406 may be aimed at picking and/or using a tool corresponding to the depicted object. In one example, the depiction may be a depiction of an action associated with the specific characteristic, the selected movement may be associated with a physical action associated with a second characteristic, and the misalignment between the input and the generated response may be based on the specific characteristic and the second characteristic. For example, the depicted action may be associated with low-force, high-speed motion, the physical action may corresponds to a high-force, low-speed motion. In another example, the depicted action may be subtle and/or easy to miss, and the physical action may crude and/or apparent.

In some examples, the input received by step 404 may be indicative of or include a gesture, the response generated by step 406 may include a response in a natural language that includes at least one word, and the misalignment between the input and the generated response may be based on the gesture and the at least one word. For example, the gesture may indicate an object (such as a physical object, a virtual object, etc.), and the generated response may fail to correctly describe or be based on the indicated object. In this example, the misalignment may be associated with a step for identifying the gesture, may be associated with a step for identifying the object indicated by the gesture, may be associated with a step for describing or determining information based on the object, and so forth. In another example, the input may further include an input in a natural language, the gesture may indicate a specific meaning of at least one word included in the input in the natural language of a plurality of alternative possible meanings, and the generated response may react to the at least one word as having a particular meaning different from the specific meaning. In this example, the misalignment may be associated with a step for identifying the gesture, may be associated with a step for associating the gesture with the at least one word, may be associated with a step for assigning meaning to the at least one word based on the gesture, may be associated with a step for reacting to the assigned meaning, and so forth. In one example, step 408 may comprise: determining a plurality of numerical result values based on the gesture; identifying a first mathematical object in a mathematical space (for example, using module 302), the first mathematical object corresponds to the at least one word; calculating a function of the plurality of numerical result values and the first mathematical object values to obtain a second mathematical object in the mathematical space, for example using module 304; and determining the misalignment between the input and the generated response based on the second mathematical object. In some examples, the gesture may be indicative of an object, the at least one word may be a noun, and the misalignment between the input and the generated response may be based on the object and the noun. For example, the gesture may indicate a flat plate, and the generated response may include ‘this is used to serve fluids’. In another example, the gesture may indicate on a doorway to a bathroom, and the generated response may include ‘this leads to the living room’. In one example, the gesture may be indicative of a command, the at least one word may be a verb, and the misalignment between the input and the generated response may be based on the command and the verb. For example, the command may be a delete command, and the generated response may include ‘Archiving the file’. In another example, the command may be a stop command, and the generated response may include ‘walking to the kitchen’.

In some examples, the input received by step 404 may be indicative of or include a gesture, the response generated by step 406 may include a visual content that includes a depiction associated with a specific characteristic, and the misalignment between the input and the generated response may be based on the gesture and the specific characteristic. For example, the gesture may indicate an object (such as a physical object, a virtual object, etc.), and the generated response may fail to visualize an aspect of the object (such as a process associated with object, the object in a different settings, the object in a different configuration, and so forth). In this example, the misalignment may be associated with a step for identifying the gesture, may be associated with a step for identifying the object indicated by the gesture, may be associated with a step for determining the aspect of the object, may be associated with a step for generating or selecting the visualization based on the object and/or the determined aspect, and so forth. In another example, the input may further include an input in a natural language, the gesture may indicate a specific meaning of at least one word included in the input in the natural language of a plurality of alternative possible meanings, and the generated response may include a visualization generated and/or selected based on the at least one word as having a particular meaning different from the specific meaning. In this example, the misalignment may be associated with a step for identifying the gesture, may be associated with a step for associating the gesture with the at least one word, may be associated with a step for assigning meaning to the at least one word based on the gesture, may be associated with a step for generating and/or selecting a visualization based on the assigned meaning, and so forth. In one example, step 408 may comprise: determining a first plurality of numerical result values based on the gesture; calculating a convolution of at least part of the visual content to obtain a second plurality of numerical result values; calculating a function of the first plurality of numerical result values and the second plurality of numerical result values to obtain a third numerical result value, for example using module 304; and determining the misalignment between the input and the generated response based on the third numerical result value. In one example, the gesture may be indicative of a first object with a first specific characteristic, the depiction may be a depiction of a second object associated with a second specific characteristic, and the misalignment between the input and the generated response may be based on the first specific characteristic and the second specific characteristic. For example, the first object and the second object may be the same object, may be different objects of a same type of objects, may be different objects of different types, and so forth. In another example, the sequence of step 406 may be aimed at creating a cartoon depiction of real world events, the first object may be a fast moving car, and the depiction may be of a standing moving car. In yet another example, the sequence of step 406 may be creating depictions of real world situations with different characters while keeping the emotion, the first object may be a smiling woman, and the depiction may include an irritated man. In one example, the gesture may be indicative of a command, the depiction may be a depiction of an event associated with a specific characteristic, and the misalignment between the input and the generated response may be based on the command and the specific characteristic. For example, the command may be a command to rotate a virtual object around a specific axis, the depiction may show the virtual object rotating around a different axis.

In some examples, the input received by step 404 may be indicative of or include a gesture, the response generated by step 406 may include a selected movement of at least part of a physical body, and the misalignment between the input and the generated response may be based on the specific gesture and the movement. For example, the gesture may indicate a physical object, and the selected movement may be associated with a failure to pick the indicated physical object. In this example, the misalignment may be associated with a step for identifying the gesture, may be associated with a step for identifying the object indicated by the gesture, may be associated with a step for determining a series of movements for picking the object, may be associated with a step for performing a specific movement of the series, and so forth. In another example, the input may further include an input in a natural language, the gesture may indicate a specific meaning of at least one word included in the input in the natural language of a plurality of alternative possible meanings, and the selected movement may be associated with reacting to the at least one word as having a particular meaning different from the specific meaning. In this example, the misalignment may be associated with a step for identifying the gesture, may be associated with a step for associating the gesture with the at least one word, may be associated with a step for assigning meaning to the at least one word based on the gesture, may be associated with a step for determining an action reacting to the assigned meaning, may be associated with a step for determining a series of movements for performing the action, may be associated with a step for performing a specific movement of the series, and so forth. In one example, step 408 may comprise: determining a first plurality of numerical result values based on the gesture; analyzing the selected movement to obtain a second plurality of numerical result values (for example, based on determined parameters of movement, such as speed, direction, involved part of the physical body, etc.); calculating a function of the first plurality of numerical result values and the second plurality of numerical result values to obtain a third numerical result value, for example using module 304; and determining the misalignment between the input and the generated response based on the third numerical result value. In one example, the gesture may be indicative of a first object (such as a physical object, a virtual object, etc.) with a first specific characteristic, the selected movement may be associated with an action associated with a physical object associated with a second specific characteristic, and the misalignment between the input and the generated response may be based on the first specific characteristic and the second specific characteristic. For example, the first object and the second object may be the same object, may be different objects of a same type of objects, may be different objects of different types, and so forth. In another example, the first object may be a screw with a hexagon head, the physical object may be a torx screwdriver, and the sequence of step 406 may be aimed at picking and/or using a tool corresponding to the first object. In one example, the gesture may be indicative of a command, the selected movement may be associated with a physical action associated with a specific characteristic, and the misalignment between the input and the generated response is based on the command and the specific characteristic. For example, the gesture may be a beckoning sign to call over a robot, and the physical action of the robot may be associated with moving away from the gesturing person. In another example, the gesture may be a stop hand gesture to cause a process to stop, and the movement may be associated with continuing an activity.

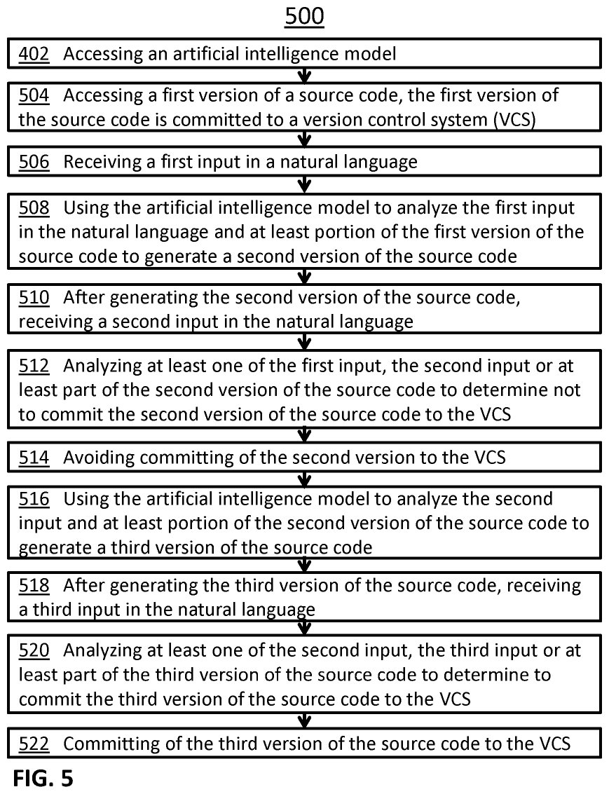

FIG. 5 is a flowchart of an example process 500 for version control in artificial intelligence coding, consistent with some embodiments of the present disclosure. In this example, process 500 may comprise: accessing an artificial intelligence model (step 402); accessing a first version of a source code (step 504), the first version of the source code is committed to a version control system (VCS); receiving a first input in a natural language (step 506); using the artificial intelligence model to analyze the first input in the natural language and at least portion of the first version of the source code to generate a second version of the source code (step 508); after generating the second version of the source code, receiving a second input in the natural language (step 510); analyzing at least one of the first input, the second input or at least part of the second version of the source code to determine not to commit the second version of the source code to the VCS (step 512); avoiding triggering a committing of the second version of the source code to the VCS (step 514); using the artificial intelligence model to analyze the second input in the natural language and at least portion of the second version of the source code to generate a third version of the source code (step 516); after generating the third version of the source code, receiving a third input in the natural language (step 518); analyzing at least one of the second input, the third input or at least part of the third version of the source code to determine to commit the third version of the source code to the VCS (step 520); and triggering a committing of the third version of the source code to the VCS (step 522). In other examples, process 500 may include additional steps or fewer steps. In other examples, one or more steps of process 500 may be executed in a different order and/or one or more groups of steps may be executed simultaneously.

In some examples, a system for version control in artificial intelligence coding may include at least one processing unit configured to perform operations, and the operations may include the steps of process 500. In some examples, a method for version control in artificial intelligence coding may include performing process 500. In some examples, a non-transitory computer readable medium may store computer implementable instructions that when executed by at least one processor may cause the at least one processor to perform operations for version control in artificial intelligence coding, and the operations may include the steps of process 500.

In some examples, step 504 may comprise accessing a first version of a source code. In one example, the first version of the source code may be a version committed to a VCS. In another example, the first version of the source code may be a version not committed to any VCS. For example, step 504 may read at least part of the first version of the source code from a memory (for example, from a digital memory, from memory unit 210, etc.), may access at least part of the first version of the source code via an external computing device (for example, using a digital communication device), may retrieve at least part of the first version of the source code from the VCS, may generate at least part of the first version of the source code (for example, using a generative artificial intelligence model, in response to a prompt, based on a sketch, by altering a different version of the source code, by generating the at least part of the source code from scratch, using the steps and/or processes described herein, using other processes, etc.), may receive at least part of the first version of the source code from an individual (for example, via a user interface, via an IDE, via a what-you-see-is-what-you-get application that creates source code from graphical design, via an input device, via a keyboard, via voice recognition, etc.), and so forth. In one example, a version of a source code may include one or more files of source code, may include source code in one or more programming languages, may include one or more computer implementable instructions, and so forth. In one example, a version of a source code may be associated with one or more configuration parameters, data, one or more values, and so forth.

In some examples, an input in a natural language may be received. For example, the received input may be a textual input in the natural language, may be an audible speech input in the natural language, and so forth. In one example, the input in the natural language may be received as described above in relation to step 404. In one example, step 706 may comprise receiving an input in a natural language. In one example, step 804 may comprise receiving an input in a natural language associated with a desire of an individual to generate source code for a software. In one example, step 1106 may comprise receiving an input in a natural language associated with a desire to modify a version of a codebase (such as the preliminary version of the codebase accessed by step 1104, a different version of the codebase of step 1104, the preliminary version of the codebase accessed by step 1504, a different version of the codebase of step 1504, a version of a different codebase, and so forth). In one example, step 1204 may comprise receiving an input in a natural language associated with a desire to generate a source code. In one example, step 506 may comprise receiving a first input in a natural language. In one example, step 612 may comprise receiving a second input in a natural language (such as the natural language of step 506, a different natural language, and so forth). In one example, step 510 may comprise receiving a second input in a natural language (such as the natural language of step 506, a different natural language, and so forth), for example after the generating the second version of the source code by step 508. In one example, step 518 may comprise receiving a third input in a natural language (such as the natural language of step 506 and/or step 510, a different natural language, etc.), for example after the generating the third version of the source code by step 516. In one example, step 1312 may comprise receiving a second input in a natural language (such as the natural language of step 506, a different natural language, and so forth), for example after receiving the request using step 1310. In one example, the input in the natural language may be read from memory (for example, from a digital memory, from memory unit 210, etc.), may be received from an external computing device (for example, using a digital communication device, such as communication module 230), may be captured (for example, using speech recognition, using a microphone, using an audio sensor, etc.), may be received from an individual (for example, using a user interface, using a keyboard, using speech recognition, using a microphone, using an audio sensor, etc.), may be decoded (for example, from a digital signal, digital data or another machine readable form), and so forth. In some examples, the input in the natural language may be received at a single time or over a plurality of times. For example, the input in the natural language may be received as a single input instance, as a sequence of input instances, or as a continuous input stream. In some examples, the input in the natural language may include multiple inputs in the natural language. In one example, the first input received by step 506 may be a first textual input in the natural language, and/or the second input received by step 510 and/or step 612 may be a second textual input in the natural language, and/or the third input received by step 518 may be a third textual input in the natural language. In another example, the first input received by step 506 may be a first speech input in the natural language, and/or the second input received by step 510 and/or step 612 may be a second speech input in the natural language, and/or the third input received by step 518 may be a third speech input in the natural language. In yet another example, the first input received by step 506 may be a textual input in the natural language, and/or the second input received by step 510 and/or step 612 may be a speech input in the natural language. In an additional example, the first input received by step 506 may be a speech input in the natural language, and/or the second input received by step 510 and/or step 612 may be a textual input in the natural language.

In some examples, an input in a natural language may be received by step 504 and/or step 510 and/or step 518 and/or step 612 and/or step 706 and/or step 804 and/or step 1106 and/or step 1204, for example as described above. The input in the natural language may include at least one of a user story, feature request, or issue ticket. In one example, the input in the natural language may include a user story. For example, the user story may include ‘when I upload a file in the wrong format, the page shows a server error instead of telling me the file type isn't supported’, or ‘when I export a report about a person with no activity records, I get an error message instead of an empty report’. In one example, the input in the natural language may include a feature request. For example, the feature request may include ‘prevent users from entering special characters in usernames’. In one example, the input in the natural language may include an issue ticket. For example, the issue ticket may include ‘all sessions are expired when daylight saving time comes into effect’. In some examples, the input in the natural language may be obtained from at least one of a project management tool, bug tracking system or issue tracking system. In one example, the input in the natural language may be obtained from a project management tool. In one example, the input in the natural language may be obtained from a bug tracking system. In one example, the input in the natural language may be obtained from an issue tracking system. For example, at least one of a user story, feature request, or issue ticket may be received from the project management tool or from the bug tracking system or from issue tracking system.

In some examples, an artificial intelligence model (such as the artificial intelligence model accessed by step 402, a different artificial intelligence model, etc.) may be used to analyze an input in a natural language and/or at least a portion of a preliminary version of the source code and/or additional information to generate a new version of the source code. For example, step 508 may comprise using the artificial intelligence model to analyze the first input in the natural language received by step 506 and at least a portion of the first version of the source code accessed by step 504 to generate a second version of the source code. In another example, step 516 may comprise using the artificial intelligence model to analyze the second input in the natural language received by step 510 and at least a portion of the second version of the source code generated by step 508 to generate a third version of the source code. In one example, the input in the natural language may include instructions and/or guidelines and/or requests to modify the preliminary version of the source code to generate the new version of the source code. In one example, one or more instructions may be added to the preliminary version of the source code to generate the new version of the source code. In another example, one or more segments of the preliminary version of the source code may be removed to generate the new version of the source code. In yet another example, one or more instructions in the preliminary version of the source code may be modified to generate the new version of the source code. In some examples, a first mathematical object in a particular mathematical space may be identified (for example, using module 302), the first mathematical object may correspond to at least one word included in the input. Further, a second mathematical object in the particular mathematical space may be identified based on at least one instruction included in the at least a portion of the preliminary version of the source code, for example using module 302. Further, a function of the first and second mathematical objects may be calculated to obtain a third mathematical object in the particular mathematical space, for example using module 304. In one example, the third mathematical object may correspond to at least one additional instruction, and the at least one additional instruction may be included in the new version of the source code. In another example, a segment of the preliminary version of the source code may be selected based on the third mathematical object, and the selected segment may be removed from the preliminary version of the source code to obtain the new version of the source code.

In some examples, generation of a new version of a source code may be based, at least in part, on a specific input in a natural language and/or on at least a portion of a preliminary version of the source code. At least one of the specific input, a particular input in a natural language received after the generation of the new version, or at least part of the new version of the source code may be analyzed to determine whether to commit the new version of the source code to a VCS (such as the VCS of step 504, a different VCS, and so forth). For example, step 512 may comprise analyzing at least one of the first input received by step 506, the second input received by step 510, or at least part of the second version of the source code generated by step 508 to determine not to commit the second version of the source code to the VCS. In another example, step 520 may comprise analyzing at least one of the second input received by step 510, the third input received by step 518, or at least part of the third version of the source code generated by step 516 to determine to commit the third version of the source code to the VCS. In one example, the analyzing the at least one of the specific input, the particular input, or the at least part of the new version of the source code may include analyzing at least two of the specific input, the particular input, or the at least part of the new version of the source code to determine whether to commit the new version of the source code to the VCS. In one example, the analyzing the at least one of the specific input, the particular input, or the at least part of the new version of the source code may include analyzing the specific input, the particular input, and the at least part of the new version of the source code to determine whether to commit the new version of the source code to the VCS. In one example, the analyzing the at least one of the specific input, the particular input, or the at least part of the new version of the source code may include using an artificial intelligence model (such as the artificial intelligence model accessed by step 402, a different artificial intelligence model, etc.) to analyze the at least one of the specific input, the particular input, or the at least part of the new version of the source code (possibly together with addition information) to determine whether to commit the new version of the source code to the VCS. For example, the artificial intelligence model may be a LLM used with a suitable prompt (such as ‘Given the inputs, should I commit this new version of the code to a VCS?’). In one example, the analyzing the at least one of the specific input, the particular input, or the at least part of the new version of the source code may include using a machine learning model to analyze the at least one of the specific input, the particular input, or the at least part of the new version of the source code to determine whether to commit the new version of the source code to the VCS. The machine learning model may be a machine learning model trained using training examples to determine whether to commit a version of a source code to a VCS based on inputs in natural language and/or at least a portion of the version of the source code and/or additional information. An example of such training example may include sample input(s) in natural language and/or at least a portion of a sample version of a sample source code and/or additional information, together with a label indicative of a desired decision whether to commit the sample version of the sample source code to a VCS. In one example, the analyzing the at least one of the specific input, the particular input, or the at least part of the new version of the source code may include using an artificial neural network to analyze the at least one of the specific input, the particular input, or the at least part of the new version of the source code (possibly together with addition information) to determine whether to commit the new version of the source code to the VCS.

In some examples, step 512 may comprise analyzing the first input received by step 506 to determine not to commit the second version of the source code generated by step 508 to the VCS, and/or step 520 may comprise analyzing the second input received by step 510 to determine to commit the third version of the source code generated by step 516 to the VCS. In some examples, the first input may be indicative of a need for a minor change to the source code, and the second input may be indicative of a need for a major change to the source code. In one example, step 512 may determine not to commit the second version based on the first input being indicative of the need for the minor change, and/or step 520 may determine to commit the third version based on the second input being indicative of the need for the major change. For example, the first input may include ‘let's have a different name for this local variable’, and the second input may include ‘let's change the name of this API function’ for an Application Programming Interface (API) function that is widely used throughout the source code. In another example, the first input may include ‘let's change the logic within this function without changing its external behavior’, and the second input may include ‘let's switch the entire software from synchronous to asynchronous’. In some examples, the first input may be indicative of a need for a first change to the source code that is below a selected threshold, wherein the first and second changes combined together may be above the selected threshold (for example, the second input may be indicative of a need for a second change to the source code that is below the selected threshold, the second input may be indicative of a need for a second change to the source code that is above the selected threshold, and so forth). Step 512 may determine not to commit the second version based on the first change being below the selected threshold, and/or step 520 may determine to commit the third version based on the second change being above the selected threshold or based on the first and second changes combined together being above the selected threshold. In one example, such selected threshold may be based on amount of code changing in the source code, on locality of the change in the source code, on impact of the change on behavior of the software (for example, on external behavior), and so forth.

In some examples, step 512 may comprise analyzing the second input received by step 510 to determine not to commit the second version of the source code generated by step 508 to the VCS, and/or step 520 may comprise analyzing the third input received by step 518 to determine to commit the third version of the source code generated by step 516 to the VCS. In some examples, the second input may be indicative of a dissatisfaction from the second version of the source code, and/or the third input may not be indicative of a dissatisfaction from the third version of the source code. In one example, step 512 may determine not to commit the second version based on the second input being indicative of the dissatisfaction from the second version, and/or step 520 may determine to commit the third version based on the third input not being indicative of a dissatisfaction from the third version. For example, the second input may include ‘this is too much’, and the third input may include ‘this is perfect’. In another example, the second input may include ‘this doesn't fix the bug’, and the third input may include ‘that will work’. In some examples, the second input may be indicative of a desire to at least one of refine or revert at least one change made in the second version of the source code (by step 508), and/or the third input may not be indicative of a desire to at least one of refine or revert at least one change made in the third version of the source code (by step 516). In one example, step 512 may determine not to commit the second version based on the second input being indicative of the desire to at least one of refine or revert at least one change made in the second version, and/or step 520 may determine to commit the third version based on the third input not being indicative of a desire to at least one of refine or revert at least one change made in the third version. For example, the second input may include ‘this is too much’, and the third input may include ‘this is perfect’. In another example, the second input may include ‘I don't like the change to the user interface, let's return to the previous user interface while keeping the backend optimization’, and the third input may include ‘that's exactly what I wanted’.

In some examples, step 512 may comprise analyzing the at least part of the second version of the source code generated by step 508 to determine not to commit the second version of the source code to the VCS, and/or step 520 may comprise analyzing the at least part of the third version of the source code generated by step 516 to determine to commit the third version of the source code to the VCS. In some examples, the second version of the source code may not include a major change to the source code compared to the first version of the source code, and the third version of the source code may include a major change to the source code compared to the first version of the source code (for example, the third version may include a major change to the source code compared to the second version of the source code, the third version may not include a major change to the source code compared to the second version of the source code). Step 512 may determine not to commit the second version based on the second version not including a major change compared to the first version, and/or step 520 may determine to commit the third version based on the third version including a major change to the source code compared to the first version (and/or the second version). In one example, a change may be considered a major change based on amount of code changing in the source code, based on locality of the change in the source code, based on impact of the change on behavior of the software (for example, on external behavior), based on a selected threshold as described below, and so forth. In one example, the second version of the source code may include a first change to the source code compared to the first version of the source code that is below a selected threshold, and the third version of the source code may include a second change to the source code compared to the first version of the source code that is above the selected threshold (for example, the third version of the source code may include a third change to the source code compared to the second version of the source code, and the third change may be above or below the selected threshold). Step 512 may determine not to commit the second version based on the first change being below the selected threshold, and/or step 520 may determine to commit the third version based on the second change being above the selected threshold or based on the third change being above the selected threshold. In one example, such selected threshold may be based on amount of code changing in the source code, on locality of the change in the source code, on impact of the change on behavior of the software (for example, on external behavior), and so forth. In some examples, the second version of the source code may fail on at least one automated test, and the third version of the source code may successfully pass the at least one automated test. Step 512 may determine not to commit the second version based on the second version failing on the at least one automated test, and/or step 520 may determine to commit the third version based on the third version successfully passing the at least one automated test. Some non-limiting examples of such automated tests may include automated unit tests, automated Continuous-Integration and/or Continuous-Deployment tests, automated stability tests, automated speed tests, automated security scans, automated user-interface based tests, automated end-to-end tests, and so forth. In some examples, the second version of the source code may fail to comply with at least one coding standard, and the third version of the source code may comply with the at least one coding standard. Step 512 may determine not to commit the second version based on the second version failing to comply with the at least one coding standard, and/or step 520 may determine to commit the third version based on the third version complying with the at least one coding standard. Some non-limiting examples of such coding standards may include organization internal coding standards, coding standards specific to the source code, naming conventions, formatting and/or structure standards, documentation standards, error handling standards, logging standards, security standards, and so forth.

In some examples, step 512 may comprise analyzing the second input received by step 510 and the at least part of the second version of the source code generated by step 508 to determine not to commit the second version of the source code to the VCS, and/or step 520 may comprise analyzing the third input received by step 518 and the at least part of the third version of the source code generated by step 516 to determine to commit the third version of the source code to the VCS. For example, step 512 may comprise: identifying a first mathematical object in a particular mathematical space, the first mathematical object corresponds to at least one word included in the second input, for example using module 302; identifying a second mathematical object in the particular mathematical space based on at least one instruction included in the at least portion of the second version of the source code, for example using module 302; calculating a function of the first and second mathematical objects to obtain a third mathematical object in the particular mathematical space, for example using module 304; and basing the determination not to commit the second version of the source code to the version control system on the third mathematical object. In another example, step 520 may comprise: identifying a first mathematical object in a particular mathematical space, the first mathematical object corresponds to at least one word included in the third input, for example using module 302; identifying a second mathematical object in the particular mathematical space based on at least one instruction included in the at least portion of the third version of the source code, for example using module 302; calculating a function of the first and second mathematical objects to obtain a third mathematical object in the particular mathematical space, for example using module 304; and basing the determination to commit the third version of the source code to the version control system on the third mathematical object.

In some examples, step 522 may comprise triggering a committing of a version of a source code (such as the third version of the source code generated by step 516, a different version of a source code, etc.) to a VCS (such as the VCS of step 504, a different VCS, and so forth). For example, step 522 may trigger a committing of the third version of the source code to the VCS in response to the determination to commit the third version of the source code by step 520. For example, step 522 may perform the committing of the version of the source code to the VCS, for example using at least one of software tools, software libraries, API of the VCS, or a communication protocol of the VCS. In another example, step 522 may store information in memory (for example, in a digital memory, in memory unit 210, in a location in the memory shared with another application, etc.), and the information may be configured to trigger the committing of the version of the source code to the VCS (for example, the information may include instructions for causing another process to commit the version of the source code to the VCS, may flag the version for committing, and so forth). In yet another example, step 522 may transmit information to an external computing device (for example, via a digital communication device) to cause the external computing device to commit the version of the source code to the VCS. In some examples, step 514 may comprise avoiding triggering a committing of a version of a source code (such as the second version of the source code generated by step 508, a different version of a source code, etc.) to a VCS (such as the VCS of step 504, a different VCS, to any VCS, and so forth). For example, step 514 may avoid triggering a committing of the second version of the source code to the VCS in response to the determination not to commit the second version of the source code by step 512. For example, step 514 may avoid performing one or more actions associated with the committing of the version of the source code to the VCS (for example, avoiding one or more of the actions described in relation to step 522).

In some examples, the committing the third version of the source code to the VCS performed or triggered by step 522 may include analyzing the third version of the source code generated by step 516 to remove particular information and thereby obtain a modified third version of the source code, and committing the modified third version of the source code to the VCS. In one example, removing the particular information may include replacing the particular information with different information, replacing the particular information with a placeholder, removing the particular information altogether, and so forth. In one example, the particular information may include at least one of an API key, password, token, credential, or private key. In another example, the particular information may include environment specific information. Some non-limiting examples of such environment specific information may include file system paths, addresses (such as Uniform Resource Locator (URL) addresses, Internet Protocol addresses, database address, API endpoint, server address, etc.), and so forth. In yet another example, the particular information may include run-time or compile-time parameters. Some non-limiting examples of such parameters may include logging level, feature flags, and so forth. In some examples, after the committing the modified third version of the source code to the VCS, process 500 may further comprise obtaining the modified third version of the source code from the VCS; and inserting the particular information to the obtained modified third version of the source code. For example, when removing the particular information, the particular information may be stored in a data-structure that enables to reinsert it to at the same locations at the source code (for example, a data-structure that associates different pieces of information with different locations at the source code), and when the modified third version is obtained from the VCS, the data-structure may be accessed.

In some examples, step 522 may further comprise generating a summary in the natural language of changes between the first version of the source code generated by step 508 and the third version of the source code generated by step 516, and storing the generated summary in the VCS. For example, the generated summary may be in a natural language, may be textual, may be audible, may be visual, may be graphical, and so forth. In one example, step 522 may analyze the first and third versions of the source code to generate the summary, and the generated summary may be based on the analysis of the first and third versions of the source code. For example, step 522 may use an artificial intelligence model (such as the artificial intelligence model accessed by step 402, a different artificial intelligence model, etc.) to analyze the first and third versions of the source code to generate the summary. In another example, step 522 may use an artificial neural network to analyze the first and third versions of the source code to generate the summary. In yet another example, step 522 may use a machine learning model to analyze the first and third versions of the source code to generate the summary. The machine learning model may be a machine learning model trained using training examples to generate summary of changes between two versions of code. An example of such training example may include two sample versions of a sample source code, together with a sample summary of the changes between the two sample versions. In one example, step 522 may analyze the first input received by step 506 and/or the second input received by step 510 to generate the summary, and the generated summary may be based on the analysis of the first and second inputs. For example, step 522 may use an artificial intelligence model (such as the artificial intelligence model accessed by step 402, a different artificial intelligence model, etc.) to analyze the first and second inputs to generate the summary. In another example, step 522 may use an artificial neural network to analyze the first and second inputs to generate the summary. In yet another example, step 522 may use a machine learning model to analyze the first and second inputs to generate the summary. The machine learning model may be a machine learning model trained using training examples to generate summary of changes between two versions of code triggered by inputs in natural language based on the inputs. An example of such training example may include one or more sample inputs in a natural language, together with a sample summary of the changes triggered by the inputs.

In some examples, step 514 may further comprise providing an indication of the avoidance of the triggering of the committing of the second version of the source code generated by step 508, and/or step 522 may further comprise providing an indication of the committing of the third version of the source code generated by step 516. For example, the provided indication may be provided digitally to another process and/or to an external computing device. In another example, the provided indication may be provided to an individual, for example textually, audibly, visually, graphically, in a natural language, via a user interface, and so forth. In one example, the provided indication may include an explanation of the reason for the determination(s) made by step 512 and/or step 520.

In some examples, the first input (received by step 506) and/or the second input (received by step 510) and/or the third input (received by step 518) may be inputs received from an individual, and process 500 may further comprise presenting to the individual the first version of the source code (accessed by step 504) and/or the second version of the source code (generated by step 508) and/or the third version of the source code (generated by step 516) or parts thereof. For example, the versions of the source code may be presented to the individual visually, textually, graphically, audibly, and so forth. In one example, the versions of the source code may be presented to the individual in a form that enables the individual to modify the source code, for example, in an IDE, in a code editor, and so forth.

In some examples, step 506 may further comprise receiving a first sketch. Further, step 508 may comprise using the artificial intelligence model accessed by step 402 to analyze the first input in the natural language received by step 506 and/or the first sketch received by step 506 and/or the at least portion of the first version of the source code accessed by step 504, to generate the second version of the source code. For example, step 508 may use the first sketch and/or pixel values of the first sketch as the additional information described above. Further, step 510 may further comprise, after generating the second version of the source code, receiving a second sketch. Further, step 516 may comprise using the artificial intelligence model accessed by step 402 to analyze the second input in the natural language received by step 510 and/or the second sketch received by step 510 and/or the at least portion of the second version of the source code generated by step 508 to generate the third version of the source code. For example, step 516 may use the second sketch and/or pixel values of the second sketch as the additional information described above. In one example, the first and/or second sketches may be indicative of a desire to modify and/or create a user interface associated with the source code. In another example, the first and/or second sketches may be indicative of a desire to modify a flow of information associated with the source code. In yet another example, the first and/or second sketches may be indicative of a desire to modify a software architecture associated with the source code. In some examples, step 512 may base (alternatively or additionally to the factors described above) the determination not to commit the second version of the source code to the VCS on the first sketch (and/or pixel values of the first sketch), and/or step 520 may base (alternatively or additionally to the factors described above) the determination to commit the third version of the source code to the VCS on the second sketch (and/or pixel values of the second sketch). For example, step 512 may use the artificial neural network and/or the machine learning model as described above, with the first sketch and/or the pixel values of the first sketch as the additional information. In another example, step 520 may use the artificial neural network and/or the machine learning model as described above, with the second sketch and/or the pixel values of the second sketch as the additional information. For example, the first sketch may be indicative of a need for a minor change to the source code, and the second sketch may be indicative of a need for a major change to the source code. Further, step 512 may base the determination not to commit the second version to the VCS on the first sketch being indicative of a need for a minor change, and/or step 520 may base the determination to commit the third version to the VCS on the second sketch being indicative of a need for a major change. In another example, the first sketch may be indicative of a need for a first change to the source code that is below a selected threshold, the second sketch may be indicative of a need for a second change to the source code that is below the selected threshold, and wherein the first and second changes combined together may be above the selected threshold. Further, step 512 may base the determination not to commit the second version to the VCS on the first change being below the selected threshold, and/or step 520 may base the determination to commit the third version to the VCS on the first and second changes combined together being above the selected threshold. In some examples, step 512 may base (alternatively or additionally to the factors described above) the determination not to commit the second version of the source code to the VCS on the second sketch received by step 510 and/or on pixel values of the second sketch. For example, the second sketch may be indicative of a desire to at least one of refine or revert at least one change made in the second version of the source code, and step 512 may base the determination not to commit the second version of the source code to the VCS on the second sketch being indicative of the desire to at least one of refine or revert at least one change made in the second version of the source code.

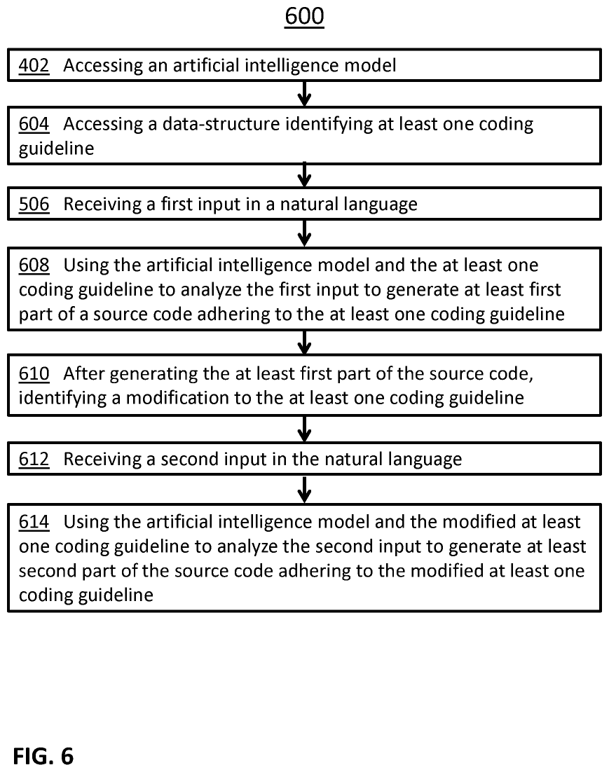

FIG. 6 is a flowchart of an example process 600 for software architecture in artificial intelligence coding, consistent with some embodiments of the present disclosure. In this example, process 600 may comprise: accessing an artificial intelligence model (step 402); accessing a data-structure identifying at least one coding guideline (step 604); receiving a first input in a natural language (step 506); using the artificial intelligence model and the at least one coding guideline to analyze the first input to generate at least first part of a source code adhering to the at least one coding guideline (step 608); after generating the at least first part of the source code, identifying a modification to the at least one coding guideline (step 610); receiving a second input in the natural language (step 612); and using the artificial intelligence model and the modified at least one coding guideline to analyze the second input to generate at least second part of the source code adhering to the modified at least one coding guideline (step 614). In other examples, process 600 may include additional steps or fewer steps. In other examples, one or more steps of process 600 may be executed in a different order and/or one or more groups of steps may be executed simultaneously.

In some examples, a system for software architecture in artificial intelligence coding may include at least one processing unit configured to perform operations, and the operations may include the steps of process 600. In some examples, a method for software architecture in artificial intelligence coding may include performing process 600. In some examples, a non-transitory computer readable medium may store computer implementable instructions that when executed by at least one processor may cause the at least one processor to perform operations for software architecture in artificial intelligence coding, and the operations may include the steps of process 600.

In some examples, step 604 may comprise accessing a data-structure identifying at least one coding guideline. For example, step 604 may read at least part of the data-structure from memory (for example, from a digital memory, from memory unit 210, etc.), may receive at least part of the data-structure from an external computing device (for example, using a digital communication device, such as communication module 230), may construct and/or generate and/or determine the data-structure (for example, based on other sources of coding guidelines, based on other information, based on analysis of other source code resources, based on inputs received from an individual, etc.), and so forth. In some examples, step 610 may comprise, for example after the generating the at least first part of the source code by step 608, identifying a modification to the at least one coding guideline. For example, step 610 may identify a change to the data-structure that includes, wherein the change to the data-structure includes the modification to the at least one coding guideline. In another example, step 610 may identify a replacement of the data-structure to a different data-structure including the modified at least one coding guideline. In yet another example, step 610 may receive an indication of the modification to the at least one coding guideline. For example, step 610 may read the indication of the modification from memory (for example, from a digital memory, from memory unit 210, etc.), may receive the indication of the modification from an external computing device (for example, using a digital communication device, such as communication module 230), may receive the indication of the modification from an individual (for example, via a user interface), and so forth. In one example, the data-structure accessed by step 604 may include text in the natural language indicative of the at least one coding guideline, and the modification to the at least one coding guideline identified by step 612 may include a modification to the text. For example, the text may include ‘Use clear, descriptive variable names that anyone can be understood without needing additional comments’, and the modification may include adding ‘and that follows the project's approved naming conventions’at the end of the sentence. In another example, the text may include ‘Keep functions small and focused on a single responsibility, with a maximum length of 40 lines and a clear docstring describing inputs and outputs’, and the modification may include removing ‘a maximum length of 40 lines’ and/or replacing ‘docstring’ with ‘Doxygen’. In another example, the data-structure accessed by step 604 may include encoding of one or more rules (for example, one or more executable rules) defining the at least one coding guideline (for example, a digital encoding, encoding in a formal language, in a markup language, in a data interchange format, in a programming language, etc.), and the modification to the at least one coding guideline may include at least one of removing a rule from the data-structure, adding a rule to the data-structure, or modifying a rule in the data-structure. In some examples, the at least one coding guideline may include at least one of a guideline associated with avoiding at least one security vulnerability, a guideline associated with avoiding at least one scalability problem, a guideline associated with software architecture, a guideline associated with naming convention, or at least one performance optimization rule.

In some examples, one or more source code pieces may be analyzed to determine coding guideline(s). For example, step 604 may analyze the one or more source code pieces to determine at least part of the at least one coding guideline. In another example, step 610 may analyze the one or more source code pieces to determine at least part of the modified at least one coding guideline. In one example, the one or more source code pieces may be pieces of the source code of step 608 and/or step 614 (other than the first and second parts of the source code). In another example, the one or more source code pieces may be pieces of source code different than the source code of step 608 and/or step 614. In one example, an artificial intelligence model (such as the artificial intelligence model accessed by step 402, a different artificial intelligence model, etc.) may be used to analyze the one or more source code pieces to determine the coding guideline(s). In another example, an artificial neural network may be used to analyze the one or more source code pieces to determine the coding guideline(s). In yet another example, a machine learning model may be used to analyze the one or more source code pieces to determine the coding guideline(s). The machine learning model may be a machine learning model trained using training examples to determine coding guidelines from source code examples. An example of such training example may include a sample piece of source code, together with a sample coding guideline associated with the sample piece of source code. In one example, the one or more source code pieces may adhere to a specific coding guideline, and the determined coding guideline(s) may include the specific coding guideline. In another example, the one or more source code pieces may not adhere to a specific coding guideline included in the determined coding guideline(s). In yet another example, the one or more source code pieces may lack in a specific aspect (for example, may include a bug, may include a security vulnerability, may include a sub-optimal implementation, may include obfuscated code, etc.), and the determined coding guideline(s) may be associated with avoiding similar lacks in the specific aspect. Further, the data-structure of step 604 may be updated based on the determined at least part of the at least one coding guideline, for example to include the determined at least part of the at least one coding guideline, to remove a coding guideline conflicting with the determined at least part of the at least one coding guideline, and so forth.

In some examples, an artificial intelligence model (such as the artificial intelligence model accessed by step 402, a different artificial intelligence model, etc.) and at least one coding guideline to analyze an input in a natural language to generate at least part of a source code adhering to the at least one coding guideline. For example, step 608 may comprise using the artificial intelligence model and the at least one coding guideline identified by the data-structure accessed by step 604 to analyze the first input received by step 506 to generate at least first part of a source code adhering to the at least one coding guideline. In another example, step 614 may comprise using the artificial intelligence model and the modified at least one coding guideline (associated with the modification identified by step 610) to analyze the second input received by step 612 to generate at least second part of the source code (of step 608) adhering to the modified at least one coding guideline. In some examples, the input in the natural language may include instructions and/or requests to modify the preliminary version of the source code to generate the new version of the source code. In one example, one or more instructions that adhere to the at least one coding guideline may be added to the preliminary version of the source code by the artificial intelligence model to generate a new version of the source code. In another example, one or more segments of the preliminary version of the source code may be removed by the artificial intelligence model to generate the new version of the source code. In yet another example, one or more instructions in the preliminary version of the source code may be modified by the artificial intelligence model in a way adhering to the at least one coding guideline to generate the new version of the source code. In some examples, the input in the natural language may include instructions and/or requests to create new source code or a new part of a source code (such as a new function, a new module, a new library, a new source code file, etc.), and a corresponding new source code or a new part of the source code may be generated by the artificial intelligence model to include one or more instructions that adhere to the at least one coding guideline. In some examples, step 608 may identify a first mathematical object in a particular mathematical space based on information included in the at least one coding guideline, for example using module 302. Further, step 608 may identify a second mathematical object in the particular mathematical space, the second mathematical object corresponds to at least one word included in the first input, for example using module 302. Further, step 608 may calculate a function of the first and second mathematical objects to obtain a third mathematical object in the particular mathematical space, the third mathematical object corresponds to a first at least one instruction, for example using module 304. Further, step 608 may include the first at least one instruction in the generated at least first part of the source code. In some examples, step 614 may identify a fourth mathematical object in the particular mathematical space based on information included in the modified at least one coding guideline that is not included in the at least one coding guideline, for example using module 302. Further, step 614 may identify a fifth mathematical object in the particular mathematical space, the fifth mathematical object corresponds to at least one word included in the second input, for example using module 302. Further, step 614 may calculate a function of the fourth and fifth mathematical objects to obtain a sixth mathematical object in the particular mathematical space, the sixth mathematical object corresponds to a second at least one instruction, for example using module 304. Further, step 614 may include the second at least one instruction in the generated at least second part of the source code. In one example, the data-structure accessed by step 604 may include text in the natural language indicative of the at least one coding guideline, the modification to the at least one coding guideline identified by step 610 may include a modification to the text, the information included in the at least one coding guideline (that the identification of the first mathematical object is based on) may include at least one word included in the text, and the information included in the modified at least one coding guideline that is not included in the at least one coding guideline (that the identification of the fourth mathematical object is based on) may include at least one word included in the modified at least one coding guideline that is not included in the at least one coding guideline. In another example, the data-structure accessed by step 604 may include encoding of one or more executable rules defining the at least one coding guideline, the modification to the at least one coding guideline identified by step 610 may include at least one of adding an executable rule to the data-structure or modifying an executable rule in the data-structure, the information included in the at least one coding guideline (that the identification of the first mathematical object is based on) may be associated with an executable rule included in the one or more executable, and the information included in the modified at least one coding guideline that is not included in the at least one coding guideline (that the identification of the fourth mathematical object is based on) may be associated with the at least one of the executable rule added to the data-structure or the executable rule modified in the data structure. In some examples, step 608 may document the adherence to the at least one coding guideline and/or step 614 may document the adherence to the modified at least one coding guideline. For example, the adherence may be documented in a log, in an audit log, in a compliance repository, in a VCS, in a governance database, in a memory, and so forth. In one example, the documentation may include an indication of the generated code, an indication of the coding guideline(s), an explanation in a natural language, and so forth.

In some examples, the first input in the natural language received by step 506 may be associated with a desire to deviate from at least part of the at least one coding guideline identified by the data-structure accessed by step 604, and/or the second input in the natural language received by step 612 may be associated with a desire to deviate from at least part of the modified at least one coding guideline associated with the modification identified by step 610. In one example, process 600 may analyze the first input and the at least one coding guideline to determine that the first input conflicts with the at least part of the at least one coding guideline, and/or may analyze the second input and the modified at least one coding guideline to determine that the first input conflicts with the at least part of the modified at least one coding guideline, for example using NLP algorithms, using an artificial neural network, using the artificial intelligence model accessed by step 402, using a LLM with a suitable prompt, and so forth. In one example, the at least first part of the source code generated by step 608 may be misaligned with the first input as a result of enforcing the at least part of the at least one coding guideline, and/or the at least second part of the source code generated by step 614 may be misaligned with the second input as a result of enforcing the at least part of the modified at least one coding guideline. In this example, process 600 may further comprise providing an indication that the at least first part of the source code generated by step 608 is misaligned with the first input as a result of enforcing the at least part of the at least one coding guideline, and/or providing an indication that the at least second part of the source code generated by step 614 is misaligned with the second input as a result of enforcing the at least part of the modified at least one coding guideline. For example, the indication(s) may be provided visually, textually, graphically, audibly, in a user interface, in a code viewer, in an IDE, in a code editor, and so forth. In one example, process 600 may further comprise determining whether to deviate from the at least part of the at least one coding guideline or to disregard at least part of the first input based on at least one of an analysis of the first input or a level of importance associated with the at least part of the at least one coding guideline. In some examples, the level of importance associated with the at least part of the at least one coding guideline may be determined based on one or more classification attributes associated with the coding guideline. The classification attributes may include, for example, a security classification, a compliance classification, a regulatory classification, an organizational policy designation, a risk severity score, a vulnerability mitigation designation, or a maintainability designation. In some examples, the classification attributes may be defined by an administrator, an organizational policy repository, an external compliance framework, or a security standards database. In some examples, the level of importance may be represented as a priority value, a weighting factor, a categorical tier, or another comparative metric usable by process 600 to determine whether to deviate from the at least part of the at least one coding guideline or to disregard at least part of the first input. In one example, the at least part of the at least one coding guideline may include ‘database queries must use parameterized statements to prevent SQL injection vulnerabilities’, the first input may include, ‘build the SQL query by concatenating the user input directly into the string, it's faster’, since security guidelines may have high importance, process 600 may determine not to deviate from the at least part of the at least one coding guideline and to disregard part of the first input, and/or the provided indication may include ‘Although it's slower, I used parameterized statements instead of directly concatenating the user input to comply with the coding guideline’. In another example, the at least part of the at least one coding guideline may include ‘Passwords and API keys must never be stored in plaintext, they must be encrypted or hashed using approved cryptographic methods’, the first input may include, ‘store the passwords in plaintext so we can debug login issues more easily’, since security guidelines may have high importance, process 600 may determine not to deviate from the at least part of the at least one coding guideline and to disregard part of the first input, and/or the indication may include ‘Although it makes debugging harder, I encrypted the passwords to comply with the coding guideline’. In yet another example, the at least part of the at least one coding guideline may include naming convention, the first input may include, ‘in this case ignore the guidelines and spell this variable name DATABASE_URL in all capital letters’, since naming conventions have lower importance, and since the input specifically request to ignore the guideline (and therefore it is clearly not an oversight), process 600 may determine to deviate from the at least part of the at least one coding guideline and name the variable ‘DATABASE_URL’. In some examples, process 600 may further comprise generating and storing a log entry or an audit record associated with the determination of whether to deviate from the at least part of the at least one coding guideline or to disregard at least part of the first input. The audit record may include, for example, at least a portion of the first input, the at least part of the at least one coding guideline, the level of importance associated with the at least part of the at least one coding guideline, an identified conflict between the first input and the at least part of the at least one coding guideline, the determination made by process 600, and/or the indication provided. In some examples, the audit record may further include a timestamp, a user identifier, a project identifier, a code artifact identifier, a version identifier, and/or an approval or override status. The audit record may be stored in an audit log, a compliance repository, a VCS, a governance database, or a memory, and may be accessible for review, reporting, compliance verification, or security analysis.

In some examples, the at least one coding guideline identified by the data-structure accessed by step 604 may include at least one guideline associated with avoiding at least one security vulnerability. In one example, the at least one security vulnerability may include at least one of an injection vulnerability, buffer overflow, or improper authentication. For example, to avoid SQL injection vulnerabilities, the at least one coding guideline may include ‘all database queries must use parameterized statements, never concatenate raw user input into SQL queries’, the first input may include ‘write a login function that checks a username and password against a SQL database’, and based on the at least one coding guideline, step 608 may avoid including code that concatenates strings into SQL in the generated at least first part of the source code. In another example, to avoid credential theft, the at least one coding guideline may include ‘authentication must use hashed passwords, plaintext comparison is prohibited’, the first input may include ‘create a user authentication routine’, and based on the at least one coding guideline, step 608 may avoid plaintext comparison and compares password hashes instead in the generated routine. In one example, the at least one guideline associated with the avoiding at least one security vulnerability may be associated with input sanitization. For example, to prevent attackers from injecting scripts, the at least one coding guideline may include ‘user-supplied content displayed in web pages must be output-encoded (HTML-escaped) before rendering’, the first input may include ‘create a webpage that displays user comments submitted through a form’, and based on the at least one coding guideline, step 608 may sanitize or encode all displayed user input. In one example, the at least one guideline associated with the avoiding at least one security vulnerability may be derived from a standardized security framework. Some non-limiting examples of such standardized security framework may include OWASP, CERT, and so forth. In some examples, the modification to the at least one coding guideline (identified by step 610) may be based on at least one newly disclosed security vulnerability. For example, the at least one newly disclosed security vulnerability may be associated with malicious users ability to craft inputs that manipulate an AI model to reveal sensitive data (prompt injection), and the modification to the at least one coding guideline may include requiring input validation and context isolation for all user-provided prompts and/or to avoid including confidential data in model context. In some examples, the modification to the at least one coding guideline (identified by step 610) may be based on an update to a standardized security framework. For example, to improve parallel processing efficiency, the at least one coding guideline may include ‘avoid unnecessary nested loops’, the first input may include ‘write a function to sum all elements in a 2D list efficiently’, and based on the at least one coding guideline, step 608 may generate a function that uses vectorized operations. In another example, to prevent inefficient processor utilization, the at least one coding guideline may include ‘avoid recomputing the same values multiple times, cache results when possible’, the first input may include ‘compute the Fibonacci numbers’, and based on the at least one coding guideline, step 608 may generate code that uses memoization (storing previously computed results) instead of naive recursion.

In some examples, the at least one coding guideline identified by the data-structure accessed by step 604 may include at least one guideline associated with avoiding at least one scalability problem. In one example, the at least one scalability problem may include at least one of inefficient resource utilization, bottlenecks in parallel processing, or suboptimal memory management. For example, to maintain low memory usage while working with arbitrary large files, the at least one coding guideline may include ‘use streaming or chunked processing instead of loading entire files into memory when handling large files’, the first input may include ‘analyze the log file and count how many times each IP address appears’, and based on the at least one coding guideline, step 608 may avoid loading the entire log file into memory, and may load and process each line of the log file separately. In another example, to eliminates lock contention, improves CPU utilization, and/or removes a parallel processing bottleneck, the at least one coding guideline may include ‘minimize shared locks and use task partitioning or map-reduce patterns for parallel workloads’, the first input may include ‘generate code to resize a repository of images’, and based on the at least one coding guideline, step 608 may keep file output operations independent per process and avoid locks in the generated code. In yet another example, to minimize memory usage, the at least one coding guideline may include ‘prefer generators and iterators over large in-memory collections when returning or transforming large result sets’, the first input may include ‘generate a function that returns all prime numbers up to 1 billion’, and based on the at least one coding guideline, step 608 may generate code that produces primes lazily rather than creating a container including all the primes. In some examples, the modification to the at least one coding guideline (identified by step 610) may be based on at least one newly discovered scalability problem. In one example, the modification to the at least one coding guideline may be based on an output of a performance profiling tool. In one example, as traffic grows, the system may experience severe slowdowns due to excessive database queries (N+1 query problem) coming from service-layer loops, the at least one guideline may originally include ‘fetch related data as needed within business logic’, and the modified at least one guideline may include ‘data must be fetched using optimized bulk queries or joins, iterative per-record database calls inside loops are prohibited’. In another example, high volume synchronous logging may cause input/output bottlenecks and increased API latency during peak usage, the at least one guideline may originally include ‘all service events should be logged synchronously at INFO level’, and the modified at least one guideline may include ‘logging must be asynchronous and non-blocking’ and/or ‘INFO logs in high-frequency code paths should be minimized or sampled’.

In some examples, the at least one coding guideline identified by the data-structure accessed by step 604 may include at least one guideline associated with software architecture. In one example, the at least one guideline associated with software architecture may include adherence to at least one of a layered architecture, a microservices architecture, or event-driven design patterns. In one example, the at least one coding guideline may include ‘use a layered architecture separating controllers, services, and data access’, the first input may include ‘we need a user registration system with email verification and password hashing’, and based on the at least one coding guideline, step 608 may generate code that separates controller, service, and repository modules, the controller may handles request, the service may manage hashing and verification logic, and the repository may perform database operations with no direct DB access from the controller. In another example, the at least one coding guideline may include ‘use a microservices architecture’, the first input may include ‘I want an e-commerce system that manages orders, payments, and shipping’, and based on the at least one coding guideline, step 608 may generate three standalone services with separate APIs and databases to handle orders, payments and shipping, plus inter-service communication, instead of a single monolithic codebase. In yet another example, the at least one coding guideline may include ‘use an event-driven design where services publish and subscribe to order events’, the first input may include ‘build a notification system that alerts users when orders are placed, shipped, or canceled’, and based on the at least one coding guideline, step 608 may generate event producers in the order system and event consumers in the notification service, including message broker integration and asynchronous handlers instead of direct service calls.

In some examples, the at least one coding guideline identified by the data-structure accessed by step 604 may include at least one guideline associated with naming convention. In one example, the at least one guideline associated with naming convention may include format rules for at least one of variables, functions, classes, or constants. For example, the at least one coding guideline may include a format for variable names, where the name starts with a lowercase letter, and each additional word in the name is capitalized (such as ‘userAge’, ‘totalPrice’, and so forth). In another example, the at least one coding guideline may include a format for function names, where all letters are lowercase, and words are separated by underscores (such as ‘calculate_price ()’, ‘send_notification ()’, and so forth). In some examples, the at least one coding guideline identified by the data-structure accessed by step 604 may include at least one performance optimization rule tailored to a target execution environment. For example, the target execution environment may be a mobile web browser on low-power devices with limited bandwidth and high latency networks, to reduce initial page load time and bandwidth consumption, the at least one coding guideline may include ‘lazy-load all non-critical images and defer off-screen rendering’, the first input may include ‘create a product listing webpage with images that supports infinite scroll’, and based on the at least one coding guideline, step 608 may generate code that lazy-load the product images and only render on-screen visuals. In another example, the target execution environment may be a server-less function with cold-start latency, short execution time limits, and pay-per-invocation billing. To minimize cold-start time and reduce execution cost, the at least one coding guideline may include ‘initialized resources outside the handler and avoid repeated heavy library loading’, the first input may include ‘create an API endpoint that resizes uploaded images and stores the thumbnails’, and based on the at least one coding guideline, step 608 may generate code that initialize handlers and load libraries outside the handler, and code that uses the external handlers and loaded libraries in the handler.

In some examples, for example in response to the identifying the modification to the at least one coding guideline by step 610, process 600 may further comprise analyzing the at least first part of the source code generated by step 608 to identify at least one section of the generated at least first part of the source code diverging from the modified at least one coding guideline. For example, process 600 may use an artificial intelligence model (such as the artificial intelligence model accessed by step 402, a different artificial intelligence model, etc.) to analyze the at least first part of the source code and the modified at least one coding guideline to identify the at least one section. In another example, process 600 may use an artificial neural network to analyze the at least first part of the source code and the modified at least one coding guideline to identify the at least one section. In yet another example, process 600 may use a machine learning model to analyze the at least first part of the source code and the modified at least one coding guideline to identify the at least one section. The machine learning model may be a machine learning model trained using training examples to identify segments of code diverging from coding guidelines. An example of such training example may include sample source code, sample coding guideline, and a label indicative of one or more segments of the sample source code diverging from the sample coding guideline. In one example, step 600 may provide an indication of the divergence from the modified at least one coding guideline. For example, the indication may be provided visually, textually, graphically, audibly, via a user interface, in an IDE, in a code editor, and so forth. In one example, the indication of the divergence may include an indication of the at least one section of the generated at least first part of the source code diverging from the modified at least one coding guideline, may include an indication of a specific guideline of the modified at least one coding guideline associated with the divergence, may include a natural language explanation of the divergence (for example, a natural language explanation generated by an LLM based on the divergence), and so forth. In some examples, process 600 may further comprise: using the artificial intelligence model and the modified at least one coding guideline to generate at least one suggested modification to the at least first part of the source code for remedying the divergence from the modified at least one coding guideline; and providing the at least one suggested modification to the at least first part of the source code (for example, digitally, visually, textually, graphically, audibly, in a user interface, in a code viewer, in an IDE, to another process, to another computing device, to an individual, and so forth). For example, the providing the at least one suggested modification to the at least first part of the source code may enable an individual to accept the at least one suggested modification (or a selected part thereof), and in response the at least first part of the source code may be updated based on the accepted modification. In another example, the providing the at least one suggested modification to the at least first part of the source code may include updating the at least first part of the source code based on the at least one suggested modification, and presenting the updated at least first part of the source code to an individual (for example, in a code editor, in an IDE, etc.) while enabling the individual to undo the update. In one example, the at least one suggested modification to the at least first part of the source code may be further based on an analysis of the first input received by step 506 and/or an analysis of the at least first part of the source code. For example, the artificial intelligence model may analyze the modified at least one coding guideline and/or the first input and/or the at least first part of the source code to generate at least one suggested modification to the at least first part of the source code for remedying the divergence from the modified at least one coding guideline.

In some examples, the second input received by step 612 may be associated with a need to modify at least portion of the at least first part of the source code generated by step 608. Further, step 614 may use an artificial intelligence model (such as the artificial intelligence model accessed by step 402, a different artificial intelligence model, etc.) and the modified at least one coding guideline (associated with the modification identified by step 610) to analyze the second input and the at least portion of the at least first part of the source code to generate at least one suggested modification to the at least portion of the at least first part of the source code. Further, the at least one suggested modification may be provided, for example as described above.

In some examples, the first and second inputs in the natural language may be received from an individual by steps 506 and 612, for example as described above. Further, process 600 may further comprise presenting to the individual the at least first part of the source code generated by step 608 and/or the at least second part of the source code generated by step 614. For example, the generated part(s) of the source code may be presented to the individual visually, textually, graphically, audibly, in a user interface, in a code viewer, and so forth. In one example, the generated part(s) of the source code may be presented to the individual in a form that enables the individual to modify the source code, for example, in an IDE, in a code editor, and so forth.

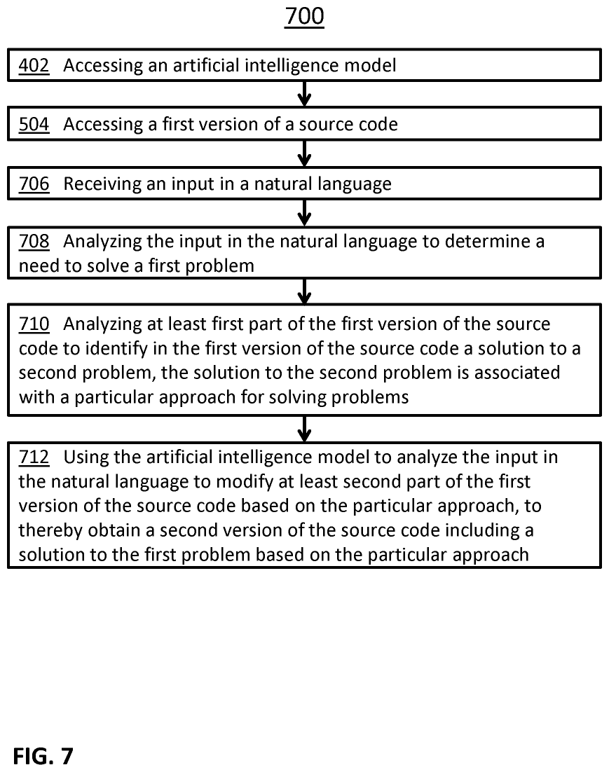

FIG. 7 is a flowchart of an example process 700 for consistency in artificial intelligence coding, consistent with some embodiments of the present disclosure. In this example, process 700 may comprise: accessing an artificial intelligence model (step 402); accessing a first version of a source code (step 504); receiving an input in a natural language (step 706); analyzing the input in the natural language to determine a need to solve a first problem (step 708); analyzing at least first part of the first version of the source code to identify in the first version of the source code a solution to a second problem (step 710), the solution to the second problem is associated with a particular approach for solving problems; and using the artificial intelligence model to analyze the input in the natural language to modify at least second part of the first version of the source code based on the particular approach, to thereby obtain a second version of the source code including a solution to the first problem based on the particular approach (step 712). In other examples, process 700 may include additional steps or fewer steps. In other examples, one or more steps of process 700 may be executed in a different order and/or one or more groups of steps may be executed simultaneously.

In some examples, a system for consistency in artificial intelligence coding may include at least one processing unit configured to perform operations, and the operations may include the steps of process 700. In some examples, a method for consistency in artificial intelligence coding may include performing process 700. In some examples, a non-transitory computer readable medium may store computer implementable instructions that when executed by at least one processor may cause the at least one processor to perform operations for consistency in artificial intelligence coding, and the operations may include the steps of process 700.

In one example, the input in the natural language received by step 706 may include a user story. For example, the user story may include ‘when I upload a file in the wrong format, the page shows a server error instead of telling me the file type isn't supported’, the first problem (of step 708 and/or step 712) may include an unhandled error at the backend size, the particular approach (of step 710 and/or step 712) may include using exception handling to catch errors, and the modification to the at least part of the version of the source code by step 712 may include adding instruction for raising an exception when a file of an unexpected format is received and/or for exception handling. In another example, the user story may include ‘when I export a report about a person with no activity records, I get an error message instead of an empty report’, the first problem (of step 708 and/or step 712) may include mishandling of edge cases, the particular approach (of step 710 and/or step 712) may include range validation, and the modification to the at least part of the version of the source code by step 712 may include adding instruction for identifying and handling the edge case of a person with no activity records. In one example, the input in the natural language received by step 706 may include a feature request. For example, the feature request may include ‘prevent users from entering special characters in usernames’, the first problem (of step 708 and/or step 712) may include a lack of input validation for usernames, the particular approach (of step 710 and/or step 712) may include using an allow-list input validation, and the modification to the at least part of the version of the source code by step 712 may include adding instruction for allow-list validation on characters in a username at form and API levels. In one example, the input in the natural language received by step 706 may include an issue ticket. For example, the issue ticket may include ‘all sessions are expired when daylight saving time comes into effect’, the first problem (of step 708 and/or step 712) may include calculating session duration using local time, the particular approach (of step 710 and/or step 712) may include calculating durations using Coordinated Universal Time (UTC) time, and the modification to the at least part of the version of the source code by step 712 may include modifying the session duration calculation to use UTC time rather than local time.

In some examples, step 708 may comprise analyzing an input in a natural language (such as the input in the natural language received by step 706, a different input in a natural language, etc.) to determine a need to solve a first problem. In one example, the input in the natural language may be indicative of the first problem and/or the need to solve the first problem. For example, the input may include ‘the continue button does not respond’ or ‘the last login shows the time of the current login rather than the previous login’. In another example, the input in the natural language may not be indicative of the first problem. For example, the problem may arise from a task indicated by the input, such as ‘show a comparison of the salary to the average salary in the previous twelve months’ while the system does not hold records of previous salaries. In one example, step 708 may use an NLP algorithm to analyze the input in the natural language and/or additional information to determine the need to solve the first problem. In another example, step 708 may use an artificial intelligence model (such as the artificial intelligence model accessed by step 402, a different artificial intelligence model, etc.) to analyze the input in the natural language and/or additional information to determine the need to solve the first problem. In yet another example, step 708 may use an artificial neural network to analyze the input in the natural language and/or additional information to determine the need to solve the first problem. In one example, step 708 may use a machine learning model to analyze the input and/or additional information in the natural language to determine the need to solve the first problem. The machine learning model may be a machine learning model trained using training examples to determine need to solve problems from natural language inputs and/or additional information. An example of such training example may include a sample natural language input and/or sample additional information, and a label indicative of a sample problem that needs to be solved arising from the sample natural language input and/or sample additional information. In some examples, step 708 may comprise analyzing the input in the natural language and the at least second part of the first version of the source code (of step 712) to determine the need to solve the first problem. For example, step 708 may use the at least second part of the first version of the source code as the additional information in the above examples. In one example, the input in the natural language may indicate a need for specific information at a specific point in time, step 708 may analyze the input to determine the need for the specific information at the specific point in time and may analyze the at least second part of the first version of the source code to determine that the specific information is not available at the specific point in time, and the first problem may be that the specific information is not available at the specific point in time (for example, when the specific information was available at a previous point in time but was not saved). In another example, the input in the natural language may indicate a need to access a resource, step 708 may analyze the input to determine the need for accessing the resource and may analyze the at least second part of the first version of the source code to determine a lack of authorization to access the resource, and the first problem may be the lack of authorization to access the resource. In some examples, step 708 may comprise: identifying a first mathematical object in a particular mathematical space (for example using module 302), the first mathematical object corresponds to at least one word included in the input; identifying a second mathematical object in the particular mathematical space based on at least one instruction included in the at least second part of the first version of the source code, for example using module 302; calculating a function of the first and second mathematical objects to obtain a particular mathematical object in the particular mathematical space, for example using module 304; and determining the need to solve the first problem based on the particular mathematical object. In some examples, step 708 may comprise analyzing the input in the natural language and the at least second part of the first version of the source code to identify a functional gap between the at least second part of the first version of the source code and a described expected behavior included in the input to thereby determine the need to solve the first problem. Some non-limiting examples of such functional gap may include missing input validation, no error handling, incomplete edge case handling, missing accessibility functionality, no screen-size or screen orientation support, user interface element exists without corresponding functionality, API end-point exists without corresponding functionality, and so forth.

In some examples, step 710 may comprise analyzing a part of a source code (such as at least first part of the first version of the source code accessed by step 504, a part of a different source code, etc.) to identify in the source code a solution to a problem. The identified solution to the problem may be associated with an approach for solving problems. For example, step 710 may comprise analyzing at least first part of the first version of the source code accessed by step 504 to identify in the first version of the source code a solution to a second problem, and the solution to the second problem may be associated with a particular approach for solving problems. For example, step 710 may use an artificial intelligence model (such as the artificial intelligence model accessed by step 402, a different artificial intelligence model, etc.) to analyze the part of the source code to identify in the source code the solution to the problem. In another example, step 710 may use an artificial neural network to analyze the part of the source code to identify in the source code the solution to the problem. In yet another example, step 710 may use a machine learning model to analyze the part of the source code to identify in the source code the solution to the problem. The machine learning model may be a machine learning model trained using training examples to identify problems and/or solutions to problems in source codes. An example of such training example may include a sample portion of a source code, together with a label indicative of one or more problems solved in the sample portion of the source code and/or one or more solutions in the sample portion of the source code to the one or more problems. In an additional example, step 710 may comprise: identifying a first mathematical object in a particular mathematical space based on at least one instruction included in the part of the source code, for example using module 302; identifying a second mathematical object in the particular mathematical space based on at least one parameter included in the part of the source code, for example using module 302; calculating a function of the first and second mathematical objects to obtain a third mathematical object in the particular mathematical space, for example using module 304; and identifying the solution to the problem in the source code based on the third mathematical object. In some examples, step 710 may analyze a log associated with the source code to identify the problem, and may analyze the part of the source code to identify in the source code the solution to the problem. In one example, the log may be a change log documenting changes made to the source code (for example, in a VCS, by one or more human programmers, by one or more AI coding systems, etc.) to identify the problem, for example using an NLP algorithm. For example, the log may include ‘I added function check_id() to avoid bugs arising from illegal inputs’, and step 710 may identify a problem of unchecked input and/or a solution of adding an input validation function. In one example, the log may be a log created by a previous version of the source code at run time. For example, the log may include ‘failed to record activity (id=“4×2”, activity=“etch”)’, and step 710 may identify a problem of unchecked input.

In some examples, step 710 may analyze the part of the source code (such as the at least first part of the first version of the source code) to identify in the source code (for example, in the first version of the source code) a plurality of solutions, for example using the techniques described above. Each solution of the plurality of solutions may be a solution to a respective problem and/or may be associated with a respective approach for solving problems. Thereby, step 710 may identify a plurality of approaches for solving problems. Further, step 710 may select the particular approach of the plurality of approaches. For example, step 710 may select the particular approach of the plurality of approaches randomly, based on one or more rules, using a scoring function that assign different scores to different approaches and choosing the approach associated with the highest (or lowest) score, by rating the plurality of approaches and choosing the highest (or lowest) rated approach, and so forth. In one example, step 710 may select the particular approach of the plurality of approaches based on a prevalence of the particular approach in the at least first part of the first version of the source code (for example, selecting the most prevalence approach of the plurality of approaches or a subgroup of the plurality of approaches). In another example, step 710 may select the particular approach of the plurality of approaches based on at least one coding guideline. For example, some approaches of the plurality of approaches may be not recommended or prohibited based on the at least one coding guideline, and thereby these approaches won't be selected as the particular approach. In another example, one of the plurality of approaches may be aligned with a recommendation or a rule included in the at least one coding guideline, and thereby this approach may be selected as the particular approach. In yet another example, step 710 may select the particular approach of the plurality of approaches based on a similarity between the second problem and the first problem.

In some examples, step 712 may comprise using an artificial intelligence model (such as the artificial intelligence model accessed by step 402, a different artificial intelligence model, etc.) to analyze an input in a natural language (such as the input in the natural language received by step 706, a different input in a natural language, etc.) to modify at least part of a version of a source code (such as at least second part of the first version of the source code accessed by step 704, a part of a different version of the source code, a part of a different source code, etc.) based on a selected approach (such as the particular approach identified by step 710, a different approach, etc.), to thereby obtain a second version of the source code including a solution to a problem (such as the first problem of step 708, a different problem indicated by the input, a different problem, etc.) based on the selected approach. For example, step 712 may comprise using the artificial intelligence model to analyze the input in the natural language received by step 706 to modify at least second part of the first version of the source code accessed by step 704 based on the particular approach identified by step 710, to thereby obtain a second version of the source code including a solution to the first problem of step 708 based on the particular approach. In one example, the modification to the at least part of the version of the source code by step 712 may include adding instructions implementing the solution to the problem based on the selected approach. In another example, the modification to the at least part of a version of a source code by step 712 may include modifying instructions and/or parameters included in the at least part of a version of a source code to thereby implement the solution to the problem based on the selected approach. In yet another example, the selected approach for solving problems may include usage of a particular design pattern. Further, the modification to the at least part of the version of the source code by step 712 may include adding instructions implementing the particular design pattern to solve the problem. For example, the design pattern may include usage of an iterator to access and/or to provide access to elements of a collection, and the added instructions may implement and/or use an iterator. In another example, the design pattern may include usage of an adapter to make two incompatible interfaces to work together, and the added instructions may implement an adapter to make two other incompatible interfaces to work together. In some examples, step 712 may comprise: identifying a first mathematical object in a particular mathematical space (for example using module 302), the first mathematical object may correspond to at least one word included in the input; identifying a second mathematical object in the particular mathematical space based on at least one instruction included in the at least second part of the first version of the source code, for example using module 302; calculating a function of the first and second mathematical objects to obtain a particular mathematical object in the particular mathematical space, for example using module 304; determining at least one additional instruction based on the particular mathematical object and the particular approach; and adding the at least one additional instruction to the at least second part of the first version of the source code to implement the solution to the first problem based on the particular approach. In some examples, step 712 may comprise: identifying a first mathematical object in a particular mathematical space (for example using module 302), the first mathematical object may correspond to at least one word included in the input; identifying a second mathematical object in the particular mathematical space based on at least one instruction included in the at least second part of the first version of the source code, for example using module 302; identifying a third mathematical object in the particular mathematical space based on at least one instruction included in the at least first part of the first version of the source code, for example using module 302; calculating a function of the first, second and third mathematical objects to obtain a particular mathematical object in the particular mathematical space, for example using module 304; determining at least one additional instruction based on the particular mathematical object; and adding the at least one additional instruction to the at least second part of the first version of the source code to implement the solution to the first problem based on the particular approach.

In some examples, step 710 may analyze the at least first part of the first version of the source code to identify at least one of a function or a library that solves at least part of the first problem, and step 712 may include in the modification to the at least second part of the first version of the source code one or more calls to the at least one of the function or the library. For example, the particular approach of step 710 may include usage of the at least one of a function or a library to solve the at least part of the first problem. In another example, the solution to the at least part of the first problem may include performing a specific action (such as performing a calculation, transmitting information, receiving information, activating or deactivating a service, and so forth), and the identified at least one of the function or the library may perform the specific action. In one example, the identified function may solve the at least part of the first problem exactly. In another example, the identified function may can be used to solve the at least part of the first problem with a specific addition (for example, by setting a parameter of the function to a specific value, by pre-processing input to the function, by post-processing output of the function, and so forth), and including the one or more calls may include adding the suitable additions in addition to the calls (for example, adding a value to be passed as a parameter to the generated function, adding pre-processing instructions, adding post-processing instructions, and so forth).

In some examples, step 712 may generate at least one of a function or a library for solving at least part of the first problem (for example using the techniques described herein), and may include the generated at least one of the function or the library in the second version of the source code. Process 700 may further comprise: analyzing the at least first part of the first version of the source code to identify instructions that can be replaced by one or more calls to the at least one of the function or the library, and replacing the identified instructions with the one or more calls in the second version of the source code. For example, the generated function or a usage of the generated library may implement a functionality implemented in the at least first part of the first version of the source code by the identified instructions, and process 700 may replace these instructions with the one or more calls to the at least one of the function or the library (for example, to functions included in the library). In one example, the generated function may include exact copy of the identified instructions. In another example, the generated function may include different instructions than the identified instructions that can be used to perform the same functionality (for example, by setting a parameter of the function to a specific value, by pre-processing input to the function, by post-processing output of the function, and so forth), and replacing the identified instructions with the one or more calls may include adding the suitable additions in addition to the calls (for example, adding a value to be passed as a parameter to the generated function, adding pre-processing instructions, adding post-processing instructions, and so forth). In one example, process 700 may use an artificial intelligence model (such as the artificial intelligence model accessed by step 402, a different artificial intelligence model, etc.) to analyze the at least first part of the first version of the source code to identify the instructions that can be replaced by the one or more calls to the at least one of the function or the library, and/or to replace the identified instructions with the one or more calls in the second version of the source code. In another example, process 700 may use an artificial neural network to analyze the at least first part of the first version of the source code to identify the instructions that can be replaced by the one or more calls to the at least one of the function or the library, and/or to replace the identified instructions with the one or more calls in the second version of the source code.

In some examples, the first problem (of step 708 and/or step 712), the second problem (of step 710), and the particular approach for solving problems (of step 710 and/or step 712) may be associated with resource management. For example, the first problem may include resource leakage due to unused file kept open, the second problem may include resource leakage due to unused sockets kept open, the particular approach for solving problems may include using automatic clean-up technique (such as ‘with’ in python, a RAII approach in c++, and so forth). In another example, the first problem may include resource leakage due to unused allocated array not being freed, the second problem may include resource leakage due to unused allocated object not being freed, and the particular approach for solving problems may include using smart pointers. In some examples, the first problem (of step 708 and/or step 712), the second problem (of step 710), and the particular approach for solving problems (of step 710 and/or step 712) may be associated with error handling. For example, the first problem may include program crashing when receiving unexpected inputs, the second problem may include program crashing when a specific file doesn't exist, and the particular approach for solving problems may include using exception handling to catch the error instead of crashing. In another example, the first problem may include returning wrong answers when operating on out-of-range values, the second problem may include crashing when dividing by zero, and the particular approach for solving problems may include range checking before executing code that is unsuitable to some values, for example with a guard clause. In some examples, the first problem (of step 708 and/or step 712), the second problem (of step 710), and the particular approach for solving problems (of step 710 and/or step 712) may be associated with input validation. For example, the particular approach for solving problems may include at least one of allow-list input validation, block-list input validation, input sanitization, or input normalization. In another example, the particular approach for solving problems may include at least one of data-type validation, length and/or boundary checking, range validation, syntactic validation, or semantic validation. In some examples, the first problem (of step 708 and/or step 712), the second problem (of step 710), and the particular approach for solving problems (of step 710 and/or step 712) may be associated with concurrency handling. For example, the particular approach for solving problems may include at least one of usage of locks and/or mutexes and/or semaphores, usage of atomic operations, or usage of an actor model. In another example, the particular approach for solving problems may include usage of data versioning to resolve conflicts (such as multi-version concurrency control approach, validation based control approach, and so forth).

In some examples, process 700 may further comprise, after obtaining the second version of the source code by step 712, receiving a second input in the natural language indicative of a desire not to use the particular approach for solving problems. For example, the second input may be received using step 612. Further, process 700 may further comprise using an artificial intelligence model (such as the artificial intelligence model accessed by step 402, a different artificial intelligence model, etc.) to analyze the second input in the natural language to generate a third version of the source code based on a specific approach different from the particular approach for solving problems (of step 710 and/or step 712), the third version of the source code may include a different solution to the first problem (of step 708 and/or step 712) based on the specific approach. For example, the particular approach may include usage of a block-list input validation, the second version of the source code obtained by step 712 may include usage of a block-list input validation to validate an input from a user, the second input may include ‘we prefer allow-list input validation over block-list input validation’, the specific approach may include usage of an allow-list input validation’, and the generated third version of the source code may include usage of an allow-list input validation to validate the input from the user instead of the block-list input validation used in the second version. In another example, the particular approach may include usage of locks, mutexes and semaphores for concurrency handling, the second version of the source code obtained by step 712 may include usage of locks and/or mutexes and/or semaphores, the second input may include ‘we prefer not to use blocking operations for concurrency handling’, the specific approach may include usage data versioning to resolve conflicts, and the generated third version of the source code may include usage of data versioning to replace the locks and/or mutexes and/or semaphores.

In some examples, the input in the natural language received by 706 may be indicative of the first problem of step 708 and/or step 712. In some examples, the input in the natural language received by 706 may be indicative of the first problem. For example, the first problem may rise from an approach taken by the artificial intelligence model to fulfil a desire associated with the input in the natural language received by 706 (for example, a desire to solve a different problem, a desire to add a feature, and so forth). In some examples, the input in the natural language received by 706 may be indicative of a specific problem, step 708 may decompose the specific problem to a series of sub-problems. The series of sub-problems may include the first problem of step 708 and/or step 712. In one example, the series of sub-problems further include a third problem, and process 700 may further comprise: analyzing at least third part of the first version of the source code to identify in the first version of the source code a solution to a fourth problem, the solution to the fourth problem is associated with a second approach for solving problems, the second approach differs from the first approach (for example as described herein in relation to step 710); and further basing the using the artificial intelligence model to analyze the input in the natural language to modify the at least second part of the first version of the source code on the second approach, wherein the second version of the source code includes a solution to the third problem based on the second approach (for example, as described above in relation to step 712, and/or the first approach, and/or the first problem). The third part of the first version of the source code and the first part of the first version of the source code (of step 710) may be the same part, may be different parts, may have at least one instruction but not all in common, may have no instruction in common, and so forth.

In some examples, the input in the natural language received by 706 may be received from an individual (for example, as described above), and process 700 may further comprise presenting the second version of the source code obtained by step 712 to the individual. For example, the second version of the source code may be presented to the individual visually, textually, graphically, audibly, in a user interface, in a code viewer, and so forth. In one example, the second version of the source code may be presented to the individual in a form that enables the individual to modify the source code, for example, in an IDE, in a code editor, and so forth.

In some examples, process 700 may further comprise providing an indication of the particular approach for solving problems (of step 710 and/or step 712) and/or providing an indication of the solution to the second problem identified by step 710. In one example, the provided indication may include a textual indication in the natural language, may be audible indication in the natural language, may be a visual indication, may be a graphical indication, and so forth. In another example, the indication may be provided in a comment in the second version of the source code obtained by step 712. In yet another example, the indication may be associated with the second version of the source code obtained by step 712 in a VCS.

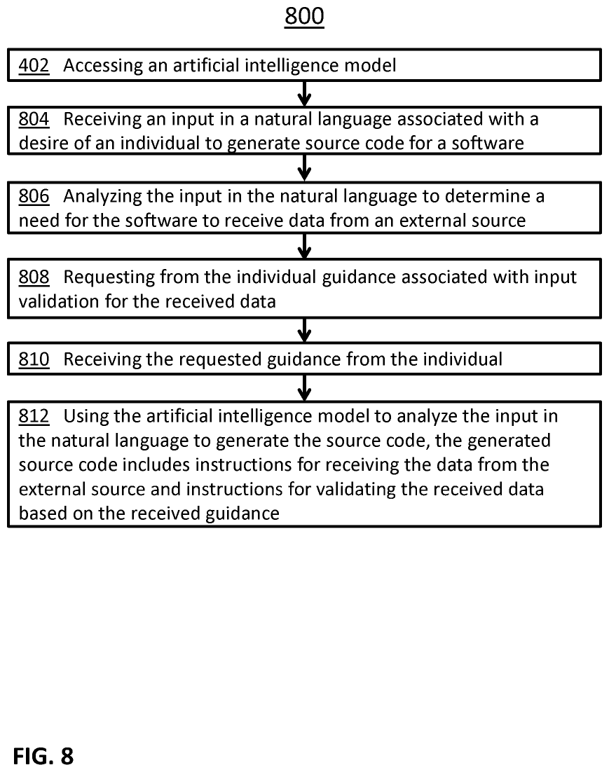

FIG. 8 is a flowchart of an example process 800 for input validation in artificial intelligence coding, consistent with some embodiments of the present disclosure. In this example, process 800 may comprise: accessing an artificial intelligence model (step 402); receiving an input in a natural language associated with a desire of an individual to generate source code for a software (step 804); analyzing the input in the natural language to determine a need for the software to receive data from an external source (step 806); requesting from the individual guidance associated with input validation for the received data (step 808); receiving the requested guidance from the individual (step 810); using the artificial intelligence model to analyze the input in the natural language to generate the source code, the generated source code includes instructions for receiving the data from the external source and instructions for validating the received data based on the received guidance (step 812). In other examples, process 800 may include additional steps or fewer steps. In other examples, one or more steps of process 800 may be executed in a different order and/or one or more groups of steps may be executed simultaneously.

In some examples, a system for input validation in artificial intelligence coding may include at least one processing unit configured to perform operations, and the operations may include the steps of process 800. In some examples, a method for input validation in artificial intelligence coding may include performing process 800. In some examples, a non-transitory computer readable medium may store computer implementable instructions that when executed by at least one processor may cause the at least one processor to perform operations for input validation in artificial intelligence coding, and the operations may include the steps of process 800.

In some examples, step 806 may comprise analyzing an input in a natural language (such as the input in the natural language received by step 804, a different input in a natural language, etc.) to determine a need for the software to receive data from an external source. In one example, the input in the natural language may be indicative of the need to receive the data and/or the external source. For example, the input may include ‘obtain sales data’ or ‘obtain sales data from the scans of the manual sales records’. In another example, the input in the natural language may not be indicative of the need to receive the data and/or the external source. For example, the input may include ‘calculate the average sale size for each month’ while the software does not hold the sales records. In one example, step 806 may use an NLP algorithm to analyze the input in the natural language and/or additional information to determine the need for the software to receive data from the external source. In another example, step 806 may use an artificial intelligence model (such as the artificial intelligence model accessed by step 402, a different artificial intelligence model, etc.) to analyze the input in the natural language and/or additional information to determine the need for the software to receive data from the external source. In yet another example, step 806 may use an artificial neural network to analyze the input in the natural language and/or additional information to determine the need for the software to receive data from the external source. In one example, step 706 may use a machine learning model to analyze the input in the natural language and/or additional information to determine the need for the software to receive data from the external source. The machine learning model may be a machine learning model trained using training examples to determine need for receiving information from external sources based on natural language inputs and/or additional information. An example of such training example may include a sample natural language input and/or sample additional information, together with a label indicative of a need for receiving information from external sources and/or characteristics of the external sources.

In some examples, step 808 may comprise requesting, for example from an individual (such as the individual of step 804, from a different individual, etc.) guidance associated with input validation, for example for the received data of step 806 and/or step 812, for a different received data, and so forth. For example, step 808 may present the request textually, audibly, visually, graphically, via a user interface, and so forth. In one example, the request may be a request in a natural language (such as the natural language of step 804, a different natural language, etc.), such as a textual request in the natural language, a request in an audible speech in the natural language, and so forth.

In some examples, step 810 may comprise receiving guidance (such as the guidance requested by step 808, guidance associated with input validation, a different guidance, etc.) from an individual (such as the individual of step 804 and/or step 808, from a different individual, and so forth). In one example, the received guidance may be or include guidance in a natural language, and step 810 may receive the guidance as described above (for example, in relation to step 706). For example, the guidance may include ‘validate the input at the server side, even if you already validated it at the browser’, ‘verify its type, length, and format’, ‘let's use an allow-list for this validation’, ‘the only allowed values are 0 and 1’, ‘inputs that contain irregular characters are prohibited’, ‘reject inputs that include the @ characters’, or ‘make a full schema validation for this input and log any invalid input’. In one example, the received guidance may be indicative of a set of values (such as a set of valid values, a set of invalid values, a list of values, a range of values, a rule defining the set of values, and so forth). For example, the set of values may be received via a user interface, via natural language (for example, as described above), via a rule defined by formal language (such as a programming language code defining a validity check, a markup language or a data interchange format defining a schema, etc.), and so forth. In one example, the request of step 808 may include a plurality of alternative options for input validation, and the guidance received by step 810 may include a selection of one option of the plurality (for example, via a user interface).

In some examples, step 812 may comprise using an artificial intelligence model (such as the artificial intelligence model accessed by step 402, a different artificial intelligence model, etc.) to analyze an input (such as the input received by step 804, an input in a natural language, a different input) to generate the source code. The generated source code may include instructions for receiving data from an external source (for example, for receiving the data from the external source of step 806) and/or instructions for validating the received data, for example based on guidance (such as the guidance received by step 810, guidance received from an individual, guidance included in a coding guideline, and so forth). In one example, the instructions for receiving data from the external source and/or the instructions for validating the received data may be based on an analysis of the input in the natural language. In some examples, the instructions for validating the received data may include at least one check of the received data not based on the received guidance. For example, the received guidance may include ‘let's use an allow-list for this validation’ with no mention of source authentication, a coding guideline may require source authentication for all transmission received from an external devices, and the instructions for validating the received data may include allow-list validation and source authentication. In some examples, the instructions for validating the received data may include at least one check of the received data that is inconsistent with the received guidance. For example, the received guidance may be inconsistent with a coding guideline, and the instructions for validating the received data may include at least one check of the received data may be inconsistent with the received guidance in order to be consistent with the coding guideline. In another example, the received guidance may be unsuitable to a type of input and/or to a source of input associated with the received data, and the instructions for validating the received data may be inconsistent with the received guidance in order to be suitable for the type of input and/or to the source of input. In one example, process 800 may further comprise providing an indication of the inclusion of the at least one check of the received data that is inconsistent with the received guidance and/or for the reason for the inclusion. For example, the indication may be provided digitally, visually, textually, graphically, audibly, via a user interface, in an IDE, in a code editor, in a VCS, as remarks in the source code, to an individual, to a different process, to a different computing device, and so forth. In one example, the indication may include a natural language indication and/or explanation of the inclusion and/or of the reason for the inclusion (for example, a natural language indication and/or explanation generated by an LLM based on the divergence), and so forth. In some examples, step 812 may comprise: identifying a first mathematical object in a particular mathematical space, wherein the first mathematical object corresponds to at least one word included in the input, for example using module 302; identifying a second mathematical object in the particular mathematical space based on at least part of the received guidance, for example using module 302; calculating a function of the first and second mathematical objects to obtain a third mathematical object in the particular mathematical space, for example using module 304; and determining at least part of the instructions for validating the received data based on the third mathematical object. In one example, step 812 may comprise determining at least part of the instructions for receiving the data from the external source based on the first mathematical object.

In some examples, the instructions for validating the received data generated by step 812 may be further based on at least one coding guideline, for example as described herein. In some examples, the instructions for validating the received data generated by step 812 may be further based on the external source, for example based on a type of the external source as described below, based on an identity of the external source, and so forth.

In some examples, an external source (such as the external source of step 806 and/or step 812, a different external source) may be at least one of a human user, a different software, or a device external to a computing device executing the software. In one example, the instructions for validating the received data generated by step 812 may be based on a type of the external source. In some examples, the external source may be a human user. In one example, the instructions for validating the received data generated by step 812 may be further based on the external source being a human user. For example, when the external source is a human user, the instructions for validating the received data may include normalization (such as trimming, case-fold, format correction, etc.), and may not include cryptographic signature validation. In some examples, the external source may be a different software. In one example, the instructions for validating the received data generated by step 812 may be further based on the external source being a different software. For example, when the external source is a different software, the instructions for validating the received data may include checking permissions or capability token, and may not include cryptographic signature validation and/or anti replay check. In some examples, when the software is executed by a computing device, the external source may be a device external to the computing device. In one example, the instructions for validating the received data generated by step 812 may be further based on the external source being a device external to the computing device. For example, when the external source is a device external to the computing device, the instructions for validating the received data may include cryptographic signature validation and/or anti replay check, and may not include process ID check.

In some examples, process 800 may further comprise at least one of presenting the source code generated by step 812 to an individual (such as the individual of step 804 and/or step 808 and/or step 810, a different individual, etc.), committing the source code generated by step 812 to a VCS, or executing the source code generated by step 812. In one example, process 800 may further comprise presenting the source code generated by step 812 to an individual (such as the individual of step 804 and/or step 808 and/or step 810, a different individual, and so forth). For example, the generated source code may be presented to the individual visually, textually, graphically, audibly, in a user interface, in a code viewer, and so forth. In one example, the generated source code may be presented to the individual in a form that enables the individual to modify the source code, for example, in an IDE, in a code editor, and so forth. In one example, process 800 may further comprise committing the source code generated by step 812 to a VCS. In one example, process 800 may further comprise executing the source code generated by step 812, for example using at least one processing unit.

In some examples, process 800 may further comprise accessing a preliminary version of the source code of step 804 and/or step 812, for example, before the input in the natural language is received by step 804 and/or before the source code is generated by step 812, for example as described above in relation to step 504. Further, step 812 may base the generation of the source code on the preliminary version of the source code. For example, step 812 may use the artificial intelligence model to analyze the input in the natural language to modify the preliminary version of the source code, for example as described above in relation to step 712, by adding instructions to the preliminary version of the source code, by removing instructions from the preliminary version of the source code, by modifying instructions of the preliminary version of the source code, and so forth. In another example, step 812 may analyze the preliminary version of the source code to determine at least one coding guideline (for example, as described above in relation to step 604), and may base the generation of the source code on the determined at least one coding guideline (for example, as described above in relation to step 608). In yet another example, step 812 may analyze the preliminary version of the source code to identify in the preliminary version of the source code a solution to a problem, wherein the solution to the problem is associated with a particular approach for solving problems (for example, as described above in relation to step 710), and may base the generation of the source code on the particular approach for solving problems (for example, as described above in relation to step 712). In some examples, the instructions for validating the received data generated by step 812 and/or the instructions for receiving the data from the external source generated by step 812 may be further based on an analysis of the preliminary version of the source code. For example, the instructions may include a call to a function or usage of a library included in the preliminary version of the source code, may solve a problem using the particular approach for solving problems used in the preliminary version of the source code, may adhere to the at least one coding guideline determined by analyzing the preliminary version of the source code, and so forth. In some examples, step 806 may comprise analyzing the input in the natural language and the preliminary version of the source code to determine the need for the software to receive data from the external source. For example, the input may include ‘find the top three salaries’, the preliminary version of the source code may include no access to salaries data, and in response step 806 may determine a need to receive the salaries data from an external source.

In some examples, process 800 may use an artificial intelligence model (such as the artificial intelligence model accessed by step 402, a different artificial intelligence model, etc.) to generate one or more testing procedures for a source code (such as the source code of step 804 and/or step 812, a different source code, etc.) based on received guidance (such as the guidance received by step 810, guidance that at least part of the source code is based on, a different guidance, and so forth), for example as described below. For example, the one or more testing procedures for a source code may be generated before the source code exists, before the source code is generated, when the source code already exists, after the source code is generated, and so forth. In one example, process 800 may execute the generated one or more testing procedures to test the source code. In another example, process 800 may provide the one or more test procedures. For example, the one or more test procedures may be provided digitally, visually, textually, graphically, audibly, via a user interface, in an IDE, in a code editor, in a VCS, to an individual, to a different process, to a different computing device, and so forth. In one example, the generated one or more testing procedures may test the reaction of the source code to different input, and to check whether they comply with the received guidance.

In some examples, the guidance received by step 810 may include guidance in a natural language (such as the natural language of step 804, a different natural language, and so forth). Further, step 812 may base the instructions for validating the received data on at least one word included in the guidance. For example, step 812 may comprise: identifying a first mathematical object in a particular mathematical space, wherein the first mathematical object corresponds to at least one word included in the input, for example using module 302; identifying a second mathematical object in the particular mathematical space, wherein the second mathematical object corresponds to at least one word included in the received guidance, for example using module 302; calculating a function of the first and second mathematical objects to obtain a third mathematical object in the particular mathematical space, for example using module 304; and determining at least part of the instructions for validating the received data based on the third mathematical object. In some examples, the guidance received by step 810 may include a word, a location at which the input validation is to be performed may be determined based on the word, and the instructions for validating the received data generated by step 812 may implement the validation at the determined location. Some non-limiting examples of such word may include a noun, an adverb, and so forth. In one example, the received guidance may include ‘validate the input at the server’, and the location may be server-side. In another example, the received guidance may include ‘the input is received by the browser, validate the input there’, and the location may be a browser. Some non-limiting examples of such location may include a device, server-side, client-side, browser, API gateway, middleware layer, edge computing device, firewall, proxy, wrapper, and so forth. In some examples, the guidance received by step 810 may include a word, a desired characteristic of the received data may be determined based on the word, and the instructions for validating the received data generated by step 812 may include validating the determined desired characteristic. Some non-limiting examples of such word may include a noun, a pronoun, a determiner, and so forth. Some non-limiting examples of such characteristic may include type, format, list, uniqueness, consistency (for example, with another input, with existing data, etc.), and so forth. In one example, the received guidance may include ‘verify the input length’, and the desired characteristic may be a length of the input. In another example, the received guidance may include ‘the input may be in the specified format, please verify it’, and the desired characteristic may be a format of the input. In some examples, the guidance received by step 810 may include a word, a validation technique may be determined based on the word, and the instructions for validating the received data generated by step 812 may include an implementation of the validation technique. Some non-limiting examples of such word may include a verb, an adjective, a noun, a pronoun, a determiner, and so forth. In one example, the received guidance may include ‘Let's use an allow-list for this validation’, and the validation technique may be allow-list input validation. In another example, the received guidance may include ‘I think a block-list would be appropriate, let's implement it’, and the validation technique may be block-list input validation. In yet another example, the received guidance may include ‘the allowed values are −1 and 1’ or ‘the prohibited values are −1 and 1’, and the validation technique may be either allow-list or block-list input validation based on whether the adjective is ‘allowed’ or ‘prohibited’. In an additional example, the received guidance may include ‘only 0 and 1 are allowed’ or ‘only 0 and 1 are prohibited’, and the validation technique may be either allow-list or block-list input validation based on whether the verb is ‘allowed’ or ‘prohibited’.

In some examples, the guidance received by step 810 may include an input in a formal language. Further, step 812 may base the instructions for validating the received data on at least one token included in the guidance. In one example, the input in the formal language may be in a markup language or in a data interchange format. For example, the formal language input may define a schema that needs to be validated. In one example, the input in the formal language may be in a programming language. For example, the programming language input may define a rule that defines valid or invalid inputs. In one example, the input in the formal language may be a regular expression. For example, the regular expression may valid or invalid inputs.

In some examples, the guidance received by step 810 may include a selection of an input validation approach. Further, the instructions for validating the received data generated by step 812 may implement the selected input validation approach. Some non-limiting examples of validation technique and/or input validation approach may include allow-list input validation, block-list input validation, input sanitization, input normalization, schema validation, type validation, length validation, range validation, format validation, rule-based validation, required-field validation, cross-field validation, business-rule validation, authorization-based validation, rate-limit, checksum validation, hash-validation, token-validation, input source validation, cryptographic validation, and so forth.

In some examples, the guidance received by step 810 may be indicative of two or more values. Further, the instructions for validating the received data generated by step 812 may implement at least one of an allow-list input validation with a list including the two or more values or block-list input validation with a list including the two or more values. For example, the guidance received by step 810 may include guidance in a natural language indicative of two or more values (for example, as described above), may include input in a formal language indicative of two or more values (for example, as described above), may include value(s) or range(s) entered via a user interface, may include value(s) or ranges(s) selected (for example, from alternative options, marked on a graphical presentation of possible value, etc.), and so forth. In one example, the guidance received by step 810 may include an indication that a specific input is valid, for example as described herein. In one example, the guidance received by step 810 may include an indication that a specific input is invalid, for example as described herein.

In some examples, the guidance received by step 810 may be indicative of a desire reaction to invalid input. Further, the instructions for validating the received data generated by step 812 may be configured to trigger the desire reaction in response to an invalid received input. Some non-limiting examples of such desire reaction to invalid input may include logging the invalid input (for example, together with contextual information, in an activity log, in a security log, etc.), reporting the invalid input (for example, to an individual, to a different process, etc.), providing an error message and/or explanation to the external source, enabling the external source to re-enter the input, and so forth. For example, the guidance received by step 810 may include guidance in a natural language indicative of the desire reaction to invalid input (such as ‘make a full schema validation for this input and log any invalid input’), may include a selection of the desire reaction from a plurality of alternative reactions (for example, via a user interface), and so forth.

In some examples, the guidance received by step 810 may be indicative of a location at which the input validation is to be performed. Further, the instructions for validating the received data generated by step 812 may be configured to cause the validation at the indicated location. Some non-limiting examples of such location may include a device, server-side, client-side, browser, API gateway, middleware layer, edge computing device, firewall, proxy, wrapper, and so forth. For example, the guidance received by step 810 may include guidance in a natural language indicative of the location (such as ‘validate the input at the server’), may include a selection of the location of a plurality of alternative locations (for example, via a user interface), and so forth.

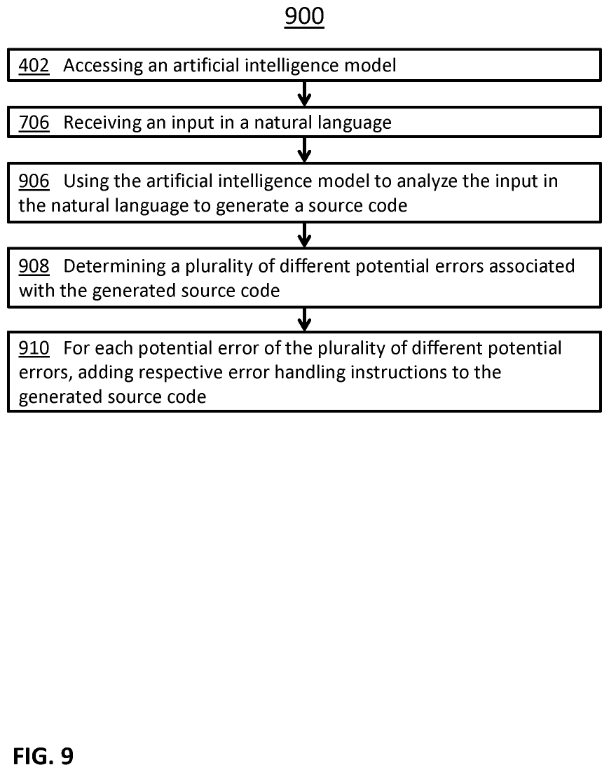

FIG. 9 is a flowchart of an example process 900 for error handling in artificial intelligence coding, consistent with some embodiments of the present disclosure. In this example, process 900 may comprise: accessing an artificial intelligence model (step 402); receiving an input in a natural language (step 706); using the artificial intelligence model to analyze the input in the natural language to generate a source code (step 906); determining a plurality of different potential run-time errors associated with the generated source code (step 908); and for each potential run-time error of the plurality of different potential run-time errors, adding respective error handling instructions to the generated source code (step 910). In other examples, process 900 may include additional steps or fewer steps. In other examples, one or more steps of process 900 may be executed in a different order and/or one or more groups of steps may be executed simultaneously.

In some examples, a system for error handling in artificial intelligence coding may include at least one processing unit configured to perform operations, and the operations may include the steps of process 900. In some examples, a method for error handling in artificial intelligence coding may include performing process 900. In some examples, a non-transitory computer readable medium may store computer implementable instructions that when executed by at least one processor may cause the at least one processor to perform operations for error handling in artificial intelligence coding, and the operations may include the steps of process 900.

In some examples, step 906 may comprise using an artificial intelligence model (such as the artificial intelligence model accessed by step 402, a different artificial intelligence model, etc.) to analyze an input in a natural language (such as the input received by step 706, a different input in a natural language, etc.) to generate a source code.

In some examples, step 908 may comprise determining a plurality of different potential run-time errors associated with a source code (such as the source code generated by step 906, a different source code, and so forth). In some examples, step 908 may receive from an individual (for example, an individual that provided the input in the natural language is received from an individual, a different individual, etc.) an indication of at least one potential run-time error, and may include the at least one potential run-time error in the plurality of different potential run-time errors. For example, the individual may provide a natural language indication of the at least one potential run-time error (such as, ‘the input received from the browser may be in unsupported format’, ‘the server we're connecting may be non-responsive’, and so forth). In another example, the individual may provide the indication of the at least one potential run-time error via a code editor, a code viewer, or an IDE, for example by pointing or marking a section of the source code associated with the at least one potential run-time error. In some examples, step 908 may comprise analyzing the input in the natural language received by step 706 (or another input in a natural language analyzed to generate the source code) to determine the plurality of different potential run-time errors. For example, the input in the natural language may include ‘obtain the salaries data from the server and calculate an average salary for each month’, and based on the input, the plurality of different potential run-time errors may include dividing by zero (for example, in an event of a month with no salaries), a communication error with server, and/or receiving corrupted data from the server. In some examples, step 908 may comprise analyzing a source code (such as the source code generated by step 906, a different source code, etc.) to determine the plurality of different potential run-time errors. For example, the source code may include instructions for receiving an array of numbers and calculating an average of the array, and based on the source code, the plurality of different potential run-time errors may include dividing by zero (for example, in an event of an empty array). In some examples, step 908 may comprise analyzing the input in the natural language and the source code to determine the plurality of different potential run-time errors. In some examples, step 908 may use an artificial intelligence model (such as the artificial intelligence model accessed by step 402, a different artificial intelligence model, etc.) to determine the plurality of different potential run-time errors, for example by analyzing the input in the natural language and/or the source code and/or additional information. In some examples, step 908 may use an artificial neural network to determine the plurality of different potential run-time errors, for example by analyzing the input in the natural language and/or the source code and/or additional information. In some examples, step 908 may use a machine learning model to determine the plurality of different potential run-time errors, for example by analyzing the input in the natural language and/or the source code and/or additional information. The machine learning model may be a machine learning model trained using training examples to determine potential run-time errors from available information. An example of such training examples may include sample input in a natural language and/or sample source code and/or sample additional information, together with a label indicative of one or more potential run-time errors. In some examples, step 908 may comprise: identifying a first mathematical object in a particular mathematical space, the first mathematical object corresponds to at least one word included in the input, for example using module 302; identifying a second mathematical object in the particular mathematical space based on at least part of the generated source code, for example using module 302; calculating a function of the first and second mathematical objects to obtain a third mathematical object in the particular mathematical space, for example using module 304; and including a particular potential run-time error in the plurality of different potential run-time errors based on the third mathematical object. For example, when the third mathematical object is in a first region of the particular mathematical space, step 908 may include the particular potential run-time error in the plurality of different potential run-time errors, and/or when the third mathematical object is in a second region of the particular mathematical space, step 908 may exclude the particular potential run-time error from the plurality of different potential run-time errors. In some examples, the determining the plurality of different potential run-time errors by step 908 may be performed by the artificial intelligence model in step 910 while generating the source code. In some examples, the determining the plurality of different potential run-time errors by step 908 may be performed, at least in part, while the source code is being generated by step 910. In some examples, the determining the plurality of different potential run-time errors by step 908 may be performed after the generation of the source code by step 910 is completed.

In some examples, step 910 may comprise, for each potential run-time error of a plurality of different potential run-time errors associated with a source code (such as the plurality of different potential run-time errors determined by step 908, a plurality of different potential run-time errors associated with the source code generated by step 906, a plurality of different potential run-time errors associated with a different source code, etc.), adding respective error handling instructions to the source code. In some examples, step 910 may generate the error handling instructions associated with a particular potential run-time error of the plurality of different potential run-time errors. In some examples, step 910 may analyze the input in the natural language received by step 706 to generate the error handling instructions associated with a particular potential run-time error of the plurality of different potential run-time errors. For example, the input may be indicative of a reliability of an input (for example, ‘the string passed to the function is generated beforehand by the source code and is guaranteed to be in the required format’ or ‘the string passed to the function is received from a user and is not checked’), and step 910 may generate the error handling instructions associated with the particular potential run-time error based on the indicated reliability (for example, determine whether to include format validation based on the input). In another example, the input may be indicative of error codes that may be received from an external function used by the source code and their meaning, and the error handling instructions associated with the particular potential run-time error may include instructions handling the different error codes based on their meaning. In some examples, step 910 may analyze the source code to generate the error handling instructions associated with a particular potential run-time error of the plurality of different potential run-time errors. For example, the source code may include a specific function that performs a functionality useful for error handling, and the generated error handling instructions may include a call to the specific function. In some examples, step 910 may base the generation of the error handling instructions associated with a particular potential run-time error of the plurality of different potential run-time errors are generated on at least one coding guideline, for example as described above in relation to step 608 and/or step 614. In some examples, step 910 may use an artificial intelligence model (such as the artificial intelligence model accessed by step 402, a different artificial intelligence model, etc.) to generate the error handling instructions associated with a particular potential run-time error of the plurality of different potential run-time errors, for example by analyzing characteristics of the particular potential run-time error and/or the input in the natural language received by step 706 and/or the source code and/or at least one coding guideline and/or additional information. In some examples, step 910 may use an artificial neural network to generate the error handling instructions associated with a particular potential run-time error of the plurality of different potential run-time errors, for example by analyzing characteristics of the particular potential run-time error and/or the input in the natural language received by step 706 and/or the source code and/or at least one coding guideline and/or additional information. In some examples, step 910 may use a machine learning model to generate the error handling instructions associated with a particular potential run-time error of the plurality of different potential run-time errors, for example by analyzing characteristics of the particular potential run-time error and/or the input in the natural language received by step 706 and/or the source code and/or at least one coding guideline and/or additional information. The machine learning model may be a machine learning model trained using training examples to generate error handling instructions based on available information. An example of such training example may include sample characteristics of sample potential run-time error and/or sample natural language input and/or sample source code and/or sample coding guideline and/or sample additional information, together with sample error handling instructions for the sample potential run-time error. In some examples, step 910 may comprise: identifying a first mathematical object in a particular mathematical space, the first mathematical object corresponds to at least one word included in the input, for example using module 302; identifying a second mathematical object in the particular mathematical space based on at least part of the generated source code, for example using module 302; calculating a function of the first and second mathematical objects to obtain a third mathematical object in the particular mathematical space, for example using module 304; and determining at least part of the error handling instructions associated with a particular potential run-time error of the plurality of different potential run-time errors based on the third mathematical object. In some examples, step 910 may comprise requesting from an individual (such as the individual that provided the input in the natural language received by step 706, a different individual, etc.) guidance associated with a particular potential run-time error of the plurality of different potential run-time errors (for example, via a user interface, as described above in relation to step 808, etc.); receiving the requested guidance from the individual (for example, via a user interface, via natural language, as described above in relation to step 810, etc.); and basing the error handling instructions associated with the particular potential run-time error on the received guidance (for example, as described above in relation to step 812). In some examples, the error handling instructions associated with a particular potential run-time error of the plurality of different potential run-time errors added by step 910 may include at least one of an implementation of a retry mechanism, or an implementation of a circuit breaker pattern. In some examples, the error handling instructions associated with a particular potential run-time error of the plurality of different potential run-time errors added by step 910 may be configured to perform, when the particular potential run-time error occurs, at least one of logging an indication that the particular potential run-time error occurred, providing an indication that the particular potential run-time error occurred to a different portion of the source code, handing a received indication of that the particular potential run-time error occurred, or executing an alternative functionality.

In some examples, process 900 may further comprise accessing a preliminary version of the source code of step 906 and/or step 908 and/or step 910, for example, before the input in the natural language is received by step 706 and/or before the source code is generated by step 906, for example as described above in relation to step 504. Further, step 906 may base the generation of the source code on the preliminary version of the source code. For example, step 906 may use the artificial intelligence model to analyze the input in the natural language to modify the preliminary version of the source code, for example as described above in relation to step 712, by adding instructions to the preliminary version of the source code, by removing instructions from the preliminary version of the source code, by modifying instructions of the preliminary version of the source code, and so forth. In some examples, the error handling instructions associated with a particular potential run-time error of the plurality of different potential run-time errors (i.e., added to the source code by step 910 for the particular potential run-time error) may be based on an analysis of the preliminary version of the source code. In one example, step 910 may analyze the preliminary version of the source code to determine at least one coding guideline (for example, as described above in relation to step 604), and may generate the error handling instructions associated with the particular potential run-time error based on the determined at least one coding guideline (for example, as described above in relation to step 608). In yet another example, step 900 may analyze the preliminary version of the source code to identify in the preliminary version of the source code a solution to a problem, wherein the solution to the problem is associated with a particular approach for handling errors (for example, as described above in relation to step 710), and may generate the error handling instructions associated with the particular potential run-time error based on the particular approach for handling errors (for example, as described above in relation to step 712). In some examples, the error handling instructions associated with the particular potential run-time error may be further based on an analysis of the preliminary version of the source code. For example, the error handling instructions may include a call to a function or usage of a library included in the preliminary version of the source code, may solve a problem using the particular approach for solving problems used in the preliminary version of the source code, may adhere to the at least one coding guideline determined by analyzing the preliminary version of the source code, and so forth.

In some examples, process 900 may further comprise at least one of presenting the source code generated by process 900 to an individual, committing the source code generated by process 900 to a VCS, or executing the source code generated by process 900. In one example, process 900 may further comprise presenting the source code generated by process 900 to an individual. For example, the generated source code may be presented to the individual visually, textually, graphically, audibly, in a user interface, in a code viewer, and so forth. In one example, the generated source code may be presented to the individual in a form that enables the individual to modify the source code, for example, in an IDE, in a code editor, and so forth. In one example, process 900 may further comprise committing the source code generated by process 900 to a VCS. In one example, process 900 may further comprise executing the source code generated by process 900, for example using at least one processing unit.

In some examples, process 900 may use an artificial intelligence model (such as the artificial intelligence model accessed by step 402, a different artificial intelligence model, etc.) to generate one or more testing procedures for a source code (such as the source code of step 906 and/or step 910, a different source code, etc.) based on the plurality of different potential run-time errors determined by step 908. For example, the one or more testing procedures for a source code may be generated before the source code exists, before the source code is generated, when the source code already exists, after the source code is generated, and so forth. In one example, process 900 may execute the generated one or more testing procedures to test the source code. In another example, process 900 may provide the one or more test procedures. For example, the one or more test procedures may be provided digitally, visually, textually, graphically, audibly, via a user interface, in an IDE, in a code editor, in a VCS, to an individual, to a different process, to a different computing device, and so forth. In one example, the generated one or more testing procedures may test the error handling associated with a particular potential run-time error of the plurality of different potential run-time errors.

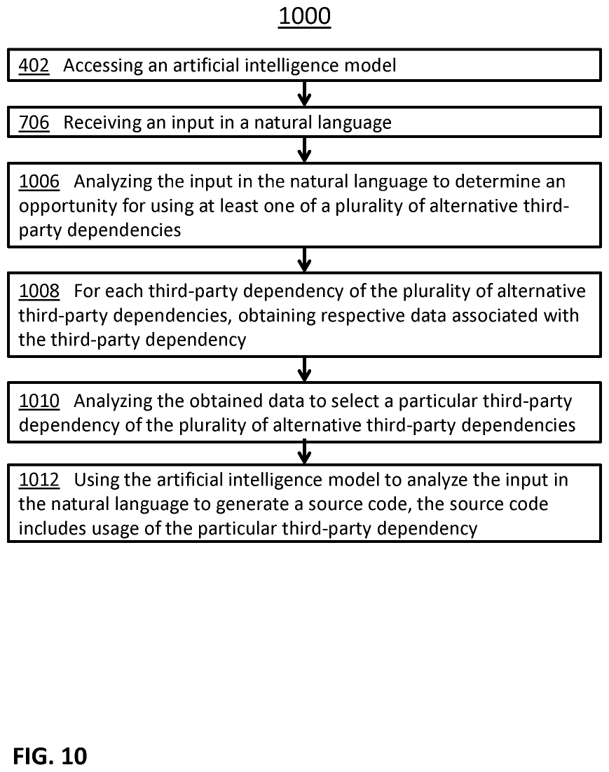

FIG. 10 is a flowchart of an example process 1000 for using third-party dependencies in artificial intelligence coding, consistent with some embodiments of the present disclosure. In this example, process 900 may comprise: accessing an artificial intelligence model (step 402); receiving an input in a natural language (step 706); analyzing the input in the natural language to determine an opportunity for using at least one of a plurality of alternative third-party dependencies (step 1006); for each third-party dependency of the plurality of alternative third-party dependencies, obtaining respective data associated with the third-party dependency (step 1008); analyzing the obtained data to select a particular third-party dependency of the plurality of alternative third-party dependencies (step 1010); and using the artificial intelligence model to analyze the input in the natural language to generate a source code, the source code includes usage of the particular third-party dependency (step 1012). In other examples, process 1000 may include additional steps or fewer steps. In other examples, one or more steps of process 1000 may be executed in a different order and/or one or more groups of steps may be executed simultaneously.

In some examples, a system for using third-party dependencies in artificial intelligence coding may include at least one processing unit configured to perform operations, and the operations may include the steps of process 1000. In some examples, a method for using third-party dependencies in artificial intelligence coding may include performing process 1000. In some examples, a non-transitory computer readable medium may store computer implementable instructions that when executed by at least one processor may cause the at least one processor to perform operations for using third-party dependencies in artificial intelligence coding, and the operations may include the steps of process 1000.

In some examples, step 1006 may comprise analyzing an input in a natural language (such as the input in the natural language received by step 706, a different input in a natural language, etc.) and/or additional information to determine an opportunity for using at least one of a plurality of alternative third-party dependencies. For example, step 1006 may use an artificial intelligence model (such as the artificial intelligence model accessed by step 402, a different artificial intelligence model, etc.) to analyze the input in the natural language to determine the opportunity for using the at least one of a plurality of alternative third-party dependencies. In another example, step 1006 may use an artificial neural network to analyze the input in the natural language and/or additional information to determine the opportunity for using the at least one of a plurality of alternative third-party dependencies. In yet another example, step 1006 may use a machine learning model to analyze the input in the natural language and/or additional information to determine the opportunity for using the at least one of a plurality of alternative third-party dependencies. The machine learning model may be a machine learning model trained using training examples to determine opportunities for using third-party dependencies and/or corresponding third-party dependencies based on natural language inputs and/or additional information. An example of a training example may include a sample natural language input and/or sample additional information, together with a label indicative of whether an opportunity for using third-party dependencies exists and/or third-party dependencies corresponding to the opportunity. In an additional example, step 1006 may use an NLP algorithm to analyze the input in the natural language to determine the opportunity for using the at least one of a plurality of alternative third-party dependencies. In another example, step 1006 may comprise: identifying a first mathematical object in a particular mathematical space, the first mathematical object corresponds to a first at least one word included in the input, for example using module 302; identifying a second mathematical object in the particular mathematical space, the second mathematical object corresponds to a second at least one word included in the input, for example using module 302; calculating a function of the first and second mathematical objects to obtain a third mathematical object in the particular mathematical space, for example using module 304; and determining the opportunity for using the at least one of a plurality of alternative third-party dependencies based on the third mathematical object.

In some examples, step 1006 may comprise: analyzing the input in the natural language to determine a need to solve a problem, for example using step 708; and determining the opportunity for using the at least one of a plurality of alternative third-party dependencies based on the determined need to solve the problem. For example, the input may include ‘analyze the salaries from last month using t-test to compare male vs female salaries’, the opportunity rise from the need to calculate t-test, and the plurality of alternative third-party dependencies may include ‘Boost.Math’ and ‘ALGLIB’ libraries. In another example, the input may include ‘analyze the expenses from the last three years to predict the expenses in the coming year’, and the opportunity may include using a third-party inference model that predicts future expenses from historic expenses. In one example, the problem may include at least one of performing a calculation, executing an algorithm, or performing an action, and each third-party dependency of the plurality of alternative third-party dependencies may be or include at least one of a respective software library, respective online service, or respective external software. In another example, the problem may include inferring first information from second information, and each third-party dependency of the plurality of alternative third-party dependencies may be or include a respective inference model.

In some examples, step 1006 may comprise: analyzing the input in the natural language to determine a need for information with specific characteristics (for example, using an NLP algorithm, using a LLM with a suitable prompt, such as ‘to implement the required code, is there a need for information, and what are the characteristics of such information’, etc.); and determining the opportunity for using the at least one of a plurality of alternative third-party dependencies based on the determined need for the information with the specific characteristics. In one example, the information with the specific characteristics may be a dataset with particular characteristics. In another example, the information with the specific characteristics may be configuration data with particular characteristics. In yet another example, the information with the specific characteristics may be geospatial information with particular characteristics. In one example, the input may include ‘the software should present a graph of month by month Earth global surface temperature over the last forty years’, and the opportunity may include using third-party global surface temperature dataset with a sufficient level of details (i.e., at least month by month resolution) and sufficient range (i.e., including at least the last forty years). In another example, the input may include ‘the software should capture data using the sensor’, and the opportunity may include using a third-party configuration file for the sensor.

In some examples, step 1008 may comprise, for each third-party dependency of a plurality of alternative third-party dependencies (such as the plurality of alternative third-party dependencies of step 1006, a different plurality of alternative third-party dependencies, etc.), obtaining respective data associated with the third-party dependency. For example, step 1008 may read the data associated with a particular third-party dependency from memory (for example, from a digital memory, from memory unit 210, etc.), may receive the data associated with a particular third-party dependency from an external computing device (for example, using a digital communication device, such as communication module 230), may receive the data associated with a particular third-party dependency from an individual (for example, via a user interface), may receive the data associated with a particular third-party dependency from a database, and so forth. In one example, step 1008 may access a data-structure associating third-party dependencies with data based on a particular third-party dependency to obtain the data associated with the particular third-party dependency. In another example, step 1008 may use a dependency management tool to obtain the data associated with at least one specific third-party dependency of the plurality of alternative third-party dependencies. In yet another example, step 1008 may analyze at least one webpage to obtain the data associated with at least one specific third-party dependency of the plurality of alternative third-party dependencies. In an additional example, step 1008 may use an API of a service for providing data associated with third-party dependencies to obtain the data associated with at least one specific third-party dependency of the plurality of alternative third-party dependencies. In one example, for each third-party dependency of the plurality of alternative third-party dependencies, the respective data associated with the third-party dependency obtained by step 1008 may include at least one of a respective popularity level, respective community support level, respective maintenance status, respective security history, or respective license associated with the third-party dependency (for example, when the third-party dependencies are software libraries, online services, or external software). In another example, for each third-party dependency of the plurality of alternative third-party dependencies, the respective data associated with the third-party dependency obtained by step 1008 may include at least one of a respective sample size, respective fields, respective bias, respective level of details, or respective accuracy associated with the third-party dependency (for example, when the third-party dependency are datasets). In yet another example, for each third-party dependency of the plurality of alternative third-party dependencies, the respective data associated with the third-party dependency obtained by step 1008 may include a respective cost associated with the third-party dependency. Some non-limiting examples of such cost may include one-time purchasing cost, recurring licensing cost, increased resources usage, and so forth.

In some examples, step 1010 may comprise analyzing data associated with a plurality of alternative third-party dependencies (such as the data obtained by step 1008, different data associated with the plurality of alternative third-party dependencies of step 1006 and/or step 1008, different data associated with a different plurality of alternative third-party dependencies, etc.) and/or additional information to select a particular third-party dependency of the plurality of alternative third-party dependencies. In some examples, step 1010 may further base the selection of the particular third-party dependency is further based on an analysis of an input in a natural language (such as the input in the natural language received by step 706, a different input in a natural language, and so forth). For example, the input may include ‘I love supporting new libraries that are still not very popular’, the data associated with each alternative third-party dependency may include year of creation and popularity level, and step 1010 may select a third-party dependency that is both new and unpopular of the plurality of alternative third-party dependencies. In another example, the input may include ‘I want to get results quickly, so don't use large datasets’, the data associated with each alternative third-party dependency may include sample size, and step 1010 may select a third-party dependency that has a small sample size of the plurality of alternative third-party dependencies. In some examples, step 1010 may further base the selection of the particular third-party dependency is further based on at least one coding guideline. In one example, the at least one coding guideline may be obtained as descried above, for example in relation to step 604. In one example, the at least one coding guideline may include a guideline to avoid usage of third-party dependencies associated with selected licenses (or to limit usage of third-party dependencies to ones associated with selected licenses, and step 1010 may select a third-party dependency based on the guideline and on associations of the a third-party dependencies with licenses. In another example, the at least one coding guideline may include a guideline to avoid with known security vulnerabilities, and step 1010 may select a third-party dependency based on the guideline and on known security vulnerabilities associated with the different third-party dependencies. In some examples, step 1010 may use an optimization algorithm (for example, a constraint optimization algorithm when the goal is to avoid third-party dependencies with selected characteristics, an unconstraint optimization algorithm, etc.) to select the particular third-party dependency of the plurality of alternative third-party dependencies based on the data associated with plurality of alternative third-party dependencies. For example, one or more constraints for the optimization algorithm may be determined based on a desire to avoid third-party dependencies with selected characteristics (for example, a desire indicated in the input, in a coding guideline, and so forth). In another example, an objective function for the optimization algorithm may be determined based on a desire to use a third-party dependency that excel in a selected aspect (for example, a desire indicated in the input, in a coding guideline, and so forth). In one example, step 1010 may use an artificial intelligence model (such as the artificial intelligence model received by step 402, a different artificial intelligence model, etc.) to analyze the obtained data and/or the input in the natural language and/or the at least one coding guideline and/or additional information to select the particular third-party dependency of the plurality of alternative third-party dependencies. In another example, step 1010 may use an artificial neural network to analyze the obtained data and/or the input in the natural language and/or the at least one coding guideline and/or additional information to select the particular third-party dependency of the plurality of alternative third-party dependencies. In yet another example, step 1010 may use a machine learning model and/or the input in the natural language and/or the at least one coding guideline and/or additional information to analyze the obtained data to select the particular third-party dependency of the plurality of alternative third-party dependencies. The machine learning model may be a machine learning model trained using training example to select a third-party dependency of alternative third-party dependencies. An example of such training example may include a sample plurality of alternative third-party dependencies and/or sample natural language input and/or sample coding guidelines and/or additional information, together with a label indicative of a desire selection of a third-party dependency of the sample plurality. In some examples, step 1010 may comprise: identifying a first mathematical object in a particular mathematical space, the first mathematical object corresponds to at least one word included in the input, for example using module 302; identifying a second mathematical object in the particular mathematical space based on at least part of the obtained data, for example using module 302; calculating a function of the first and second mathematical objects to obtain a third mathematical object in the particular mathematical space, for example using module 304; and basing the selection of the particular third-party dependency of the plurality of alternative third-party dependencies on the third mathematical object.

In some examples, each third-party dependency of the plurality of alternative third-party dependencies may be or include a respective at least one software library. In this example, the selection of the particular third-party dependency by step 1010 may be based on popularity levels associated with the plurality of alternative third-party dependencies, may be based on community support levels associated with the plurality of alternative third-party dependencies, may be based on maintenance statuses associated with the plurality of alternative third-party dependencies, may be based on security histories associated with the plurality of alternative third-party dependencies, may be based on licenses associated with the plurality of alternative third-party dependencies, may be based on costs associated with the plurality of alternative third-party dependencies, and so forth. In some examples, each third-party dependency of the plurality of alternative third-party dependencies may be or include a respective online service. In this example, the selection of the particular third-party dependency by step 1010 may be based on popularity levels associated with the plurality of alternative third-party dependencies, may be based on support levels associated with the plurality of alternative third-party dependencies, may be based on security histories associated with the plurality of alternative third-party dependencies, may be based on licenses associated with the plurality of alternative third-party dependencies, may be based on costs associated with the plurality of alternative third-party dependencies, and so forth. In some examples, each third-party dependency of the plurality of alternative third-party dependencies may be or include a respective external software. In this example, the selection of the particular third-party dependency by step 1010 may be based on popularity levels associated with the plurality of alternative third-party dependencies, may be based on support levels associated with the plurality of alternative third-party dependencies, may be based on security histories associated with the plurality of alternative third-party dependencies, may be based on licenses associated with the plurality of alternative third-party dependencies, may be based on costs associated with the plurality of alternative third-party dependencies, and so forth. In some examples, each third-party dependency of the plurality of alternative third-party dependencies may be or include a respective inference model. In this example, the selection of the particular third-party dependency by step 1010 may be based on accuracies associated with the plurality of alternative third-party dependencies, may be based on biases associated with the plurality of alternative third-party dependencies, may be based on costs associated with the plurality of alternative third-party dependencies, and so forth. In some examples, each third-party dependency of the plurality of alternative third-party dependencies may be or include a respective data source. Some non-limiting examples of such data source may include dataset, geospatial data, configuration data, and so forth. In this example, the selection of the particular third-party dependency by step 1010 may be based on data quality levels associated with the plurality of alternative third-party dependencies, may be based on samples sizes associated with the plurality of alternative third-party dependencies, may be based on fields associated with the plurality of alternative third-party dependencies, may be based on biases associated with the plurality of alternative third-party dependencies, may be based on level of details associated with the plurality of alternative third-party dependencies, may be based on costs associated with the plurality of alternative third-party dependencies, and so forth.

In some examples, step 1012 may comprise using an artificial intelligence model (such as the artificial intelligence model received by step 402, a different artificial intelligence model, etc.) to analyze an input in a natural language (such as the input in the natural language received by step 706, a different input in a natural language, etc.) to generate a source code. The generated source code may include usage of a third-party dependency (such as the particular third-party dependency selected by step 1010, a different third-party dependency, and so forth). For example, the generated may include instructions for using the third-party dependency, such as instructions for calling functions included in a third-party library, instructions for configuring components based on third-party configuration data, instructions for accessing and analyzing third-party dataset, and so forth. In some examples, step 1012 may further comprise, before generating the source code, requesting approval for using the particular third-party dependency from an individual (for example, via a user interface, in a natural language, visually, textually, graphically, audibly, and so forth). In one example, the input in the natural language may be received from the individual. In another example, the input in the natural language may be received from a different individual or from an automated source.

In some examples, process 1000 may further comprise accessing a preliminary version of the source code of step 1012, for example, before the input in the natural language is received by step 706 and/or before the source code is generated by step 1012, for example as described above in relation to step 504. Further, process 1000 may further comprise analyzing the preliminary version of the source code to identify one or more third-party dependencies used in the preliminary version of the source code, for example using a complier or a code parser. In some examples, step 1010 may further base the selection of the particular third-party dependency on the identified one or more third-party dependencies. For example, step 1010 may prefer third-party dependencies that are used by the preliminary version (i.e., included in the identified one or more third-party dependencies) over ones that are not. In another example, step 1010 may avoid third-party dependencies that conflict with third-party dependencies that are used by the preliminary version. In some examples, step 1012 may base the generation of the source code on the preliminary version of the source code. For example, step 1012 may use the artificial intelligence model to analyze the input in the natural language to modify the preliminary version of the source code, for example as described above in relation to step 712, by adding instructions to the preliminary version of the source code (for example, by adding instruction that uses the particular third-party dependency), by removing instructions from the preliminary version of the source code, by modifying instructions of the preliminary version of the source code (for example, modifying the instructions to use the particular third-party dependency), and so forth.

In some examples, process 1000 may further comprise at least one of presenting the source code generated by step 1012 to an individual, committing the source code generated by step 1012 to a VCS, or executing the source code generated by step 1012. In one example, process 1000 may further comprise presenting the source code generated by step 1012 to an individual. For example, the generated source code may be presented to the individual visually, textually, graphically, audibly, in a user interface, in a code viewer, and so forth. In one example, the generated source code may be presented to the individual in a form that enables the individual to modify the source code, for example, in an IDE, in a code editor, and so forth. In one example, process 1000 may further comprise committing the source code generated by step 1012 to a VCS. In one example, process 1000 may further comprise executing the source code generated by step 1012, for example using at least one processing unit. In some examples, process 1000 may further comprise using a dependency management tool to obtain the particular third-party dependency.

In some examples, process 1000 may further comprise updating documentation associated with the source code generated by step 1012 to reflect the usage of a third-party dependency (such as the particular third-party dependency selected by step 1010, a different third-party dependency used by the source code, and so forth). In one example, the documentation may be separated from the source code, for example in a separate documentation file, in a VCS, and so forth. In another example, the documentation may be included in the source code, for example as one or more remarks in the source code. In one example, the documentation may include an indication of a reason for selecting the particular third-party dependency. In another example, the documentation may include an indication of the opportunity determined by step 1006. In one example, the documentation associated with the source code may be in a natural language (such as the input in the natural language received by step 706, a different input in a natural language, etc.), may be in a formal language, may be graphical, and so forth.

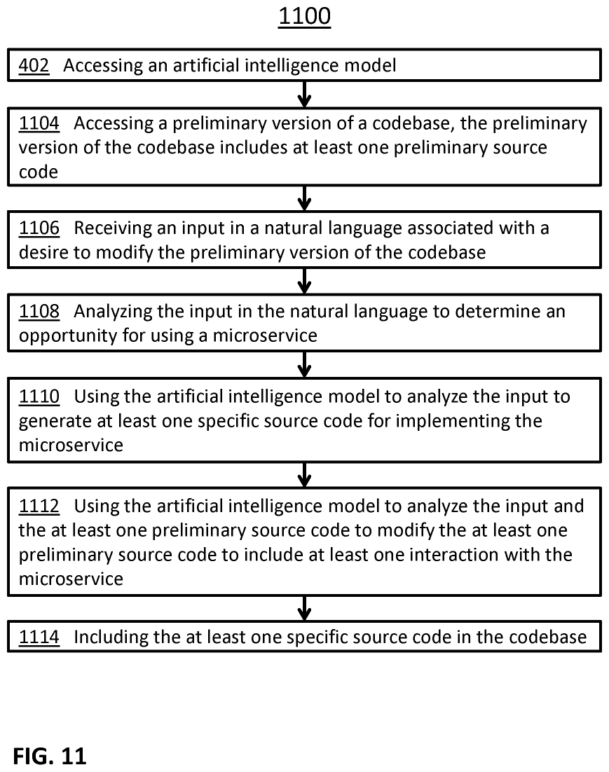

FIG. 11 is a flowchart of an example process 1100 for using microservices in artificial intelligence coding, consistent with some embodiments of the present disclosure. In this example, process 1100 may comprise: accessing an artificial intelligence model (step 402); accessing a preliminary version of a codebase, the preliminary version of the codebase includes at least one preliminary source code (step 1104); receiving an input in a natural language associated with a desire to modify the preliminary version of the codebase (step 1106); analyzing the input in the natural language to determine an opportunity for using a microservice (step 1108); using the artificial intelligence model to analyze the input to generate at least one specific source code for implementing the microservice (step 1110); and obtaining an updated version of the codebase by: using the artificial intelligence model to analyze the input and the at least one preliminary source code to modify the at least one preliminary source code to include at least one interaction with the microservice (step 1112); and including the at least one specific source code in the codebase (step 1114). In other examples, process 1100 may include additional steps or fewer steps. In other examples, one or more steps of process 1100 may be executed in a different order and/or one or more groups of steps may be executed simultaneously.

In some examples, a system for using microservices in artificial intelligence coding may include at least one processing unit configured to perform operations, and the operations may include the steps of process 1100. In some examples, a method for using microservices in artificial intelligence coding may include performing process 1100. In some examples, a non-transitory computer readable medium may store computer implementable instructions that when executed by at least one processor may cause the at least one processor to perform operations for using microservices in artificial intelligence coding, and the operations may include the steps of process 1100.

In some examples, the input in the natural language received by step 1106 may be an input received from an individual. In one example, the desire to modify the preliminary version of the codebase may be a desire of the individual. In one example, process 1100 may further comprise, for example before generating the at least one specific source code by step 1110 and/or before modifying the at least one preliminary source code by step 1112, requesting approval for using the microservice from the individual (for example, via a user interface, in a natural language, visually, textually, graphically, audibly, and so forth) and/or receiving the approval for using the microservice from the individual (for example, via a user interface, via a natural language, via voice commands, via gestures, and so forth). In some examples, the microservice of process 1100 and/or step 1108 and/or step 1110 and/or step 1112 may be a microservice deployed in a cloud platform.

In some examples, step 1104 may comprise accessing a preliminary version of a codebase. The preliminary version of the codebase may include at least one preliminary source code and/or additional components, such as additional preliminary source code(s), preliminary configuration data, preliminary dataset(s), preliminary data files, and so forth. For example, step 1104 may retrieve at least part of the preliminary version of the codebase from a VCS, may read at least part of the preliminary version of the codebase from a memory (for example, from a digital memory, from memory unit 210, etc.), may access at least part of the preliminary version of the codebase via an external computing device (for example, using a digital communication device), may generate at least part of the preliminary version of the codebase (for example, using a generative artificial intelligence model, in response to a prompt, based on a sketch, by altering a different version of the source code, by generating the at least part of the source code from scratch, using the steps and/or processes described herein, using other processes, etc.), may receive at least part of the preliminary version of the codebase from an individual (for example, via a user interface, via an IDE, via a what-you-see-is-what-you-get application that creates source code from graphical design, via an input device, via a keyboard, via voice recognition, etc.), and so forth.

In some examples, step 1108 may comprise analyzing an input in a natural language (such as the input in the natural language received by step 1106, a different input in a natural language, etc.) and/or additional information to determine an opportunity for using a microservice. For example, step 1108 may use an artificial intelligence model (such as the artificial intelligence model received by step 402, a different artificial intelligence model, etc.) to analyze the input in the natural language and/or additional information to determine the opportunity for using the microservice. In another example, step 1108 may use an artificial neural network to analyze the input in the natural language and/or additional information to determine the opportunity for using the microservice. In yet another example, step 1108 may use a machine learning model to analyze the input in the natural language and/or additional information to determine the opportunity for using the microservice. The machine learning model is a machine learning model trained using training examples to determine opportunities for using microservices based on natural language inputs and/or additional information. An example of a training example may include a sample natural language input and/or sample additional information, together with a label indicative of whether an opportunity for using microservices exists. In an additional example, step 1108 may use an NLP algorithm to analyze the input in the natural language and/or additional information to determine the opportunity for using the microservice. In another example, step 1108 may comprise: identifying a first mathematical object in a particular mathematical space, the first mathematical object corresponds to a first at least one word included in the input, for example using module 302; identifying a second mathematical object in the particular mathematical space based on at least one instruction included in the preliminary version of the codebase accessed by step 1104, for example using module 302; calculating a function of the first and second mathematical objects to obtain a third mathematical object in the particular mathematical space, for example using module 304; and determining the opportunity for using the microservice based on the third mathematical object. In one example, step 1108 may comprise analyzing the input in the natural language and the preliminary version of the codebase accessed by step 1104 to determine the opportunity for using the microservice. For example, when the analysis of the preliminary version of the codebase may indicate that a particular module of the codebase is associated with a specific category of events, and when the input is indicative of scalability problem associated with the specific category of events, step 1108 may determine the opportunity for using a microservice for handling the specific category of events. In one example, step 1108 may comprise analyzing the input in the natural language and at least one coding guideline to determine the opportunity for using the microservice. In one example, the at least one coding guideline may be obtained as descried above, for example in relation to step 604. In one example, the at least one coding guideline may include a guideline specifying when and when not to use microservices, and step 1108 may determine the opportunity for using a microservice when the input corresponds to a case in the guideline the guideline specifies as a case for using microservices. In some examples, step 1108 may comprise: analyzing the input in the natural language to determine a need to solve a problem, for example using step 708; and determining the opportunity for using the microservice based on the determined need to solve the problem. For example, the input may include ‘the payment workflow is slow and needs to be scaled’, the problem is that the payment workflow is slow, and the opportunity for using a microservice includes extracting an order processing component into an independent microservice. In another example, the input may include the following description of the problem, ‘order tracking updates are not loaded quickly and reliably during peak shopping times’, and the opportunity for using a microservice includes extracting an order data retrieval component into an independent microservice. In some examples, step 1108 may determine the opportunity for using the microservice based on a need to scale a part of a system associated with the codebase. In one example, the at least one specific source code generated by step 1110 may correspond to the part of the system. For example, the determined need to solve a problem discussed above may include the need to scale a part of the system, for example as described above. In some examples, step 1108 may determine the opportunity for using the microservice based on an advantage for using at least one of a different programming language, a different software framework or a different run-time environment for a part of a system associated with the codebase. In one example, the at least one specific source code generated by step 1110 may correspond to the part of the system. For example, the input may be indicative of a need to use an inference model, the most natural programming language for using the inference model may be Python (for example, an implementation of the inference model may be readily available in Python, a tool required to implementing the inference model may be readily available in Python, etc.), other parts of the codebase may use a different programming language or framework (such as Node.js), and the opportunity for using the microservice may be based on the advantage for using Python rather than Node.js for the usage of the inference model. In some examples, step 1108 may determine the opportunity for using the microservice based on an advantage of increased reliability from isolating a part of a system associated with the codebase. In one example, the at least one specific source code generated by step 1110 may correspond to the part of the system. For example, using an external module for logging information may be faulty and may lower the overall reliability of the system, and the opportunity for using the microservice may be based on the advantage of isolating the usage of the external module to increase the reliability of other parts of the system.

In some examples, step 1110 may comprise using an artificial intelligence model (such as the artificial intelligence model received by step 402, a different artificial intelligence model, etc.) to analyze an input in a natural language (such as the input in the natural language received by step 1106, a different input in a natural language, etc.) to generate at least one specific source code, for example for implementing a microservice (such as the microservice of step 1108 and/or step 1112, a different microservice, and so forth). In some examples, the at least one specific source code generated by step 1110 may include instructions for interaction with a service discovery mechanism. For example, the instructions may implement interaction with the service discovery mechanism to use required services (for example, to select an available service instance associated with a required service), to register as a service instance (for example, upon startup, with a network location associated with an instance of the microservice, etc.), to remove a service instance (for example, upon shutdown), to perform health check for an instance of the microservice, and so forth. In some examples, step 1110 may base the generation of the at least one specific source code for implementing the microservice on at least one coding guideline, for example as described above in relation to step 608. In some examples, the at least one specific source code generated by step 1110 may include instructions for at least one interaction with at least one other part of the codebase. In one example, the at least one interaction with the at least one other part of the codebase may include a communication with the at least one other part of the codebase through a memory accessible by the at least one other part of the codebase (for example, through a database, through a data-structure, through an area of a digital memory, and so forth). In another example, the at least one interaction with the at least one other part of the codebase may include an interaction via an API (for example, using synchronous API calls, using asynchronous API calls, and so forth). In yet another example, the at least one interaction with the at least one other part of the codebase may include an interaction via a communication network (for example, using a. using a digital communication device, and so forth). In an additional example, the at least one interaction with the at least one other part of the codebase may include at least one of publishing an event or reacting to an event.

In some examples, step 1110 may analyze the preliminary version of the codebase to identify in the preliminary version of the codebase accessed by step 1104 at least one other microservice associated with at least one characteristic, for example using a complier or a code parser. Further, step 1110 may base the generation of the at least one specific source code for implementing the microservice on the at least one characteristic. For example, the implemented microservice may have the at least one characteristic, may have other characteristics compatible with the at least one characteristic, and so forth. In one example, the at least one characteristic may include a communication style. In this example, the at least one interaction with the microservice in the at least one preliminary source code modified by step 1112 may be based on the communication style, instructions included in the at least one specific source code generated by step 1110 for at least one interaction with at least one other part of the codebase may be based on the communication style, and so forth. In one example, the at least one characteristic may include a characteristic associated with a deployment of the at least one other microservice. Some non-limiting examples of such characteristic may include a containerization characteristic, an orchestration characteristic, a cloud platform, and so forth. For example, the deployment of the microservice (of step 1108 and/or step 1110 and/or step 1112) may be based on the characteristic associated with the deployment. In one example, the at least one characteristic may include a characteristic associated with a service discovery mechanism. Some non-limiting examples of such characteristics associated with a service discovery mechanism may include usage of a specific service discovery mechanism framework or platform, metadata registered in the service discovery mechanism, and so forth. In one example, the at least one characteristic may include a characteristic associated with a logging mechanism, such as a logging framework or library, a logging policy (such as a policy regarding what and how to log), and so forth. For example, step 1110 may generate the at least one specific source code to implement logging policy identified in the at least one other microservice and/or to use the logging framework identified in the at least one other microservice. In one example, the at least one characteristic may include a characteristic associated with failure handling, for example as described above in relation to process 900 and/or step 908 and/or step 910 (for example in relation to process 900 and the preliminary version of the source code). For example, step 1110 may generate the at least one specific source code to implement similar failure handling techniques to the ones identified in the at least one other microservice. In one example, the at least one characteristic may include a characteristic associated with a programming language and/or a programming framework. For example, the preliminary version of the codebase may include microservices implemented in a specific programming language and/or a programming framework, and step 1110 may generate the at least one specific source code in the specific programming language and/or a programming framework.

In some examples, step 1112 may comprise using an artificial intelligence model (such as the artificial intelligence model received by step 402, a different artificial intelligence model, etc.) to analyze an input in a natural language (such as the input in the natural language received by step 1106, a different input in a natural language, etc.) and the at least one preliminary source code accessed by step 1104 to modify the at least one preliminary source code to include at least one interaction with a microservice (such as the microservice of step 1108 and/or step 1110, a different microservice, and so forth). In one example, step 1112 may comprise: identifying a first mathematical object in a particular mathematical space, the first mathematical object corresponds to a first at least one word included in the input, for example using module 302; identifying a second mathematical object in the particular mathematical space based on at least one instruction included in the preliminary version of the codebase accessed by step 1104; calculating a function of the first and second mathematical objects to obtain a third mathematical object in the particular mathematical space, for example using module 304; determining at least one additional instruction based on the third mathematical object; and adding the at least one additional instruction to the modified at least one preliminary source code. In one example, the at least one interaction with the microservice may include a communication with the microservice through a memory accessible by the microservice (for example, through a database accessible by the microservice, through a data-structure accessible by the microservice, through an area of a digital memory accessible by the microservice, and so forth). In another example, the at least one interaction with the microservice may include an interaction via an API (for example, using synchronous API calls, using asynchronous API calls, and so forth). In yet another example, the at least one interaction with the microservice may include an interaction via a communication network (for example, using a. using a digital communication device, and so forth). In an additional example, the microservice may be an event-driven microservice, and/or the at least one interaction with the microservice may include at least one of publishing an event or reacting to an event.

In some examples, step 1114 may comprise including the at least one specific source code generated by step 1110 in the codebase. In one example, the at least one specific source code generated by step 1110 may include at least one new additional source code (not included in the preliminary version of the codebase accessed by step 1104), and the including the at least one specific source code in the codebase by step 1114 may comprise adding the at least one new additional source code to the codebase. In another example, the at least one specific source code generated by step 1110 may include an updated version of at least one source code included in the preliminary version of the codebase accessed by step 1104, the using the artificial intelligence model to analyze the input to generate at least one specific source code by step 1110 may comprise using the artificial intelligence model to analyze the input in the natural language received by step 1106 to update the at least one source code included in the preliminary version of the codebase, and the including the at least one specific source code in the codebase by step 1114 may comprise updating the at least one source code in the codebase (for example, as part of the update of the at least one source code by step 1110, after the update of the at least one source code by step 1110, and so forth).

In some examples, process 1100 may use step 1110 and/or step 1112 and/or step 1114 to obtain an updated version of the codebase of step 1104 and/or 1106. In some examples, process 1100 may further comprise at least one of presenting the updated version of the codebase to an individual, committing the updated version of the codebase to a VCS, or executing the updated version of the codebase. In one example, process 1100 may further comprise presenting the updated version of the codebase to an individual. For example, the updated version of the codebase may be presented to the individual visually, textually, graphically, audibly, in a user interface, in a code viewer, and so forth. In one example, the updated version of the codebase may be presented to the individual in a form that enables the individual to modify the updated version of the codebase, for example, in an IDE, in a code editor, and so forth. In one example, process 1100 may further comprise committing the updated version of the codebase to a VCS. In one example, process 1100 may further comprise executing the updated version of the codebase, for example using at least one processing unit.

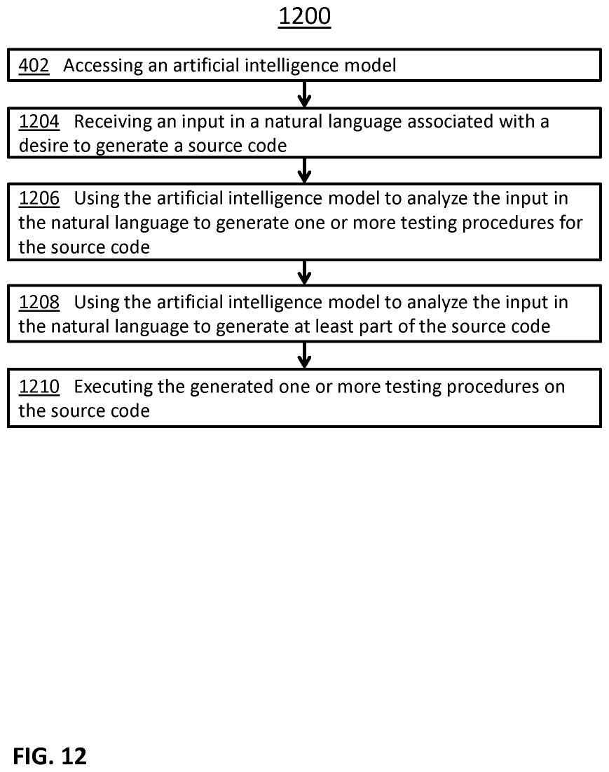

FIG. 12 is a flowchart of an example process 1200 for testing in artificial intelligence coding, consistent with some embodiments of the present disclosure. In this example, process 1200 may comprise: accessing an artificial intelligence model (step 402); receiving an input in a natural language associated with a desire to generate a source code (step 1204); using the artificial intelligence model to analyze the input in the natural language to generate one or more testing procedures for the source code (step 1206); using the artificial intelligence model to analyze the input in the natural language to generate at least part of the source code (step 1208); and executing the generated one or more testing procedures on the source code (step 1210). In other examples, process 1200 may include additional steps or fewer steps. In other examples, one or more steps of process 1200 may be executed in a different order and/or one or more groups of steps may be executed simultaneously.

In some examples, a system for testing in artificial intelligence coding may include at least one processing unit configured to perform operations, and the operations may include the steps of process 1200. In some examples, a method for testing in artificial intelligence coding may include performing process 1200. In some examples, a non-transitory computer readable medium may store computer implementable instructions that when executed by at least one processor may cause the at least one processor to perform operations for testing in artificial intelligence coding, and the operations may include the steps of process 1200.

In some examples, step 1206 may comprise using an artificial intelligence model (such as the artificial intelligence model received by step 402, a different artificial intelligence model, etc.) to analyze an input in a natural language (such as the input in the natural language received by step 1204, a different input in the natural language, a different input in a different natural language, etc.) to generate one or more testing procedures for a source code (such as the source code of step 1204 and/or step 1208 and/or step 1210, a source code generated based on the input, a source code generated based on a different input, a different source code, and so forth). In one example, step 1206 may comprise using the artificial intelligence model to analyze the input in the natural language and at least one coding guideline (such as at least one coding guideline obtained as descried above, for example in relation to step 604) to generate the one or more testing procedures for the source code. In one example, a particular testing procedure of the one or more testing procedures generated by step 1206 may include a test for verifying adherence to the at least one coding guideline. For example, the input may indicate a need to receive information from a user, the at least one coding guideline may specify tests on received information and/or required reaction to invalid received information, and the particular testing procedure may verify that the source code performs the specified tests and/or reacts to invalid received information based on the required reaction. In some examples, step 1206 may comprise using the artificial intelligence model to analyze the input in the natural language and at least part of the source code (for example, the at least part of the source code generated by step 1208, a different part of the source code, etc.) to generate the one or more testing procedures for the source code. For example, the one or more testing procedures for the source code may include at least one of a white-box test, branch coverage tests, statement coverage tests, path coverage tests, condition coverage tests. For example, the input may include a requirement, the at least part of the source code may include a usage of a specific third-party dependency (such as an external service) for satisfying the requirement, and the test may check adherence to the requirement in case the specific third-party dependency is unavailable. In some examples, step 1206 may comprise identifying a first mathematical object in a particular mathematical space, the first mathematical object corresponds to a first at least one word included in the input, for example using module 302; identifying a second mathematical object in the particular mathematical space based on at least one instruction included in the generated at least part of the source code, for example using module 302; calculating a function of the first and second mathematical objects to obtain a third mathematical object in the particular mathematical space, for example using module 304; determining at least one new token based on the third mathematical object; and including the at least one new token in the one or more testing procedures for the source code. For example, the at least one new token may be at least one new word. In another example, the at least one new token may be at least one new instruction. In some examples, a particular testing procedure of the one or more testing procedures generated by step 1206 may include a test specified in a formal language. For example, the formal language may be a programming language, for example implementing the particular testing procedure in the programming language. In another example, a schema for the particular testing procedure may be specified in a formal language which is not a programming language. In some examples, a particular testing procedure of the one or more testing procedures generated by step 1206 may include a test specified in the natural language. For example, the particular testing procedure may be specific in a natural language in a Behavior-Driven Development (BDD) methodology. One example of such particular test procedure may include ‘Check that when a user adds a product to the cart and checks out with a valid credit card, the order is confirmed’.

In some examples, step 1208 may comprise using the artificial intelligence model to analyze an input in a natural language (such as the input in the natural language received by step 1204, the input of step 1206, a different input in the natural language, a different input in a different natural language, etc.) to generate at least part of a source code (such as the source code of step 1204 and/or step 1206 and/or step 1210, a source code generated based on the input, a source code generated based on a different input, a different source code, and so forth), for example as described herein.

In some examples, step 1210 may comprise executing one or more testing procedures (such as the one or more testing procedures generated by step 1206, one or more other testing procedures, etc.) on a source code (such as the source code of step 1204 and/or step 1206 and/or step 1208, a source code generated based on an input, a different source code, and so forth). In one example, step 1210 may further comprise executing at least one preexisting testing procedure on the source code. In some examples, step 1210 may further comprise determining a success of a source code (such as the source code of step 1204 and/or step 1206 and/or step 1208, a source code generated based on an input, a different source code, and so forth) in all tests of the one or more testing procedures generated by step 1206 and/or determining a failure of the source code in at least one of the one or more testing procedures, for example by executing at least some of the one or more testing procedures on the source code. In one example, step 1210 may determine a success of the source code in all tests of the one or more testing procedures; and, in response to the success, process 1200 may further comprise performing at least one of committing the generated at least part of the source code to a version control system, or executing the generated at least part of the source code. In one example, the input in the natural language received by step 1204 may be input received from an individual, and step 1210 may determine a failure of the source code in at least one of the one or more testing procedures; and may provide an indication of the failure to the individual (for example, visually, textually, graphically, audibly, in a user interface, in a code viewer, in an IDE, in a code editor, and so forth). In one example, the input in the natural language received by step 1204 may be input received from an individual, and step 1210 may determine a success of the source code in all tests of the one or more testing procedures; and may provide an indication of the success to the individual (for example, visually, textually, graphically, audibly, in a user interface, in a code viewer, in an IDE, in a code editor, and so forth). In one example, step 1210 may further comprise: receiving an indication of an update to the source code (for example, from a VCS, from a memory, from another process, from a user, etc.); and automatically executing the generated one or more testing procedures on the updated source code. In one example, step 1210 may determine a failure of the source code in at least one of the one or more testing procedures; and, in response to the failure, process 1200 may further comprise using the artificial intelligence model to analyze the input in the natural language and the failure to modify the at least part of the source code. For example, the modification may fix the source code to avoid the failure while keeping the functionality indicated by the input. In another example, the modification may fix the source code to avoid the failure while avoiding functionality indicated as prohibited by the input.

In some examples, a particular testing procedure of the one or more testing procedures for the source code generated by step 1206 may include an indication of at least one of a prerequisite, activity, or expected outcome. For example, in a Behavior-Driven Development (BDD) specification, (such as Cucumber, SpecFlow, etc.), the ‘Given’ of a testing procedure is a prerequisite, the ‘When’ of a testing procedure is an activity, and the ‘Then’ of a testing procedure is an expected outcome. In one example, a prerequisite may include ‘the user is in a login page’, an activity may include ‘the user enters valid credentials’, and the expected outcome may include ‘the user is redirected to the personal dashboard’. In another example, a prerequisite may include ‘x==5’, an activity may include ‘y=x+2’, and the expected outcome may include ‘y==7’. In some examples, a particular testing procedure of the one or more testing procedures for the source code generated by step 1206 may include an indication of a desired property of the source code. For example, in a property-based testing systems (such as QuickCheck, Hypothesis, etc.), different inputs and/or scenarios (such as random, edge cases, etc.) may be used to test that the desired property always holds true, regardless of the input and/or the scenario. In one example, an ‘assert’ statement may be inserted to the source code to verify that the desired property is true in runtime.

In some examples, a particular testing procedure of the one or more testing procedures for the source code generated by step 1206 may include at least one of a load test, stress test, or scalability test. For example, the particular testing procedure may include simulating real-world traffic to ensure the system can handle an expected and/or desired volume of activity (for example, an expected and/or desired volume of activity indicated by the input received by step 1204). In another example, the particular testing procedure may include simulating real-world traffic to ensure the system when handling a volume of activity that is significantly higher than the expected and/or desired volume of activity (for example, an expected and/or desired volume of activity indicated by the input received by step 1204). In an additional example, the particular testing procedure may include testing the system with different workloads and available resources (such as, computing units, memory, communication bandwidth, and so forth). In some examples, a particular testing procedure of the one or more testing procedures for the source code generated by step 1206 may include a penetration test. For example, the particular testing procedure may include a simulated cyberattack (for example, a cyberattack based on a vulnerability indicated by the input received by step 1204). In some examples, a particular testing procedure of the one or more testing procedures for the source code generated by step 1206 may include a state-based test. For example, the particular testing procedure may include an indication of an initial state, an indication of an event or an input, and an indication of a new state, and the particular testing procedure may test that when the system is in the initial state and the indicated event occurs or the indicated input is received, the system transit to the new state. For example, the states and/or the expected transitions among states may be indicated by the input received by step 1204. In some examples, a particular testing procedure of the one or more testing procedures for the source code generated by step 1206 may include a test of functionality associated with at least one valid input. In one example, the valid input may be an edge case (such as an edge case determined based on the input received by step 1204, an edge case determined based on the source code generated by step 1208, and so forth). In another example, the valid input may not be an edge case.

In some examples, a particular testing procedure of the one or more testing procedures for the source code generated by step 1206 may include a test of functionality associated with error test. In one example, the functionality may be associated with an invalid input case (such as an invalid input determined based on the input received by step 1204). In another example, the functionality may be associated with a communication error (such as a communication error associated with an external computing device, such as an external computing device selected based on the input received by step 1204). In yet another example, the functionality may be associated with an unavailable resource. In an additional example, the functionality may be associated with an unavailable service (such as a service selected based on the input received by step 1204). In another example, the functionality may be associated with an error reported by a third-party dependency (such as a third-party dependency selected based on the input received by step 1204, a third-party dependency selected by step 1010, and so forth). In yet another example, the functionality may be associated with a failure of a third-party dependency (such as a third-party dependency selected based on the input received by step 1204, a third-party dependency selected by step 1010, and so forth).

In some examples, the input in the natural language received by step 1204 may indicate a desired functionality on a collection of items, and the one or more testing procedures generated by step 1206 may include a test associated with the functionality when the collection includes no item. For example, the input may include ‘add a button for removing the last priority record’, the collection may be a list data-structure of priority records, and the one or more testing procedures may include a test associated with using the added button when the list is empty. In another example, the input may include ‘show the average and mean salary’, the collection may be a set data-structure of salary records, and the one or more testing procedures may include a test associated with the code for calculating the average and mean when the set is empty.

In some examples, step 1206 and/or step 1208 may comprise analyzing the input in the natural language received by step 1204 to determine a need to receive data associated with a specific valid range. Further, step 1206 may include in the one or more testing procedures for the source code at least one test based on the specific valid range. In one example, the at least one test based on the specific valid range may include at least one test associated with a value out of the specific valid range. In another example, the at least one test based on the specific valid range may include at least one test associated with an edge value of the specific valid range. In yet another example, the at least one test based on the specific valid range may include at least one test associated with a value in the specific valid range. In one example, step 1206 may determine an edge case based on the specific valid range, and include in the one or more testing procedures for the source code at least one test based on the edge case. For example, the input may include ‘verify that the password is at least 8 characters’, a test of an invalid value may include a 7 characters password, a test of an edge value may include an 8 characters password, and a test of a valid value may include a 9 characters password. In one example, step 1206 may analyze the input in the natural language to determine a need to receive second data, and the at least one test based on the specific valid range may be further based on the second received data.

In some examples, step 1206 and/or step 1208 may comprise analyzing the input in the natural language received by step 1204 to determine a need to receive data associated with a specific format. Further, step 1206 may include in the one or more testing procedures for the source code at least one test based on the specific format. For example, the input may include ‘receive an email address’, the specific format is ‘/\hat{ }[a-zA-Z0-9._%+-]+@[a-zA-Z0-9.-]+\. [a-zA-Z]{2,}$/’ (written in a regular expression), and the one or more testing procedures may include a test associated with an invalid email address input (such as ‘@domain.com’, ‘name@domain’, ‘name.domain’, ‘name@’), may include a test associated with a valid email address input (such as ‘name@domain.com’), and so forth. In another example, the input may include ‘receive a valid salary record’, a preliminary version of the source code may indicate that a valid salary record includes an integer employee-id, and a non-negative real number salary, and the one or more testing procedures may include a test associated with an invalid salary record input (such as a record without an employee-id, a record with a negative salary, and so forth), may include a test associated with a valid salary record (such as ‘{employee-id=7, salary=3,501.42’), and so forth. In some examples, step 1206 and/or step 1208 may comprise analyzing the input in the natural language received by step 1204 to determine a specific format for an output of the source code. Further, step 1206 may include in the one or more testing procedures for the source code at least one test based on the specific format. For example, the input may include ‘output must be a valid US phone number’, and the one or more testing procedures may include testing that the output is always a valid US phone number (for example, in a ‘\hat{ }\(?\d{3}\)?[-.\s]?\d{3}[-.\s]?\d{4}$’ format) for different inputs (such as different random inputs).

In some examples, step 1206 and/or step 1208 may comprise analyzing the input in the natural language received by step 1204 to determine a need to manipulate a data element when a specific condition is met. Further, step 1206 may include in the one or more testing procedures for the source code a test checking that the data element does not change when the specific condition is not met and/or a test checking that the data element change when the specific condition is met. For example, the input may include ‘count leap years in the data’, the condition may be that a specific year in the data is a leap year, and the one or more testing procedures may include testing that the counter does not change for the year ‘2026’ and/or testing that the counter increases for the year ‘2028’.

In some examples, step 1206 and/or step 1208 may comprise analyzing the input in the natural language received by step 1204 to determine a need to change a state of an object based on received data. Further, step 1206 may include in the one or more testing procedures for the source code a test checking that the state changes from a first selected state to a second selected state when a selected data is received. For example, the input may include ‘the gamer transit from level 4 to level 5 when they provide the secret key’, the object may be ‘level’, the first selected state may be ‘level==4’, the second selected state may be ‘level==5’, and the received selected data may be the secret key (that is, ‘received-key==secret-key’ is true). In some examples, step 1206 and/or step 1208 may comprise analyzing the input in the natural language received by step 1204 to determine a need to perform an operation. Further, step 1206 may include in the one or more testing procedures for the source code a test checking retrying performing the operation on failure of the operation for up to a selected number of times and stop retrying on success of the operation or reaching the selected number of times. For example, the input may include ‘obtain a background image from the server’, the operation may be connecting to the server, and the selected number of times may be 3. In some examples, step 1206 and/or step 1208 may comprise analyzing the input in the natural language received by step 1204 to determine a need to perform an operation. Further, step 1206 may include in the one or more testing procedures for the source code a test checking retrying performing the operation on failure of the operation. For example, the input may include ‘obtain a background image from the server’, and the operation may be connecting to the server.

In some examples, process 1200 may further comprise at least one of presenting the at least part of the source code generated by step 1208 and/or the one or more testing procedures generated by step 1206 to an individual, committing the at least part of the source code generated by step 1208 and/or the one or more testing procedures generated by step 1206 to a VCS, or executing the at least part of the source code generated by step 1208 and/or the one or more testing procedures generated by step 1206. In one example, process 1200 may further comprise presenting the at least part of the source code generated by step 1208 and/or the one or more testing procedures generated by step 1206 to an individual. For example, the presentation to the individual may be visually, textually, graphically, audibly, in a user interface, in a code viewer, and so forth. In one example, the presentation to the individual in a form that enables the individual to modify the source code and/or the one or more testing procedures, for example, in an IDE, in a code editor, in an editor, and so forth. In one example, process 1200 may further comprise committing the at least part of the source code generated by step 1208 and/or the one or more testing procedures generated by step 1206 to a VCS. In one example, process 1200 may further comprise executing the at least part of the source code generated by step 1208, for example using at least one processing unit.

In some examples, process 1200 may further comprise accessing a preliminary version of the source code of step 1204 and/or step 1206 and/or step 1208 and/or step 1210, for example, before the input in the natural language is received by step 1204 and/or before the source code is generated by step 1208, for example as described above in relation to step 504. In one example, step 1206 may use the artificial intelligence model to analyze the input in the natural language and at least part of the preliminary version of the source code to generate the one or more testing procedures for the source code. For example, the preliminary version of the source code may include an implementation of a function, the input may be indicative of a desired usage of the function, and the one or more testing procedures for the source code may be based on the function and the desired usage. In another example, the preliminary version of the source code may include a usage of a function, the input may be indicative of a desired modification to the function, and the one or more testing procedures for the source code may be based on the usage and/or the desired modification to the function. In one example, step 1208 may base the generation of the at least part of the source code on the preliminary version of the source code. For example, step 1208 may use the artificial intelligence model to analyze the input in the natural language to modify the preliminary version of the source code, for example as described above in relation to step 712, by adding instructions to the preliminary version of the source code, by removing instructions from the preliminary version of the source code, by modifying instructions of the preliminary version of the source code, and so forth.

In some examples, process 1200 may further comprise, for a particular testing procedure (such as a particular testing procedure of the generated one or more testing procedures for the source code, a different testing procedure, etc.), analyzing an input in a natural language (such as the input in the natural language received by step 1204, the input of step 1206, a different input in the natural language, a different input in a different natural language, etc.) to generate a documentation explaining the particular testing procedure based on the input (for example, using a generative model, using the artificial intelligence model accessed by step 402, using an artificial neural network, and so forth). For example, the documentation may be in a natural language (such as the natural language of step 1204, a different natural language, and so forth). In another example, the documentation may be graphically, may be in a formal language, and so forth. In one example, process 1200 may further comprise associating the generated documentation with the particular testing procedure in a data-structure. In one example, the documentation may be separated from the source code and the testing procedures, for example in a separate documentation file, in a VCS, and so forth. In another example, the documentation may be included in the source code, for example as one or more remarks in the source code. In yet another example, the documentation may be included in the particular testing procedure.

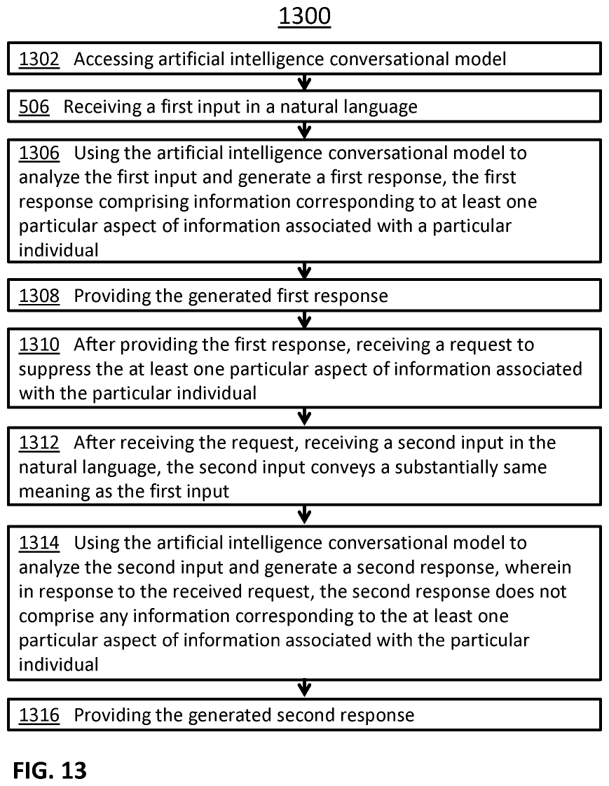

FIG. 13 is a flowchart of an example process 1300 for forgetting in artificial intelligence conversational models, consistent with some embodiments of the present disclosure. In this example, process 1300 may comprise: accessing an artificial intelligence conversational model (step 1302); receiving a first input in a natural language (step 506); using the artificial intelligence conversational model to analyze the first input and generate a first response (step 1306), the first response comprising information corresponding to at least one particular aspect of information associated with a particular individual; providing the generated first response (step 1308); after providing the first response, receiving a request to suppress the at least one particular aspect of information associated with the particular individual (step 1310); after receiving the request, receiving a second input in the natural language, the second input conveys a substantially same meaning as the first input (step 1312); using the artificial intelligence conversational model to analyze the second input and generate a second response (step 1314), wherein in response to the received request, the second response does not comprise any information corresponding to the at least one particular aspect of information associated with the particular individual; and providing the generated second response (step 1316). In other examples, process 1300 may include additional steps or fewer steps. In other examples, one or more steps of process 1300 may be executed in a different order and/or one or more groups of steps may be executed simultaneously.

In some examples, a system for forgetting in artificial intelligence conversational models may include at least one processing unit configured to perform operations, and the operations may include the steps of process 1300. In some examples, a method for forgetting in artificial intelligence conversational models may include performing process 1300. In some examples, a non-transitory computer readable medium may store computer implementable instructions that when executed by at least one processor may cause the at least one processor to perform operations for forgetting in artificial intelligence conversational models, and the operations may include the steps of process 1300.

In some examples, step 1302 may comprise accessing an artificial intelligence conversational model, for example using step 402. In some examples, the second input received by step 1312 may convey a substantially same meaning as the first input received by step 506, may convey a different meaning from the first input received by step 506, and so forth. In another example, the second input received by step 1312 and the first input received by step 506 may be identical, may be different, and so forth. In yet another example, the second input received by step 1312 may include the same words as the first input received by step 506, the second input received by step 1312 may include the same words at the same order as the first input received by step 506, the second input received by step 1312 may include the same words as the first input received by step 506 but in a different order, the second input received by step 1312 may include the different words from the first input received by step 506, and so forth. In an additional example, the first input received by step 506 may be a speech input in the natural language and the second input received by step 1312 may be a textual input in the natural language. In another example, the first input received by step 506 may be a textual input in the natural language and the second input received by step 1312 may be a speech input in the natural language. In yet another example, the first input received by step 506 may be a first speech input in the natural language and the second input received by step 1312 may be a second speech input in the natural language. In an additional example, the first input received by step 506 may be a first textual input in the natural language and the second input received by step 1312 may be a second textual input in the natural language. For example, the second textual input may be textually identical to the first textual input, may be textually different from the first textual input, and so forth.

In some examples, step 1306 may comprise using an artificial intelligence conversational model (such as the artificial intelligence conversational model accessed by step 1302, a different artificial intelligence conversational model, etc.) to analyze an input in a natural language (such as the first input received by step 506, a different input in a natural language, etc.) and generate a first response. Further, the first response may comprise information corresponding to at least one particular aspect of information associated with a particular individual. In some examples, step 1314 may comprise using an artificial intelligence conversational model (such as the artificial intelligence conversational model accessed by step 1302, a different artificial intelligence conversational model, etc.) to analyze an input in a natural language (such as the second input received by step 1312, a different input in a natural language, etc.) and generate a second response. In response to the request received by step 1310, the second response generated by step 1314 may not comprise any information corresponding to the at least one particular aspect of information associated with a particular individual (such as the particular individual of step 1306 and/or step 1310, a different individual, and so forth).

In some examples, a response may be provided. For example, step 1308 may comprise providing the first response generated by step 1306. In another example, step 1316 may comprise providing the second response generated by step 1314. In one example, the response may be a response to an input received from an individual, and the response may be provided to the individual. In another example, the response may be a response to an input received from an individual, and the response may be provided to a different individual. In yet another example, the response may be provided to a different process, for example via memory, data-structure, database, communication protocol or function call. In an additional example, the response may be provided to an external computing device for example, using a digital communication device, such as communication module 230. In one example, the response may be provided digitally, may be provided visually, may be provided textually, may be provided graphically, may be provided audibly, may be provided in a user interface, may be provided in a Command Line Interface (CLI), and so forth.

In some examples, step 1316 may provide an indication that information was redacted from the generated second response. For example, step 1316 may provide the indication that information was redacted from the generated second response with the generated second response. In another example, step 1316 may provide the indication that information was redacted from the generated second response separately from the generated second response. For example, step 1316 may provide the indication that information was redacted from the generated second response digitally, visually, textually, graphically, audibly, via a user interface, in a CLI, in a log file, to a system administrator, to an individual, to a different process, to an external computing device, and so forth.

In some examples, the first input may be received by step 506 from a specific individual, the second input may be received by step 1312 from the specific individual, the first response may be provided by step 1308 to the specific individual, and the second response may be provided by step 1316 to the specific individual. In another example, the first input may be received by step 506 from a specific individual, and the first response may be provided by step 1308 to the specific individual. In yet another example, the second input may be received by step 1312 from a specific individual, and the second response may be provided by step 1316 to the specific individual. In one example, the specific individual may differ from the particular individual. In another example, the specific individual and the particular individual may be the same individual. In one example, the first input may be received by step 506 from a first individual, the first response may be provided by step 1308 to the first individual, the second input may be received by step 1312 from a second individual different from the first individual, and the second response may be provided by step 1316 to the second individual.

In some examples, step 1310 may comprise, for example after providing the first response using step 1308, receiving a request to suppress at least one particular aspect of information associated with a particular individual (such as the at least one particular aspect of information associated with the particular individual of step 1306, a different at least one particular aspect of information associated with the particular individual of step 1306, at least one particular aspect of information associated with a different individual, and so forth). In one example, step 1310 may receive the request from the particular individual. In another example, step 1310 may receive the request from an entity different from the particular individual (some non-limiting examples of such entity may include an individual different from the particular individual, a representative of the particular individual, a regulatory entity, and so forth). In yet another example, step 1310 may read the request from memory (for example, from a digital memory, from memory unit 210, etc.), may receive the request from an external computing device (for example, using a digital communication device, such as communication module 230), may receive the request from an individual (for example, via a user interface, via voice commands, via gesture recognition, via an input device, in a natural language, etc.), may receive the request from a different process, and so forth. In some examples, the request received by step 1310 may be a request in a natural language or may include information in the natural language. In one example, step 1310 may analyze the information in the natural language to determine the at least one particular aspect, for example using an NLP algorithm, using an artificial neural network, using an artificial intelligence conversational model (such as the artificial intelligence conversational model accessed by step 1302, a different artificial intelligence conversational model, etc.), and so forth. For example, the request may include ‘forget any information associate with his arrest’, and the at least one particular aspect may be the particular individual's arrest. In one example, step 1310 may analyze the information in the natural language to analyzing the information in the natural language to identify the particular individual, for example using an NLP algorithm, using an artificial neural network, using an artificial intelligence conversational model (such as the artificial intelligence conversational model accessed by step 1302, a different artificial intelligence conversational model, etc.), and so forth. For example, the request may include ‘Don't disclose any information about the hospitalization of the elder son’, and the particular individual may be the elder son.

In some examples, process 1300 may further comprise, for example in response to the request received by step 1310, modifying the artificial intelligence conversational model, for example based on the request received by step 1310. Further, the analyzing the first input and the generating the first response by step 1306 may be performed with the artificial intelligence conversational model before the modification, and the analyzing the second input and the generating the second response by step 1314 may be performed with the modified artificial intelligence conversational model. For example, the artificial intelligence conversational model may be fine-tuned or re-trained to remove data corresponding to at least one particular aspect of information associated with the particular individual from the model. In another example, the artificial intelligence conversational model may be fine-tuned, re-trained or reinforced (in a reinforcement training scheme) to avoid providing any data corresponding to at least one particular aspect of information associated with the particular individual.

In some examples, for example in response to the request received by step 1310, step 1314 may post process one or more outputs of the artificial intelligence conversational model to remove information corresponding to the at least one particular aspect of information associated with the particular individual to generate the second response. For example, step 1314 may use the artificial intelligence conversational model to analyze the second input and generate a preliminary response that comprises data corresponding to the at least one particular aspect of information associated with the particular individual. Further, step 1314 may post process the preliminary response to remove the data corresponding to the at least one particular aspect of information associated with the particular individual, and thereby generate the second response. For example, step 1314 may use a machine learning model to analyze the preliminary response to remove the data corresponding to the at least one particular aspect of information associated with the particular individual. The machine learning model may be a machine learning model trained using training examples to remove, from provided content, data corresponding to selected aspect(s) associated with selected individual(s). An example of such training example may include sample preliminary content, sample aspect(s) and sample individual(s), together with a revised (or a redacted) version of the sample preliminary content that does not include data corresponding to the sample aspect(s) and associated with the sample individual(s). In another example, step 1314 may use an artificial neural network to analyze the preliminary response to remove the data corresponding to the at least one particular aspect of information associated with the particular individual. In yet another example, step 1314 may use an artificial intelligence conversational model (such as the artificial intelligence conversational model accessed by step 1302, a different artificial intelligence conversational model, etc.) to analyze the preliminary response to remove the data corresponding to the at least one particular aspect of information associated with the particular individual.

In some examples, step 1306 may analyze the first input received by step 506 to select a particular source of information, for example, using a search engine, using a Retrieval-Augmented Generation (RAG) framework, via a Model Context Protocol (MCP) connection, and so forth. Further, step 1306 may base the generation of the first response on the particular source of information. Further, step 1314 may avoid basing the generation of the second response on the particular source of information, for example in response to the request received by step 1310. For example, the particular source of information may include information associated with the particular individual and corresponding to the at least one particular aspect (of step 1306 and/or step 1310 and/or step 1314). In another example, the at least one particular aspect of information associated with the particular individual (of step 1306 and/or step 1314) may include the particular source. In some examples, step 1306 may analyze the first input received by step 506 to select a first source of information and a second source of information, for example, using a search engine, using a RAG framework, via an MCP connection, and so forth. Further, step 1306 may base the generation of the first response on the first source of information and the second source of information. Further, step 1314 may analyze the second input received by step 1312 to select the second source of information while avoiding selecting the first source of information based on the request received by step 1310. Further, step 1314 may base the generation of the second response on the second source of information. For example, the first source of information may include information associated with the particular individual and corresponding to the at least one particular aspect (of step 1306 and/or step 1310 and/or step 1314), and the second source of information may not include information associated with the particular individual and corresponding to the at least one particular aspect.

In some examples, process 1300 may further comprise, for example in response to the request received by step 1310, modifying a system prompt, for example based on the request received by step 1310. Further, the analyzing the first input and the generating the first response by step 1306 may be performed with the system prompt before the modification, and the analyzing the second input and the generating the second response by step 1314 may be performed with the modified system prompt. For example, the system prompt may be modified to include instructions for avoiding providing information corresponding to the at least one particular aspect of information associated with the particular individual (of step 1306 and/or step 1310 and/or step 1314).

In some examples, the at least one particular aspect of information associated with the particular individual (of step 1306 and/or step 1314) may include a particular source of information including information associated with the particular individual. That is, the request received by step 1310 may be a request to suppress information associated with the particular individual originating from particular source of information. Some non-limiting examples of such source of information may include a website, an article (such as a report, a feature story, an essay, a news article, a publication, etc.), a blog, a media content (such as a video clip, an audio clip, etc.), and so forth. In one example, after receiving the request, a third input in the natural language may be received (for example as described above); the artificial intelligence conversational model accessed by step 1302 may be used to analyze the third input and generate a third response, the third response may not be associated with the particular individual and may comprise information based on the particular source of information; and the generated third response may be provided (for example, as described above in relation to step 1308 and/or step 1316). In one example, the first response generated by step 1306 may include a reference to the particular source, and the second response generated by step 1314 may not include any reference to the particular source (for example in response to the request received by step 1310). For example, the second response generated by step 1314 may include a reference to an alternative source that is not indicated in the generated first response, for example instead of the particular source. In one example, the first response generated by step 1306 may include a particular piece of information based on information included in the particular source, and the second response generated by step 1314 may not include the particular piece of information (for example in response to the request received by step 1310). In some examples, the first response generated by step 1306 may include a particular media content from the particular source of information, and the second response generated by step 1314 may not include the particular media content. In one example, the particular media content may be a visual content (such as an image or a video clip) including a depiction of the particular individual. In another example, the particular media content may be an audio clip including speech produced by the particular individual. In one example, the particular media content may be or include at least one of an image, a video clip, or an audio clip. For example, the generated second response may include an alternative media content that is not included in the generated first response. For example, the alternative media content may not be included in the particular source of information. In another example, the alternative media content may be included in the particular source of information and in an alternative source of information, and the particular media content may not be included in the alternative source of information.

In some examples, the at least one particular aspect of information associated with the particular individual (of step 1306 and/or step 1314) may include a particular piece of information associated with the particular individual. In some examples, the at least one particular aspect of information associated with the particular individual (of step 1306 and/or step 1314) may include a particular type of information associated with the particular individual. Some non-limiting examples of such type of information may include identifying information (such as a name, an official identification number, etc.), contact information (such as a phone number, an email address, a street address, etc.), demographic information (such as age, gender, ethnicity, nationality, language preference, etc.), preferences and/or interests (such as favorite product, preferred music, preferred content, consumed content, wish-list, etc.), financial information (such as wealth, income, transaction history, credit score, etc.), health information (such as illnesses, medical conditions, consumed medications, medical procedures, treatment history, etc.), social information (such as social connections, social activity, etc.), behavioral information, opinions, quotes of the particular individual, visual depictions of the particular individual, audio recordings of the particular individual, and so forth. In some examples, the at least one particular aspect of information associated with the particular individual (of step 1306 and/or step 1314) may include all information associated with the particular individual but the existence of the particular individual, may include all information associated with the particular individual including the existence of the particular individual, and so forth.

In some examples, the at least one particular aspect of information associated with the particular individual (of step 1306 and/or step 1314) may include at least one visual depiction of the particular individual. In some examples, the at least one particular aspect of information associated with the particular individual (of step 1306 and/or step 1314) may include all visual depictions of the particular individual. In some examples, the at least one particular aspect of information associated with the particular individual (of step 1306 and/or step 1314) may include all visual depictions of a selected category of the particular individual. Some non-limiting examples of such category may include nudity, location-based category (that is, visual depictions of the individual at a selected location), time-based category (that is, visual depictions of the individual from a selected time-frame), activity-based category (that is, visual depictions of the individual during a selected activity), association-based category (that is, visual depictions of the individual together with a selected person or a selected element), and so forth.

In some examples, the at least one particular aspect of information associated with the particular individual (of step 1306 and/or step 1314) may include at least one audio recording of the particular individual. In some examples, the at least one particular aspect of information associated with the particular individual (of step 1306 and/or step 1314) may include all audio recordings of the particular individual. In some examples, the at least one particular aspect of information associated with the particular individual (of step 1306 and/or step 1314) may include all audio recordings of a selected category of the particular individual. Some non-limiting examples of such category may include location-based category (that is, audio recordings of the individual from a selected location), time-based category (that is, audio recordings of the individual from a selected time-frame), activity-based category (that is audio recordings of the individual during a selected activity), association-based category (that is, audio recordings of the individual conversing with a selected person), subject-based category (that is, audio recordings of the individual speaking about a selected subject), and so forth.

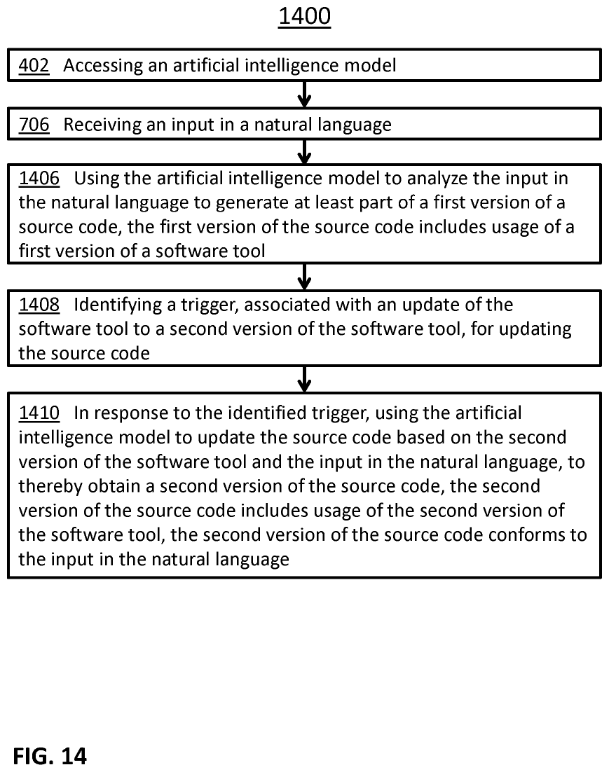

FIG. 14 is a flowchart of an example process 1400 for maintaining conformance to prior guidance when updating source code using artificial intelligence coding, consistent with some embodiments of the present disclosure. In this example, process 1400 may comprise: accessing an artificial intelligence model (step 402); receiving an input in a natural language (step 706); using the artificial intelligence model to analyze the input in the natural language to generate at least part of a first version of a source code (step 1406), the first version of the source code includes usage of a first version of a software tool; identifying a trigger, associated with an update of the software tool to a second version of the software tool, for updating the source code (step 1408); and in response to the identified trigger, using the artificial intelligence model to update the source code based on the second version of the software tool and the input in the natural language, to thereby obtain a second version of the source code (step 1410), the second version of the source code includes usage of the second version of the software tool, the second version of the source code conforms to the input in the natural language. In other examples, process 1400 may include additional steps or fewer steps. In other examples, one or more steps of process 1400 may be executed in a different order and/or one or more groups of steps may be executed simultaneously.

In some examples, a system for maintaining conformance to prior guidance when updating source code using artificial intelligence coding may include at least one processing unit configured to perform operations, and the operations may include the steps of process 1400. In some examples, a method for maintaining conformance to prior guidance when updating source code using artificial intelligence coding may include performing process 1400. In some examples, a non-transitory computer readable medium may store computer implementable instructions that when executed by at least one processor may cause the at least one processor to perform operations for maintaining conformance to prior guidance when updating source code using artificial intelligence coding, and the operations may include the steps of process 1400.

In some examples, step 1406 may comprise using an artificial intelligence model (such as the artificial intelligence model received by step 402, a different artificial intelligence model, etc.) to analyze an input in a natural language (such as the input in the natural language received by step 706, a different input in the natural language, a different input in a different natural language, etc.) to generate at least part of a first version of a source code. The first version of the source code may include usage of a first version of a software tool. In one example, the software tool may be a software library. In another example, the software tool may be a software function. In yet another example, the software tool may be a digital service (such as an online digital service, a local digital service, and so forth). In an additional example, the software may be is an API. In another example, the software tool may be a software framework. In one example, the first version of the source code may conform to the input in the natural language.

In some examples, step 1408 may comprise identifying a trigger, associated with an update of a software tool (such as, the software tool of step 1406 and/or step 1410, a different software tool, and so forth) to a second version of the software tool, for updating a source code (such as, the source code or step 1406 and/or step 1410, a different source code, and so forth). In some examples, the identified trigger may be based on an availability of the second version of the software tool. For example, step 1408 may receive an indication of the availability of the second version of the software tool, and thereby identify the trigger for updating the source code. For example, step 1408 may receive the indication of the availability of the second version of the software tool from an individual (for example, via a user interface, via a CLI, in a natural language, etc.), from a bug tracking system (for example, a bug report may include an indication of an availability of the second version of the software tool that may solve the bug), from an issue tracking system (for example, a feature request may include a request to use the second version of the software tool, thereby indicating its availability), from a package management system, from release notes (for example, of the second version of the software tool, of a different component, etc.), from a VCS, and so forth. In some examples, the identified trigger may be based on an unavailability of the first version of the software tool. In one example, the unavailability may be a prospective unavailability. In another example, the unavailability may be a current unavailability. For example, step 1408 may receive an indication of the unavailability of the first version of the software tool, and thereby identify the trigger for updating the source code. For example, step 1408 may receive the indication of the unavailability of the first version of the software tool from an individual (for example, via a user interface, via a CLI, in a natural language, etc.), from a bug tracking system (for example, a bug report reporting failure due to the unavailability), from an issue tracking system, from a package management system, and so forth. In some examples, the identified trigger may be based on at least one of a decision or a need to replace the usage of the first version of the software tool with a usage of the second version of the software tool. In some example, step 1408 may receive the trigger from an individual, for example via a user interface, via a CLI, in a formal language, in a natural language (such as ‘update the code to use the newest version of this library’), and so forth. For example, step 706 may receive the input in the natural language from a specific individual, and step 1408 may receive the trigger from the same specific individual. In some examples, the trigger may be an automatically generated digital indication, for example by a package management system, in response to an availability of the second version of the software tool, in response to an unavailability of the first version of the software tool, and so forth. In some examples, step 1408 may receive the trigger from at least one of a bug tracking system or an issue tracking system, for example as described above. In some examples, step 1408 may receive the trigger from a package management system, for example based on an availability of the second version of the software tool, based on an unavailability of the first version of the software tool, and so forth.

In some examples, step 1410 may comprise, for example in response to a trigger (such as the trigger identified by step 1408, a different trigger, etc.), using an artificial intelligence model (such as the artificial intelligence model received by step 402, a different artificial intelligence model, etc.) to update a source code (such as the source code or step 1406 and/or step 1408) based on a version of a software tool (such as the second version of the software tool of step 1408, a different version of the software tool of step 1406 and/or step 1408, a version of a different software tool, etc.) and an input in a natural language (such as the input in the natural language received by step 706, a different input in the natural language, a different input in a different natural language, etc.), to thereby obtain a second version of the source code. For example, step 1410 may, in response to the trigger identified by step 1408, using the artificial intelligence model to update the source code (of step 1406 and/or step 1408) based on the second version of the software tool (of step 1408) and the input in the natural language, to thereby obtain a second version of the source code. The second version of the source code may include usage of the version of the software tool. The second version of the source code may conform to the input in the natural language. In one example, the update to the source code comprises a replacement of at least part of the usage of the first version of the software tool (of step 1406) with a usage of the second version of the software tool (of step 1408). For example, at least some of but not all the instances of usage of the first version of the software tool in the first version of the source code may be replaced with usage of the second version of the software tool in the second version of the source code. In another example, all the instances of usage of the first version of the software tool in the first version of the source code may be replaced with usage of the second version of the software tool in the second version of the source code. In yet another example, no instance of usage of the first version of the software tool in the first version of the source code may be replaced in the second version of the source code, and the second version of the source code may include new instance(s) of usage of the second version of the software tool. In one example, the second version of the source code generated by step 1410 may include no usage of the first version of the software tool (of step 1406). In another example, the second version of the source code generated by step 1410 may include at least one usage of the first version of the software tool (of step 1406), for example in addition to at least one usage of the second version of the software tool.

In some examples, the input in the natural language received by step 706 may include an indication of at least one desired characteristic and/or no indication of the software tool of step 1406 and/or step 1408 and/o step 1410, the first version of the source code generated by step 1406 may include the at least one desired characteristic, and the update to the source code by step 1410 may preserve the at least one desired characteristic. Therefore, the second version of the source code obtained by step 1410 may include the at least one desired characteristic. For example, step 1410 may modify a usage of the software tool included in the first version of the source code to preserve the at least one desired characteristic that would not be preserved, when replacing the first version of the software tool to the second version of the software tool, without the modification. For example, the update of the software tool may include a change in functionality that without the modification may cause the source code to fail to preserve the at least one desired characteristic. In one example, the first version of the source code may further include at least one other characteristic not indicated by the input in the natural language, and the update to the source code by step 1410 may not preserve the at least one other characteristic. In one example, the at least one desired characteristic may be associated with performance. For example, the input may include ‘minimize memory footprint, even if that makes the code slower’, the first version of the software tool may minimize memory footprint by default, the second version of the software tool may only minimize memory footprint when specifically guided to (for example, via a parameter, via a flag, via a setting, etc.), and the update to the source code may include guiding the software tool to minimize memory footprint. In one example, the at least one desired characteristic may be associated with error handling. For example, the input may include ‘log all errors’, ‘fail gracefully instead of crushing’, and so forth. In one example, the at least one desired characteristic may be associated with security practices. For example, the input may include ‘sanitize all user inputs’, the first version of the software tool may not be configured to receive data from a user, a specific functionality of the second version of the software tool may be configured to receive data from a user, the first version of the source code may use the specific functionality, and the update to the source code may include replacing the usage of the specific functionality with an alternative. In one example, the at least one desired characteristic may be associated with a programming language or a programming framework. For example, the input may include ‘use Python 3.11 features only’, the first version of the software tool may only include Python 3.11 features, a specific functionality of the second version of the software tool may include usage of non-Python 3.11 features, the first version of the source code may use the specific functionality, and the update to the source code may include replacing the usage of the specific functionality with an alternative.

In some examples, the input in the natural language received by step 706 may include an indication of at least one undesired characteristic and/or no indication of the software tool of step 1406 and/or step 1408 and/o step 1410, the first version of the source code generated by step 1406 may avoid the at least one undesired characteristic, and the update to the source code by step 1410 may avoid the at least one undesired characteristic. Therefore, the second version of the source code obtained by step 1410 may avoid the at least one undesired characteristic. For example, step 1410 may modify a usage of the software tool included in the first version of the source code to avoid the at least one undesired characteristic that would not be avoided, when replacing the first version of the software tool to the second version of the software tool, without the modification. For example, the update of the software tool may include a change in functionality that without the modification may cause the source code to include the at least one undesired characteristic. In one example, the first version of the source code may further avoid at least one other characteristic not indicated by the input in the natural language, and the update to the source code by step 1410 may not avoid the at least one other characteristic. In one example, the at least one undesired characteristic may be associated with performance. For example, the input may include ‘don't allow the memory footprint to go over 64 k’, the footprint of the first version of the source code may be under 64 k, naïve upgrade of the software tool may create a footprint larger than 64 k, and the update to the source code may include configuring the software tool to use less memory. In one example, the at least one undesired characteristic may be associated with error handling. For example, the input may include ‘avoid crushing without logging’. In one example, the at least one undesired characteristic may be associated with security practices. For example, the input may include ‘do not expose sensitive data in logs’, the first version of the software tool may not create any log, the second version of the software tool may create logs by default that may expose sensitive data, and the update to the source code may include guiding the software tool to avoid creating logs (for example, via a parameter, via a flag, via a setting, and so forth). In one example, the at least one undesired characteristic may be associated with a programming language or a programming framework. For example, the input may include ‘don't use any unauthorized external tool’, the first version of the software tool may not use any unauthorized external tool, a specific functionality of the second version of the software tool may include usage of an unauthorized external tool, the first version of the source code may use the specific functionality, and the update to the source code may include replacing the usage of the specific functionality with an alternative.

In some examples, the second version of the software tool (of step 1408 and/or step 1410) may include a default option to rely on a specific type of hardware and a non-default option that does not rely on the specific type of hardware, the first version of the software tool (of step 1406) may include a default option that does not rely on the specific type of hardware, the first version of the source code generated by step 1406 may use the default option of the first version of the software tool, and the second version of the source code obtained by step 1410 may use the non-default option of the second version of the software tool to conform to the input in the natural language received by step 706. For example, the input in the natural language may include a guidance to avoid the specific type of hardware. For example, the input may include ‘don't use GPUs’, ‘assume there is no local printer’, ‘the code must support older CPU models that do not include this capability’, and so forth. Some non-limiting examples of such specific type of hardware may include hardware accelerator, auxiliary hardware, specific versions of a hardware device, and so forth.

In some examples, the second version of the software tool (of step 1408 and/or step 1410) may include a default option that includes a specific user-facing behavior and a non-default option that does not include the specific user-facing behavior, the first version of the software tool (of step 1406) may include a default option that does not include the specific user-facing behavior, the first version of the source code generated by step 1406 may use the default option of the first version of the software tool, and the second version of the source code obtained by step 1410 may use the non-default option of the second version of the software tool to conform to the input in the natural language received by step 706. For example, the input in the natural language may include a guidance to avoid the specific user-facing behavior. For example, the input may include ‘do not expose private information’, ‘do not wait for user input’, and so forth. For example, the specific user-facing behavior may be associated with providing information to a user, may be associated with receiving information from a user, and so forth.

In some examples, the second version of the software tool (of step 1408 and/or step 1410) may include a default option that includes a default option that includes sharing specific data and a non-default option that does not share the specific data, the first version of the software tool (of step 1406) may include a default option that does not share the specific data, the first version of the source code generated by step 1406 may use the default option of the first version of the software tool, and the second version of the source code obtained by step 1410 may use the non-default option of the second version of the software tool to conform to the input in the natural language received by step 706. For example, the input in the natural language may include a guidance to avoid sharing the specific data. For example, the input may include ‘do not share private information’, ‘do not share progress data’, and so forth. For example, the sharing specific data may be sharing with an individual (such as a user), sharing with another process (for example, digitally), sharing with an external computing device, and so forth.

In some examples, the first version of the source code generated by step 1406 may use the first version of the software tool (of step 1406) to solve a first problem and a second problem. Further, the second version of the source code obtained by step 1410 may use the second version of the software tool (of step 1408 and/or step 1410) to solve the first problem. Further, the second version of the source code obtained by step 1410 may avoid using the second version of the software tool to solve the second problem to conform to the input in the natural language received by step 706. In one example, the second version of the source code obtained by step 1410 may use the first version of the software tool to solve the second problem. In another example, the second version of the source code may use an alternative to the software tool to solve the second problem.

In some examples, the first version of the source code generated by step 1406 may be used for a particular usage before the trigger is identified. In one example, process 1400 may further comprise: stopping using the first version of the source code for the particular usage; and initiating using the second version of the source code obtained by step 1410 for the particular usage. For example, the particular usage may be a usage of the source code in production. In another example, the first version of the source code may be used by at least one hundred people before the trigger is identified.

In some examples, process 1400 may further comprise at least one of presenting the first version of the source code generated by step 1406 to an individual, committing the first version of the source code generated by step 1406 to a VCS, executing the first version of the source code generated by step 1406, presenting the second version of the source code obtained by step 1410 to an individual, committing the second version of the source code obtained by step 1410 to a VCS, or executing the second version of the source code obtained by step 1410. In one example, process 1400 may further comprise presenting the first version of the source code generated by step 1406 to an individual. In another example, process 1400 may further comprise presenting the second version of the source code obtained by step 1410 to an individual. For example, the source code may be presented to the individual visually, textually, graphically, audibly, in a user interface, in a code viewer, and so forth. In one example, the source code may be presented to the individual in a form that enables the individual to modify the source code, for example, in an IDE, in a code editor, and so forth. In one example, process 1400 may further comprise committing the first version of the source code generated by step 1406 to a VCS. In another example, process 1400 may further comprise committing the second version of the source code obtained by step 1410 to a VCS. In one example, process 1400 may further comprise executing the first version of the source code generated by step 1406, for example using at least one processing unit. In another example, process 1400 may further comprise executing the second version of the source code obtained by step 1410, for example using at least one processing unit.

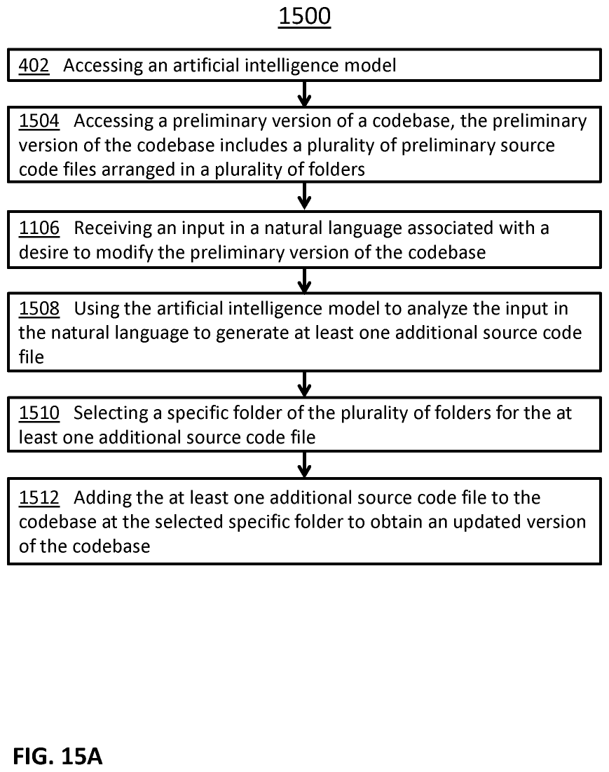

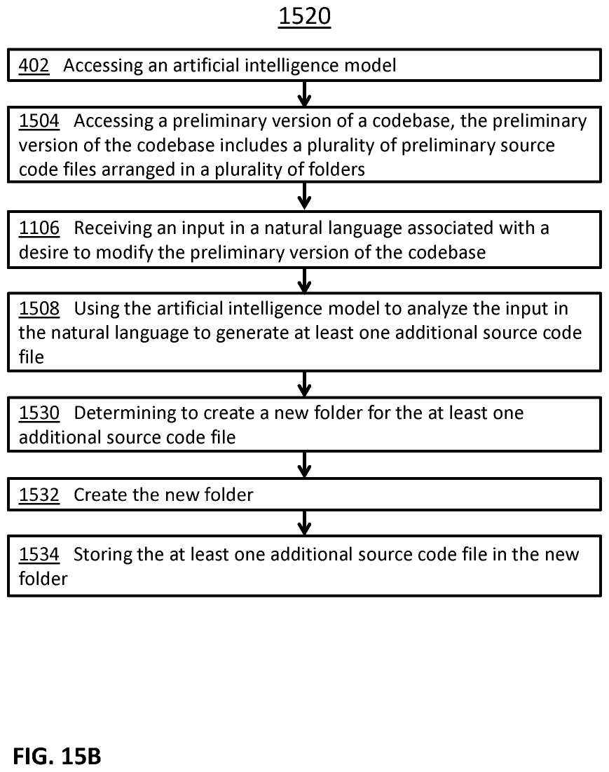

FIG. 15A is a flowchart of an example process 1500 for folders in artificial intelligence coding, consistent with some embodiments of the present disclosure. In this example, process 1500 may comprise: accessing an artificial intelligence model (step 402); accessing a preliminary version of a codebase (step 1504), the preliminary version of the codebase includes a plurality of preliminary source code files arranged in a plurality of folders; receiving an input in a natural language associated with a desire to modify the preliminary version of the codebase (step 1106); using the artificial intelligence model to analyze the input in the natural language to generate at least one additional source code file (step 1508); selecting a specific folder of the plurality of folders for the at least one additional source code file (step 1510); and adding the at least one additional source code file to the codebase at the selected specific folder to obtain an updated version of the codebase (step 1512). In other examples, process 1500 may include additional steps or fewer steps. In other examples, one or more steps of process 1500 may be executed in a different order and/or one or more groups of steps may be executed simultaneously.

FIG. 15B is a flowchart of an example process 1520 for folders in artificial intelligence coding, consistent with some embodiments of the present disclosure. In this example, process 1520 may comprise: accessing an artificial intelligence model (step 402); accessing a preliminary version of a codebase (step 1504), the preliminary version of the codebase includes a plurality of preliminary source code files arranged in a plurality of folders; receiving an input in a natural language associated with a desire to modify the preliminary version of the codebase (step 1106); using the artificial intelligence model to analyze the input in the natural language to generate at least one additional source code file (step 1508); determining to create a new folder for the at least one additional source code file (step 1530); creating the new folder (step 1532); and storing the at least one additional source code file in the new folder (step 1534). In other examples, process 1520 may include additional steps or fewer steps. In other examples, one or more steps of process 1520 may be executed in a different order and/or one or more groups of steps may be executed simultaneously.

In some examples, a system for folders in artificial intelligence coding may include at least one processing unit configured to perform operations, and the operations may include the steps of process 1500 and/or the steps of process 1520. In some examples, a method for folders in artificial intelligence coding may include performing process 1500 and/or process 1520. In some examples, a non-transitory computer readable medium may store computer implementable instructions that when executed by at least one processor may cause the at least one processor to perform operations for folders in artificial intelligence coding, and the operations may include the steps of process 1500 and/or the steps of process 1520.

In some examples, step 1504 may comprise accessing a preliminary version of a codebase. The preliminary version of the codebase may include a plurality of preliminary source code files arranged in a plurality of folders. In one example, each folder of the plurality of folders is associated with a respective name. In one example, each folder of the plurality of folders may be associated with a respective subgroup of the plurality of preliminary source code files (for example, may store the respective subgroup of the plurality of preliminary source code files, may be linked to the respective subgroup of the plurality of preliminary source code files, and so forth). For example, step 1504 may retrieve at least part of the preliminary version of the codebase from a VCS, may read at least part of the preliminary version of the codebase from a memory (for example, from a digital memory, from memory unit 210, etc.), may access at least part of the preliminary version of the codebase via an external computing device (for example, using a digital communication device), may generate at least part of the preliminary version of the codebase (for example, using a generative artificial intelligence model, in response to a prompt, based on a sketch, by altering a different version of the source code, by generating the at least part of the source code from scratch, using the steps and/or processes described herein, using other processes, etc.), may receive at least part of the preliminary version of the codebase from an individual (for example, via a user interface, via an IDE, via a what-you-see-is-what-you-get application that creates source code from graphical design, via an input device, via a keyboard, via voice recognition, etc.), and so forth.

In some examples, step 1508 may comprise using an artificial intelligence model (such as the artificial intelligence model received by step 402, a different artificial intelligence model, etc.) to analyze an input in a natural language (such as the input in the natural language received by step 1106, a different input in the natural language, a different input in a different natural language, etc.) to generate at least one additional source code file.

In some examples, step 1510 may comprise selecting a specific folder of a plurality of folders (for example, of the plurality of folders of step 1504, of a different plurality of folders, and so forth) for at least one additional source code file (such as the at least one additional source code file generated by step 1508, a different at least one additional source code file, and so forth). In one example, step 1510 may analyze the at least one additional source code file to select the specific folder of the plurality of folders for the at least one additional source code file, for example using an artificial neural network, using an artificial intelligence model (such as the artificial intelligence model accessed by step 402, a different artificial intelligence model, etc.), and so forth. For example, the at least one additional source code file may include instructions for unit tests, and step 1510 may select a folder associated with unit tests of the plurality of folders (such as a folder designated for unit tests, a folder that already contain source code files for unit tests, a folder associated with tests in general, and so forth). In another example, the at least one additional source code file may include instructions implementing a communication protocol, and step 1510 may select a folder associated with communication protocols of the plurality of folders. In one example, step 1510 may analyze the input in the natural language to select the specific folder of the plurality of folders for the at least one additional source code file, for example using an NLP algorithm, using an artificial neural network, using an artificial intelligence model (such as the artificial intelligence model accessed by step 402, a different artificial intelligence model, etc.), and so forth. For example, the input may include ‘create unit tests for the communication protocol’, and step 1510 may select a folder associated with unit tests of the plurality of folders. In one example, each folder of the plurality of folders may be associated with a respective name, and step 1510 may base the selection of the specific folder on the names associated with the plurality of folders. For example, when the at least one additional source code file is associated with unit tests, step 1510 may select a folder associated with the name ‘tests’. In another example, when the at least one additional source code file is associated with a frontend website user interface, step 1510 may select a folder associated with the name ‘web-app’. In one example, each folder of the plurality of folders may be associated with a respective description in the natural language, and step 1510 may base the selection of the specific folder on an analysis of the descriptions in the natural language associated with the plurality of folders (for example, using an NLP algorithm, using an artificial neural network, using the artificial intelligence model, and so forth). For example, when the at least one additional source code file is associated with unit tests, and step 1510 may select a folder associated with the description ‘procedures for automated tests’. In another example, when the at least one additional source code file is associated with data retrieval from a database in response to frontend triggers, and step 1510 may select a folder associated with the description ‘This folder contains the backend logic for handling user authentication, API endpoints, and database interactions’. In one example, each folder of the plurality of folders may be associated with a respective subgroup of the plurality of preliminary source code files, and step 1510 may base the selection of the specific folder on the association of different folders with source code files. For example, step 1510 may calculate affinity measure between the at least one additional source code file and the different subgroups of the plurality of preliminary source code files, and may select the folder corresponding to the subgroup with the largest affinity value. In one example, the at least one additional source code file may include configuration data, and step 1510 may select a folder already including other configuration files.

In some examples, step 1510 may use an artificial intelligence model (such as the artificial intelligence model accessed by step 402, a different artificial intelligence model, etc.) to select the specific folder of the plurality of folders for the at least one additional source code file based on data associated with each folder of the plurality of folders and data associated with the at least one additional source code file. In some examples, step 1510 may use an artificial neural network to select the specific folder of the plurality of folders for the at least one additional source code file based on data associated with each folder of the plurality of folders and data associated with the at least one additional source code file. In some examples, step 1510 may use a machine learning model to select the specific folder of the plurality of folders for the at least one additional source code file based on data associated with each folder of the plurality of folders and data associated with the at least one additional source code file. The machine learning model may be a machine learning model trained using training examples to select folder of a group of folders for source code file(s) based on data associated with at least some of the group of folders, data associated with the source code file(s), and/or additional information. An example of such training example may include sample data associated with sample group of two or more folders, sample data associated with sample source code file, and sample additional information, together with a label indicative of a selection of a folder of the sample group of two or more folders for the sample source code file. In one example, step 1510 may comprise: identifying a first mathematical object in a particular mathematical space, the first mathematical object corresponds to one or more words included in the input, for example using module 302; identifying a second mathematical object in the particular mathematical space based on data associated with a particular folder of the plurality of folders, for example using module 302; calculating a function of the first and second mathematical objects to obtain a third mathematical object in the particular mathematical space, for example using module 304; and basing the selection of the specific folder of the plurality of folders on the third mathematical object. In one example, step 1510 may comprise: identifying a first mathematical object in a particular mathematical space based on data associated with the at least one additional source code file, for example using module 302; identifying a second mathematical object in the particular mathematical space based on data associated with a particular folder of the plurality of folders, for example using module 302; calculating a function of the first and second mathematical objects to obtain a third mathematical object in the particular mathematical space, for example using module 304; and basing the selection of the specific folder of the plurality of folders on the third mathematical object. In one example, such data associated with the at least one additional source code file may comprise at least one of data associated with the input in the natural language (such as words, phrases, utterances, sentences, length, etc.), content of the at least one additional source code file (such as instructions, constants, variables, remarks, etc.), and so forth. In one example, such data associated with one or more folders of the plurality of folders may include at least one of a name of each folder, a description in natural language of each folder, names of files included in each folder, content of files included in each folder, and so forth.

In some examples, a first folder of the plurality of folders of step 1504 and/or step 1510 may be associated with tests, a second folder of the plurality of folders may be associated with core code, and step 1510 may base the selection of the specific folder on whether the at least one additional source code file is associated with core code or tests. In some examples, a first folder of the plurality of folders may be associated with a first category of files, a second folder of the plurality of folders may be associated with a second category of files, and the selection of the specific folder may be based on a category of files associated with the at least one additional source code file. In some examples, a first folder of the plurality of folders may be associated with a first type of functionality, a second folder of the plurality of folders may be associated with a second type of functionality, and step 1510 may base the selection of the specific folder on a type of functionality associated with the at least one additional source code file. In some examples, a first folder of the plurality of folders may be associated with environment specific information, a second folder of the plurality of folders may be associated with general information, and step 1510 may base the selection of the specific folder on whether the at least one additional source code file is associated with a specific environment. In some examples, a first folder of the plurality of folders may be associated with a first specific environment, a second folder of the plurality of folders may be associated with a second specific environment, and step 1510 may base the selection of the specific folder on an environment associated with the at least one additional source code file.

In some examples, step 1530 may comprise determining to create a new folder for the at least one additional source code file generated by step 1508. For example, step 1530 may analyze the at least one additional source code file to determine whether to create the new folder for the at least one additional source code file and/or to select name for the new folder. In another example, step 1530 may analyze the input in the natural language received by step 1106 to determine whether to create the new folder for the at least one additional source code file and/or to select name for the new folder. In yet another example, step 1530 may analyze data associated with each folder of the plurality of folders (of step 1504) to determine whether to create the new folder for the second at least one additional source code file and/or to select name for the new folder. In one example, step 1530 may use an artificial intelligence model (such as the artificial intelligence model accessed by step 402, a different artificial intelligence model, etc.) to determine whether to create a new folder for the at least one additional source code file and/or to select name for the new folder, for example, based on the input in the natural language and/or the at least one additional source code file and/or the data associated with each folder of the plurality of folders. In one example, step 1530 may use an artificial neural network to determine whether to create a new folder for the at least one additional source code file and/or to select name for the new folder, for example, based on the input in the natural language and/or the at least one additional source code file and/or the data associated with each folder of the plurality of folders. In one example, step 1530 may use a machine learning model to determine whether to create a new folder for the at least one additional source code file and/or to select name for the new folder, for example, based on the input in the natural language and/or the at least one additional source code file and/or the data associated with each folder of the plurality of folders. The machine learning model may be a machine learning model trained using training examples to determine whether to create new folder(s) for source code file(s) and/or name(s) for the new folder(s) based on inputs used to generate the source code file(s), data associated with the source code file(s), and/or data associated with existing folders. An example of such training example may include a sample input user to create a sample source code file, and/or sample data associated with the sample source code file, and/or sample data associated with a sample group of existing folders, together with a label indicative of whether to create a new folder for the sample source code file(s) and/or a name for the new folder. In one example, step 1530 may comprise: identifying a first mathematical object in a particular mathematical space, the first mathematical object corresponds to one or more words included in the input in the natural language, for example using module 302; identifying a second mathematical object in the particular mathematical space based on data associated with a particular folder of the plurality of folders, for example using module 302; calculating a function of the first and second mathematical objects to obtain a third mathematical object in the particular mathematical space, for example using module 304 ; and basing the determination whether to create the new folder for the second at least one additional source code file on the third mathematical object and/or basing the selection of a name for the new folder based on the third mathematical object. In one example, step 1530 may comprise: identifying a first mathematical object in a particular mathematical space based on data associated with the at least one additional source code file, for example using module 302; identifying a second mathematical object in the particular mathematical space based on data associated with a particular folder of the plurality of folders, for example using module 302; calculating a function of the first and second mathematical objects to obtain a third mathematical object in the particular mathematical space, for example using module 304; and basing the determination whether to create the new folder for the second at least one additional source code file on the third mathematical object and/or basing the selection of a name for the new folder based on the third mathematical object.

In some examples, step 1532 may comprise creating a new folder (such as the new folder of step 1530). For example, step 1532 may create the new folder in a file system, in a VCS, within another folder of the plurality of folders of step 1504, and so forth. For example, step 1532 may set a name of the new folder to the name selected for the new folder by step 1532. In some examples, step 1534 may comprise storing the at least one source code file (such as the at least one additional source code file generated by step 1508, a different at least one source code file, etc.) in a folder (such as the new folder created by step 1532, a different folder, etc.), for example to obtain an updated version of the codebase of step 1504. In some examples, step 1512 may comprise adding the at least one additional source code file to a codebase (such as the codebase of step 1504 and/or step 1106, a different codebase, etc.) at a specific folder (such as the specific folder selected by step 1510, a different specific folder, etc.) to obtain an updated version of the codebase.

In some examples, process 1500 and/or process 1520 may further comprise at least one of presenting the updated version of the codebase to an individual, committing the updated version of the codebase to a VCS, or executing the updated version of the codebase. In one example, process 1500 and/or process 1520 may further comprise presenting the updated version of the codebase to an individual. For example, the updated version of the codebase may be presented to the individual visually, textually, graphically, audibly, in a user interface, in a code viewer, and so forth. In one example, the updated version of the codebase may be presented to the individual in a form that enables the individual to modify the updated version of the codebase, for example, in an IDE, in a code editor, and so forth. In one example, process 1500 and/or process 1520 may further comprise committing the updated version of the codebase to a VCS. In one example, process 1500 and/or process 1520 may further comprise executing the updated version of the codebase, for example using at least one processing unit.

What is claimed is:

1. A non-transitory computer readable medium storing computer implementable instructions that when executed by at least one processor cause the at least one processor to perform operations for input validation in artificial intelligence coding, the operations comprising:
accessing an artificial intelligence model;
receiving an input in a natural language associated with a desire of an individual to generate source code for a software;
analyzing the input in the natural language to determine a need for the software to receive data from an external source;
requesting from the individual guidance associated with input validation for the received data;
receiving the requested guidance from the individual; and
using the artificial intelligence model to analyze the input in the natural language to generate the source code, the generated source code includes instructions for receiving the data from the external source and instructions for validating the received data based on the received guidance.

2. The non-transitory computer readable medium of claim 1, wherein the operations further comprise:
accessing a preliminary version of the source code before the input in the natural language is received; and
basing the generation of the source code on the preliminary version of the source code.

3. The non-transitory computer readable medium of claim 2, wherein the instructions for validating the received data is further based on an analysis of the preliminary version of the source code.

4. The non-transitory computer readable medium of claim 1, wherein the instructions for validating the received data is further based on at least one coding guideline.

5. The non-transitory computer readable medium of claim 1, wherein the instructions for validating the received data is further based on the external source.

6. The non-transitory computer readable medium of claim 1, wherein the received guidance includes guidance in the natural language.

7. The non-transitory computer readable medium of claim 6, wherein the received guidance includes a word, and a location at which the input validation is to be performed is determined based on the word.

8. The non-transitory computer readable medium of claim 6, wherein the received guidance includes a word, a desired characteristic of the received data is determined based on the word, and the generated instructions for validating the received data includes validating the desired characteristic.

9. The non-transitory computer readable medium of claim 6, wherein the received guidance includes a word, a validation technique is determined based on the word, and the generated instructions for validating the received data implements the determined validation technique.

10. The non-transitory computer readable medium of claim 1, wherein the received guidance includes an input in a formal language.

11. The non-transitory computer readable medium of claim 1, wherein the received guidance includes a selection of an input validation approach, and the instructions for validating the received data implements the selected input validation approach.

12. The non-transitory computer readable medium of claim 1, wherein the received guidance is indicative of two or more values, and the instructions for validating the received data implements at least one of an allow-list input validation with a list including the two or more values or block-list input validation with a list including the two or more values.

13. The non-transitory computer readable medium of claim 1, wherein the received guidance is indicative of a desire reaction to invalid input, and the instructions for validating the received data are configured to trigger the desire reaction in response to an invalid received input.

14. The non-transitory computer readable medium of claim 1, wherein the received guidance is indicative of a location at which the input validation is to be performed.

15. The non-transitory computer readable medium of claim 1, wherein the instructions for validating the received data includes at least one check of the received data not based on the received guidance.

16. The non-transitory computer readable medium of claim 1, wherein the instructions for validating the received data includes at least one check of the received data that is inconsistent with the received guidance.

17. The non-transitory computer readable medium of claim 1, wherein the operations further comprise:
identifying a first mathematical object in a particular mathematical space, the first mathematical object corresponds to at least one word included in the input;
identifying a second mathematical object in the particular mathematical space based on at least part of the received guidance;
calculating a function of the first and second mathematical objects to obtain a third mathematical object in the particular mathematical space; and
determining at least part of the instructions for validating the received data based on the third mathematical object.

18. The non-transitory computer readable medium of claim 1, wherein the operations further comprise using the artificial intelligence model to generate one or more testing procedures for the source code based on the received guidance.

19. A system for input validation in artificial intelligence coding, the system comprising:
at least one processing unit configured to perform operations, the operations comprise:
accessing an artificial intelligence model;
receiving an input in a natural language associated with a desire of an individual to generate source code for a software;
analyzing the input in the natural language to determine a need for the software to receive data from an external source;
requesting from the individual guidance associated with input validation for the received data;
receiving the requested guidance from the individual; and
using the artificial intelligence model to analyze the input in the natural language to generate the source code, the generated source code includes instructions for receiving the data from the external source and instructions for validating the received data based on the received guidance.

20. A method for input validation in artificial intelligence coding, the method comprising:
accessing an artificial intelligence model;
receiving an input in a natural language associated with a desire of an individual to generate source code for a software;
analyzing the input in the natural language to determine a need for the software to receive data from an external source;
requesting from the individual guidance associated with input validation for the received data;
receiving the requested guidance from the individual; and
using the artificial intelligence model to analyze the input in the natural language to generate the source code, the generated source code includes instructions for receiving the data from the external source and instructions for validating the received data based on the received guidance.
